(19) United States
(12) Patent Application Publication
(10) Pub. No.: US 2026/0246601 A1
(43) Pub. Date: Aug. 20, 2026

(54) METHOD AND UNIT

(71) Applicant: NEC Corporation, Tokyo (JP)

(72) Inventor: Pravjyot DEOGUN, Milton Keynes (GB)

(73) Assignee: NEC Corporation, Tokyo (JP)

(21) Appl. No.: 19/162,606

(22) PCT Filed: Mar. 21, 2024
(86) PCT No.: PCT/JP2024/010987

§ 371 Date: Sep. 5, 2025

(30) Foreign Application Priority Data
Mar. 24, 2023 (GB) 2304384.7

(51) Int. Cl. H04L 5/14; H04L 5/00; H04W 72/04; H04W 72/29

(52) U.S. Cl. CPC H04L 5/14; H04L 5/0092; H04W 72/04; H04W 72/29

(57) ABSTRACT

A distributed access network is disclosed in which information for configuring full duplex communication in the context of time-division-duplex communication is exchanged between the nodes of the distributed access network.

### TECHNICAL FIELD

The present disclosure relates to a communication system.

### BACKGROUND ART

The disclosure has particular but not exclusive relevance to wireless communication systems and devices thereof operating according to the 3rd Generation Partnership Project (3GPP) standards or equivalents or derivatives thereof (including LTE-Advanced, Next Generation or 5G networks, future generations, and beyond). The disclosure has particular, although not necessarily exclusive relevance to, improved apparatus and methods that support full duplex communication in time division duplex (TDD) communication bands.

Earlier developments of the 3GPP standards were referred to as the Long-Term Evolution (LTE) of Evolved Packet Core (EPC) network and Evolved UMTS Terrestrial Radio Access Network (E-UTRAN), also commonly referred as ‘4G’. More recently, the term ‘5G’ and ‘new radio’ (NR) has started to be used to refer to an evolving communication technology that is expected to support a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network.

Under the 3GPP standards, a NodeB (or an eNB in LTE, and gNB in 5G) is the radio access network (RAN) node (or simply ‘access node’, ‘access network node’ ‘base station’ or ‘RAN equipment’) via which communication devices (user equipment or ‘UE’) connect to a core network and communicate with other communication devices or remote servers. For simplicity, the present application will use the term access network node, RAN node or base station to refer to any such access nodes.

For simplicity, the present application will use the term mobile device, user device, or UE to refer to any communication device that is able to connect to the core network via one or more base stations. Although the present application may refer to mobile devices in the description, it will be appreciated that the technology described can be implemented on any communication devices (mobile and/or generally stationary) that can connect to a communications network for sending/receiving data, regardless of whether such communication devices are controlled by human input or software instructions stored in memory.

In the current 5G architecture, the gNB structure may be split into two or more parts. In some RAN implementations there are two parts, known as the Central Unit (CU or gNB-CU)—sometimes referred to as a ‘control unit’—and the Distributed Unit (DU or gNB-DU), connected by an F1 interface. This enables the use of a ‘split’ architecture in which the typically ‘higher’ CU layers (for example, but not necessarily or exclusively, Packet Data Convergence Protocol (PDCP) and Radio Resource Control (RRC) layers) and the, ‘lower’ DU layers (for example, but not necessarily or exclusively, Radio Link Control (RLC), Media Access Control (MAC), and Physical (PHY) layers) are separated between a particular CU, and one or more DUs that are connected to and controlled by that CU via the F1 interface. Thus, for example, the higher layer CU functionality for a number of gNBs may be implemented centrally (for example, by a single processing unit, or in a cloud-based or virtualised system), whilst retaining the lower layer DU functionality locally separately for each gNB.

In more recently proposed RAN distributed architectures, in addition to the CU and DU, the concept of a Radio Unit (RU)—sometimes referred to as a ‘remote unit’—has been introduced. In this architecture the RU is responsible for handling the digital front end (DFE), digital beamforming functionality and, typically, the functionality of the lower parts of the PHY layer, whilst the DU typically handles the higher parts of the PHY layer and the RLC and MAC layers. The CU in this architecture continues to be responsible for controlling one or more DUs (each DU corresponding to a different respective gNB) and to handle higher layer signalling (typically RRC and PDCP layers).

The actual functional split between the CU and DUs (and potentially RUs where applicable) of these distributed architectures is flexible allowing the functionality to be optimised for different use cases. Effectively, the split architecture enables a 5G network to use a different distribution of protocol stacks between CU and DUs (and potentially RUs) depending on, for example, midhaul availability and network design.

The choice of how to split functions in the architecture depends on, among other things, factors related to radio network deployment scenarios, constraints and intended supported use cases. Key considerations include: the need to support a specific quality of service for each service offered and for real/non-real time applications; support of specific user density and load demand in a given geographical area; and available transport networks with different performance levels.

In efforts to move away from vendor specific deployments, towards deployments in which hardware and software components from different vendors are interoperable and can be mixed and matched, there has been a drive to so-called ‘open’ interfaces between the various elements of the RAN. In earlier generations the RAN incorporated controllers that were responsible for RAN orchestration and management. With the development of 4G, the overall network architecture became flatter, and the expectation was that, to enable optimal subscriber experience, base stations would use the standardised base station to base station (X2) interface to communicate with each other to handle resource allocation. However, whilst the X2 application protocol was largely standardised, different RAN vendors still produced their own variations of the X2 interface thus making it difficult for a mobile network operator (MNO) to use equipment from more than one RAN vendor in a particular location. More recently there has been a movement back towards the controller concept to allow disaggregation of hardware and software and development of open interfaces between them. This movement is known as ‘Open RAN’ and whilst it has particular relevance for 5G and future generations it is also applicable to RAN development for earlier generations.

In the context of 5G, in which many 5G scenarios require low latency, implementation of 5G concepts such as Control and User Plane Separation (CUPS), functional RAN splits and network slicing, require a combination of advanced RAN virtualization and software defined networking (SDN). This has led to the concept of a RAN Intelligent Controller (RIC) being developed as part of the Open RAN movement. The RIC comprises a Non-Real-Time (non-RT) RIC (supporting tasks that require >1s latency) and a Near-Real Time RIC (latency of <1s).

The Near-RT RIC is responsible for per-UE controlled load-balancing, radio resource management, interference detection and mitigation. To facilitate this, the Near-RT RIC provides cloud-based infrastructure for controlling a distributed collection of RAN nodes (eNB, gNB, CU, DU) in a particular geographic area via an open “southbound” interface (E2) protocol. The Near-RT RIC also provides open “northbound” interfaces (A1 and O1), to a service management and orchestration (SMO) framework, for operators. The Near-RT RIC hosts micro-service-based applications called xApps that are run by the Near-RT RIC and that can use the E2 interface to collect near real-time information (on a UE basis or a cell basis). These xApps cover functions such as mobility management, admission control, and interference management. The Near-RT RIC also enforces network policies via the E2 interface toward the radios and provides advanced control functionalities with the intention of increasing efficiency and providing improved radio resource management (RRM). These control functionalities make use of analytics and data-driven approaches including advanced machine learning (ML)/artificial intelligence (AI) tools to improve resource management capabilities. The Near-RT RIC's control over the E2 nodes (e.g. eNB, gNB, CU, DU or the like) is steered via the policies and the data provided via the A1 interface from the Non-RT RIC. The RRM functional allocation between the Near-RT RIC and the E2 node is subject to the capability of the E2 node and is controlled by the Near-RT RIC. For example, the near-RT RIC may monitor, suspend/stop, override or control the node via Non-RT RIC enabled policies. The Near-RT RIC may be deployed in a number of ways for example as a virtual network function (VNF), a set of virtual machines (VMs), or as a cloud native function (CNF).

The Non-RT RIC forms part of the SMO framework and connects to the Near-RT RIC for the management and optimization of the RAN. Network management applications in the Non-RT RIC receive and act on data from the DU and CU provided in a standardised format over the A1 Interface. Non-RT RIC functionality includes configuration management, device management, fault management, performance management, and lifecycle management for all network elements in the network. All new RUs are self-configured by the Non-RT RIC, reducing the need for manual intervention. The provision by the Non-RT RIC of insights into network operations, allows MNOs to better understand and, as a result, better optimize the network by applying pre-determined service and policy parameters. The Non-RT RIC supports intelligent RAN optimisation by providing policy-based guidance, model management and enrichment information to the Near-RT RIC so that the RAN can be optimised efficiently and effectively. The Non-RT RIC can use data analytics and machine learning (ML)/artificial intelligence (AI) training/inference to identify appropriate RAN optimisation actions for which it can use SMO services.

The separation of functionalities on southbound and northbound interfaces enables more efficient and cost-effective radio resource management for real-time and non-real-time functionalities, as the RIC customizes network optimization for each network environment and use case.

Historically, communication systems have employed two core duplex schemes-frequency division duplex (FDD) and time division duplex (TDD). In FDD the frequency domain resource is split between downlink (DL) and uplink (UL) whereas in TDD the time domain resource is split between DL and UL.

The appropriate duplex scheme to be used in a given scenario is broadly spectrum dependent, albeit with some overlap. Where lower frequency bands are used for communication, paired spectrum UL and DL resource allocations are generally employed and hence FDD is used. In contrast, for higher frequency bands the use of unpaired spectrum, and hence TDD, is becoming increasingly prevalent. Thus, TDD is widely used in commercial NR deployments. Given the significantly higher carrier frequencies supported by 5G, and that will be supported by future communication generations (6G and beyond) as compared to earlier communication generations, improved techniques for providing efficient use of unpaired spectrum are, and will continue to be, increasingly critical.

However, allocation of too limited a time duration for the UL in TDD carriers has the potential to result in reduced coverage, increased latency, and reduced capacity.

Full duplex (FD) operation, involving sharing both frequency domain and time domain resources between the UL and the DL, within the bandwidth of a conventional TDD carrier, represents one way in which improvements may be achievable over conventional TDD performance. Accordingly, enhancements to implement full duplex operation at the gNB, within TDD carriers, are currently being developed-currently with no restriction on the possible frequency ranges used for such FD operation. At present half duplex operation within TDD carriers is still envisaged for the UE, although full duplex UE operation remains an option for the future. The use of FD has, however, the potential to cause serious interference issues, both at the base station and at the UE, which are difficult to address.

There are a number of possible FD implementations that can be implemented on TDD carriers including, for example, subband non-overlapping, subband overlapping, full overlapping.

Referring to FIGS. 1 to 4, in subband non-overlapping FD (′SBFD′, also referred to as cross division duplex (XDD)), non-overlapping UL and DL subbands may be configured in the TDD carrier (as seen in the general case illustrated in FIG. 1). As seen in FIGS. 1 to 4 each subband comprises a respective relatively ‘narrow’ frequency band having a bandwidth that extends only part of the full available bandwidth within the current TDD carrier that is configured for communication in the associated cell. A base station can thus perform simultaneous (full duplex) transmission and reception at the same time, in different respective non-overlapping subbands, for different UEs.

FIG. 2 shows a particular example in which only one dedicated DL subband and one dedicated UL subband are configured in the TDD carrier. FIG. 3 shows an example in which, from the first slot to the fourth slot, full duplex operation is active where an UL subband is present in the centre of the frequency band and two DL subbands are present at either side of the DL subband. In the fifth slot, the base station uses legacy TDD operation (i.e. entire frequency band is used only for UL). FIG. 4 shows an example in which, from the first slot to the fifth slot, full duplex operation is active. In the first four slots an UL subband is present in the centre of the frequency band and two DL subbands are present at either side of the DL subband. In the fifth slot a complementary UL/DL configuration is present compared to the first four slots.

In subband overlapping FD, UL and DL may be configured in a similar way to subband non-overlapping FD, but the different subbands are allowed to overlap in frequency.

### CITATION LIST

### Patent Literature

PTL 1: EP4199387A1
PTL 2: EP3442157A1
PTL 3: CN109302708A

### Non Patent Literature

NPL 1: The ‘NGMN 5G White Paper’ V1.0 by the Next Generation Mobile Networks (NGMN) Alliance, available from https://www.ngmn.org/5g-white-paper.html.

### SUMMARY OF INVENTION

### Technical Problem

In full overlapping FD, the entire available bandwidth may be used for UL or DL transmissions.

One of the key benefits of SBFD is increased UL coverage because SBFD makes it easier to take advantage of multi-slot UL repetitions due to an increased number of consecutive UL occasions in SBFD. Currently, therefore, focus is on the development of techniques for implementing subband non-overlapping FD operation and potential related enhancements for dynamic or flexible TDD. It will be appreciated, however, that other FD implementations remain an option for the future and enhancements envisaged for sub-band non-overlapping FD may have benefits in other FD schemes.

When implementing FD schemes there are a number of considerations that need to be taken into account. Among the considerations that are particularly relevant for SBFD (and other FD schemes), for example, is the need to avoid, self-Interference. In more detail, of particular concern for the implementation of SBFD within a base station/access network is self-interference from a DL subband to a UL subband (also known as inter-subband interference). Specifically, even though the DL and the UL operate using different frequency resources, DL transmissions can interfere with UL receptions due to transceiver elements having a non-linear channel response (e.g. power amplifier). Moreover, the high DL transmission power (as compared to low UL intended signal power) can saturate an analog-to-digital conversion (ADC) unit which can greatly impact the resolution capability of ADC for UL receptions. This occurs mainly because the analog filtering operation, which is performed before ADC, only filters out transmissions outside the channel band and hence the filtering output can contain both a UL intended signal and a dominant DL transmitted signal.

There are a number of self-interference mitigation techniques which can be applied including, for example:
Self-interference cancellation mechanisms (which can be digital, analog, or a combination of both);
Spatial domain mechanisms (for example, using beams with minimal radiation overlap to reduce self-interference from DL to UL);
Power domain mitigation methods (for example, reducing DL power and/or improving UL power);
Frequency domain isolation (for example, introducing/increasing a frequency gap (i.e. guard band) between DL and UL subbands);
Filtering mechanisms (for example, performing an analog filtering operation before ADC to output only the UL subband component);
   How much isolation can be achieved is dependent on both the analog filtering characteristics and any guard band between UL and DL subband and hence frequency domain and filtering solutions are generally considered together; and
Antenna isolation (given that many 5G implementations use antenna panels with multiple antenna elements, different antenna elements can be used for DL and UL to provide isolation)

Various aspects of SBFD, and in particular the self-interference mitigation techniques, have an impact at different layers of the RAN architecture. Accordingly, in the context of a distributed RAN having several different RAN entities (such as an RU, DU and CU defined by an O-RAN architecture or the like), the implementation of SBFD can be complex. In particular, the way in which SBFD and any self-interference techniques are configured can have impacts on the operation of the distributed entities. For example, different sets of antenna elements may be available for uplink (and/or downlink) communication during SBFD slots/symbols than non-SBFD slots/symbols. This could have an impact on how beamforming is performed at the RU and/or controlled by the DU/CU.

It can be seen, therefore, that there is a need for improved procedures and apparatus that address the requirements of SBFD appropriately in the context of a distributed RAN architecture.

### Solution to Problem

The disclosure aims to provide one or more apparatus, and one or more associated methods, that at least partially contribute to the above need.

In one aspect the disclosure provides a method performed by a first unit of an access network, the method comprising: transmitting, to a second unit of the access network, capability information indicating a capability of the first unit, the information indicating the capability indicating at least one of: a capability of the first unit to communicate with a user equipment (UE) using a communication scheme in which at least one time resource is configured for uplink communication, at least one time resource is configured for downlink communication, and at least one time resource is configured both for downlink communication and for uplink communication; or a capability of the first unit to isolate downlink communication from uplink communication in at least one time resource that is configured both for downlink communication and for uplink communication.

The capability information may include information indicating a respective isolation capability for each of a plurality of different isolation schemes. The capability information may include information indicating a combined isolation capability for a plurality of different isolation schemes. The capability information may include information identifying a configuration of the different isolation schemes used to determine the combined isolation capability. The capability information may include information indicating a respective combined isolation capability for each a plurality of different configurations of the different isolation schemes.

The different isolation schemes may include at least one of: a first isolation scheme in which at least one guard band is used to isolate downlink communication from uplink communication; a second isolation scheme in which different beams are used to isolate downlink communication from uplink communication; a third isolation scheme in which different antenna configurations are used to isolate downlink communication from uplink communication; and/or a fourth isolation scheme in which at least one cancellation mechanism is used to isolate downlink communication from uplink communication.

The method may further comprise receiving a request from the second unit, wherein the capability information is provided in response to the request.

In another aspect the disclosure provides a method performed by a second unit of an access network, the method comprising: receiving, from a first unit of the access network, capability information indicating at least one of: a capability of the first unit to communicate with a user equipment (UE) using a communication scheme in which at least one time resource is configured for uplink communication, at least one time resource is configured for downlink communication, and at least one time resource is configured both for downlink communication and for uplink communication; or a capability of the first unit to isolate downlink communication from uplink communication in at least one time resource that is configured both for downlink communication and for uplink communication.

In one aspect the disclosure provides a method performed by a second unit of an access network, the method comprising: transmitting, to a first unit of the access network, configuration information for a communication scheme in which at least one time resource, of a plurality of time resources, is configured as a first type for uplink communication, at least one time resource, of the plurality of time resources, is configured as a second type for downlink communication, and at least one time resource, of the plurality of time resources, is configured as a third type for both downlink communication and uplink communication.

The configuration information may be for configuring the first unit to communicate with at least one user equipment (UE) using the plurality of time resources in accordance with the communication scheme.

The configuration information may include information indicating, for each time resource of the plurality of time resources whether that time resource is: the first type, the second type, or the third type.

The first unit may have an existing configuration of the plurality of time resources in which at least one time resource is configured as the first type and at least one time resource is configured as the second type, and the configuration information may include information indicating which of the plurality of time resources of the existing configuration are to be modified from the first type, or from the second type, to the third type.

The configuration information may include: first information for respectively configuring each resource, of the plurality of time resources, to be the first type for uplink communication or the second type for downlink communication in a first frequency region; and second information for respectively configuring each resource, of the plurality of time resources, to be the first type for uplink communication or the second type for downlink communication in a second frequency region.

The method may further comprise transmitting, to the first unit, further information indicating: at least one time resource of the first type, and/or at least one time resource of the second type, to be modified dynamically to become a time resource of the third type; and/or at least one time resource of the third type to be modified dynamically to become a time resource of the first type or a time resource of the second type.

The transmitting of the further information may be timed to be received by the first unit a minimum time before the first unit receives control information relating to transmission of data for at least one UE by the second unit. The further information may be transmitted with control information relating to transmission of data for at least one UE by the second unit.

The method may further comprise transmitting, to the first unit, an indication of a frequency region for at least one of: an uplink subband; a downlink subband; and/or a guard band. The method may further comprise transmitting, to the first unit, an indication of a filter to be applied for time resources configured as the third type.

The configuration information may include at least one of: information indicating a configuration for the communication scheme for implementation at the first unit; information indicating an intended configuration for the communication scheme at the second unit; and/or information indicating a configuration for the communication scheme for a neighbouring unit of the access network or another access network.

The configuration information may include information, for configuring at least one time resource as the third type, that includes at least one of: an indication of frequency resources for at least one uplink subband; an indication of frequency resources for at least one downlink subband; an indication of frequency resources for at least one guard band; an indication of a time location for at least one uplink subband or downlink subband; and/or a time location for the at least one time resource of the third type.

The configuration information may be transmitted on condition that the first unit: supports reception of configuration information including information for configuring at least one time resource as the third type; or supports operation in accordance with a communication scheme in which at least one time resource is configured as the third type.

The configuration information may include information for configuring at least one time resource as the third type on condition that the first unit: supports reception of configuration information including information for configuring at least one time resource as the third type; or supports operation in accordance with a communication scheme in which at least one time resource is configured as the third type.

The configuration information may be second configuration information, and the transmitting may include transmitting first configuration information for configuring at least one time resource as the first type, and at least one time resource as the second type, without configuring a time resource as the third type.

The configuration information may include first configuration information for configuring at least one time resource as the first type, and at least one time resource as the second type, and second configuration information for configuring at least one time resource configured by the first configuration information as the first type or as the second type, as the third type.

In another aspect the disclosure provides a method performed by a first unit of an access network, the method comprising: receiving, from a second unit of the access network, configuration information for a communication scheme in which at least one time resource, of a plurality of time resources, is configured as a first type for uplink communication, at least one time resource, of the plurality of time resources, is configured as a second type for downlink communication, and at least one time resource, of the plurality of time resources, is configured as a third type for both downlink communication and uplink communication.

The configuration information may be for configuring the first unit to communicate with at least one user equipment (UE) using the plurality of time resources in accordance with the communication scheme. The method may further comprise determining a filter to be applied between an uplink subband and a downlink subband based on a guard band configured by the second unit.

The configuration information may be second configuration information, and the receiving may include receiving first configuration information for configuring at least one time resource as the first type, and at least one time resource as the second type, without configuring a time resource as the third type.

The method may further comprise: in a case where the first unit does not support reception of configuration information including information for configuring at least one time resource as the third type, or does not support operation in accordance with a communication scheme in which at least one time resource is configured as the third type: ignoring the second configuration information and using the first configuration information; and in a case where the first unit supports reception of configuration information including information for configuring at least one time resource as the third type, or supports operation in accordance with a communication scheme in which at least one time resource is configured as the third type: using the second configuration information.

The configuration information may include first configuration information for configuring at least one time resource as the first type, and at least one time resource as the second type, and second configuration information for configuring at least one time resource configured by the first configuration information as the first type or as the second type, as the third type.

The method may further comprise: in a case where the first unit does not support reception of configuration information including information for configuring at least one time resource as the third type, or does not support operation in accordance with a communication scheme in which at least one time resource is configured as the third type: ignoring the second configuration information and using the first configuration information; and in a case where the first unit supports reception of configuration information including information for configuring at least one time resource as the third type, or supports operation in accordance with a communication scheme in which at least one time resource is configured as the third type: using the first configuration information and the second configuration information.

The method may further comprise using a configuration of time resources based on whether the first configuration information and or second configuration is used, and transmitting an indication to the second unit to indicate: that the configuration of time resources used at the first unit is a configuration that includes at least one time resource that is configured as the third type; or that the configuration of time resources used at the first unit is a configuration that does not include at least one time resource that is configured as the third type.

The method may further comprise: providing, to the second unit: an indication of whether the first unit does, or does not support reception of configuration information including information for configuring at least one time resource as the third type; or an indication of whether the first unit does, or does not support operation in accordance with a communication scheme in which at least one time resource is configured as the third type.

The method may further comprise: in a case where the first unit does not support reception of configuration information including information for configuring at least one time resource as the third type, or does not support operation in accordance with a communication scheme in which at least one time resource is configured as the third type: sending an error message to the second unit in response to receipt of the configuration information.

In another aspect the disclosure provides a method performed by a first unit of an access network, the method comprising: transmitting, to a second unit of the access network, beam or antenna related information including at least one of: first information indicating at least one first beam configuration for at least one time resource that is configured both for downlink communication and for uplink communication, and at least one second beam configuration for at least one time resource that is configured specifically for downlink communication or specifically for uplink communication; second information indicating at least one first beam pattern for at least one time resource that is configured both for downlink communication and for uplink communication, and at least one second beam pattern for at least one time resource that is configured specifically for downlink communication or specifically for uplink communication; third information indicating at least one first set of antenna components that can, or cannot, be used for uplink communication in at least one time resource that is configured both for downlink communication and for uplink communication, and at least one second set of antenna components that can, or cannot, be used for downlink communication in at least one time resource that is configured both for downlink communication and for uplink communication; and/or fourth information indicating at least one first configuration for an antenna for uplink communication in at least one time resource that is configured both for downlink communication and for uplink communication, and at least one second configuration for an antenna for downlink communication in at least one time resource that is configured both for downlink communication and for uplink communication.

In another aspect the disclosure provides a method performed by a second unit of an access network, the method comprising: receiving, from a first unit of the access network, beam or antenna related information including at least one of: first information indicating at least one first beam configuration for at least one time resource that is configured both for downlink communication and for uplink communication, and at least one second beam configuration for at least one time resource that is configured specifically for downlink communication or specifically for uplink communication; second information indicating at least one first beam pattern for at least one time resource that is configured both for downlink communication and for uplink communication, and at least one second beam pattern for at least one time resource that is configured specifically for downlink communication or specifically for uplink communication; third information indicating at least one first set of antenna components that can, or cannot, be used for uplink communication in at least one time resource that is configured both for downlink communication and for uplink communication, and at least one second set of antenna components that can, or cannot, be used for downlink communication in at least one time resource that is configured both for downlink communication and for uplink communication; and/or fourth information indicating at least one first configuration for an antenna for uplink communication in at least one time resource that is configured both for downlink communication and for uplink communication, and at least one second configuration for an antenna for downlink communication in at least one time resource that is configured both for downlink communication and for uplink communication.

The method may further comprise using the beam or antenna related information when identifying a beam to be used for at least one time resource that is configured both for downlink communication and for uplink communication.

The method may further comprise using the beam or antenna related information when identifying at least one weight to be applied for beamforming for at least one time resource that is configured both for downlink communication and for uplink communication.

In another aspect the disclosure provides a first unit for an access network, the first unit comprising: means for transmitting, to a second unit of the access network, capability information indicating a capability of the first unit, the information indicating the capability indicating at least one of: a capability of the first unit to communicate with a user equipment (UE) using a communication scheme in which at least one time resource is configured for uplink communication, at least one time resource is configured for downlink communication, and at least one time resource is configured both for downlink communication and for uplink communication; or a capability of the first unit to isolate downlink communication from uplink communication in at least one time resource that is configured both for downlink communication and for uplink communication.

In another aspect the disclosure provides a second unit for an access network, the second unit comprising: means for receiving, from a first unit of the access network, capability information indicating at least one of: a capability of the first unit to communicate with a user equipment (UE) using a communication scheme in which at least one time resource is configured for uplink communication, at least one time resource is configured for downlink communication, and at least one time resource is configured both for downlink communication and for uplink communication; or a capability of the first unit to isolate downlink communication from uplink communication in at least one time resource that is configured both for downlink communication and for uplink communication.

In another aspect the disclosure provides a second unit for an access network, the second unit comprising: means for transmitting, to a first unit of the access network, configuration information for a communication scheme in which at least one time resource, of a plurality of time resources, is configured as a first type for uplink communication, at least one time resource, of the plurality of time resources, is configured as a second type for downlink communication, and at least one time resource, of the plurality of time resources, is configured as a third type for both downlink communication and uplink communication.

In another aspect the disclosure provides a first unit for an access network, the first unit comprising: means for receiving, from a second unit of the access network, configuration information for a communication scheme in which at least one time resource, of a plurality of time resources, is configured as a first type for uplink communication, at least one time resource, of the plurality of time resources, is configured as a second type for downlink communication, and at least one time resource, of the plurality of time resources, is configured as a third type for both downlink communication and uplink communication.

In another aspect the disclosure provides a first unit for an access network, the first unit comprising: means for transmitting, to a second unit of the access network, beam or antenna related information including at least one of: first information indicating at least one first beam configuration for at least one time resource that is configured both for downlink communication and for uplink communication, and at least one second beam configuration for at least one time resource that is configured specifically for downlink communication or specifically for uplink communication; second information indicating at least one first beam pattern for at least one time resource that is configured both for downlink communication and for uplink communication, and at least one second beam pattern for at least one time resource that is configured specifically for downlink communication or specifically for uplink communication; third information indicating at least one first set of antenna components that can, or cannot, be used for uplink communication in at least one time resource that is configured both for downlink communication and for uplink communication, and at least one second set of antenna components that can, or cannot, be used for downlink communication in at least one time resource that is configured both for downlink communication and for uplink communication; and/or fourth information indicating at least one first configuration for an antenna for uplink communication in at least one time resource that is configured both for downlink communication and for uplink communication, and at least one second configuration for an antenna for downlink communication in at least one time resource that is configured both for downlink communication and for uplink communication.

In another aspect the disclosure provides a second unit for an access network, the second unit comprising: means for receiving, from a first unit of the access network, beam or antenna related information including at least one of: first information indicating at least one first beam configuration for at least one time resource that is configured both for downlink communication and for uplink communication, and at least one second beam configuration for at least one time resource that is configured specifically for downlink communication or specifically for uplink communication; second information indicating at least one first beam pattern for at least one time resource that is configured both for downlink communication and for uplink communication, and at least one second beam pattern for at least one time resource that is configured specifically for downlink communication or specifically for uplink communication; third information indicating at least one first set of antenna components that can, or cannot, be used for uplink communication in at least one time resource that is configured both for downlink communication and for uplink communication, and at least one second set of antenna components that can, or cannot, be used for downlink communication in at least one time resource that is configured both for downlink communication and for uplink communication; and/or fourth information indicating at least one first configuration for an antenna for uplink communication in at least one time resource that is configured both for downlink communication and for uplink communication, and at least one second configuration for an antenna for downlink communication in at least one time resource that is configured both for downlink communication and for uplink communication.

It will be appreciated that while the communication system to which the present application relates is described in the context of full duplex enhancement at the base station side, half duplex operation at the UE side, and no restriction on the frequency ranges; the enhancements described may have benefit in other communication systems. For example, communication systems in which the UE is capable of full duplex operation and/or there are restrictions on the frequency ranges that may be used.

### BRIEF DESCRIPTION OF DRAWINGS

Example embodiments of the disclosure will now be described, by way of example, with reference to the accompanying drawings in which:

FIG. 1 is simplified time frequency diagrams illustrating a subband non-overlapping full duplex scheme and the exemplary implementations of such a scheme;

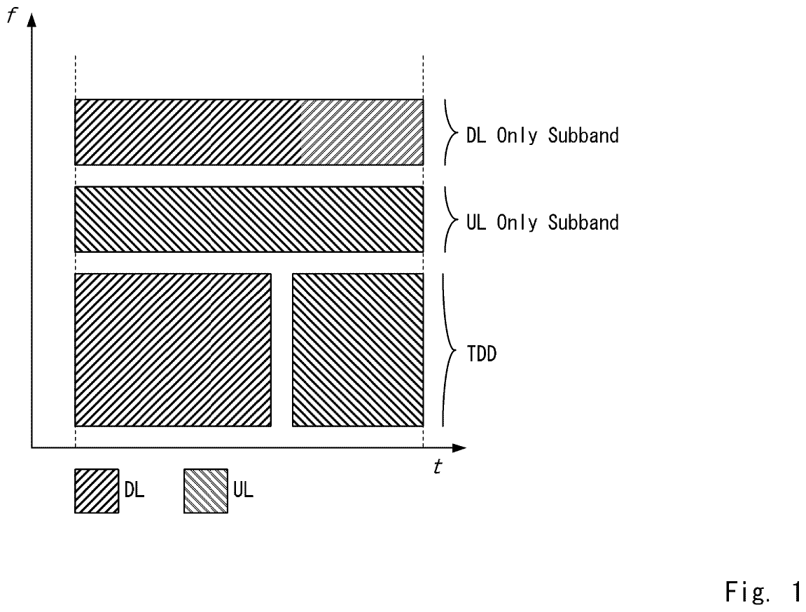

FIG. 2 is simplified time frequency diagrams illustrating a subband non-overlapping full duplex scheme and the exemplary implementations of such a scheme;

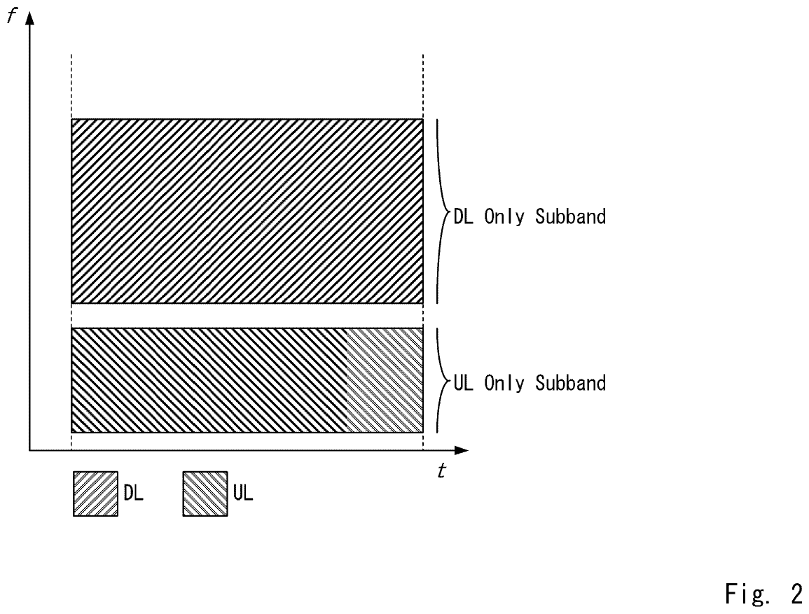

FIG. 3 is simplified time frequency diagrams illustrating a subband non-overlapping full duplex scheme and the exemplary implementations of such a scheme;

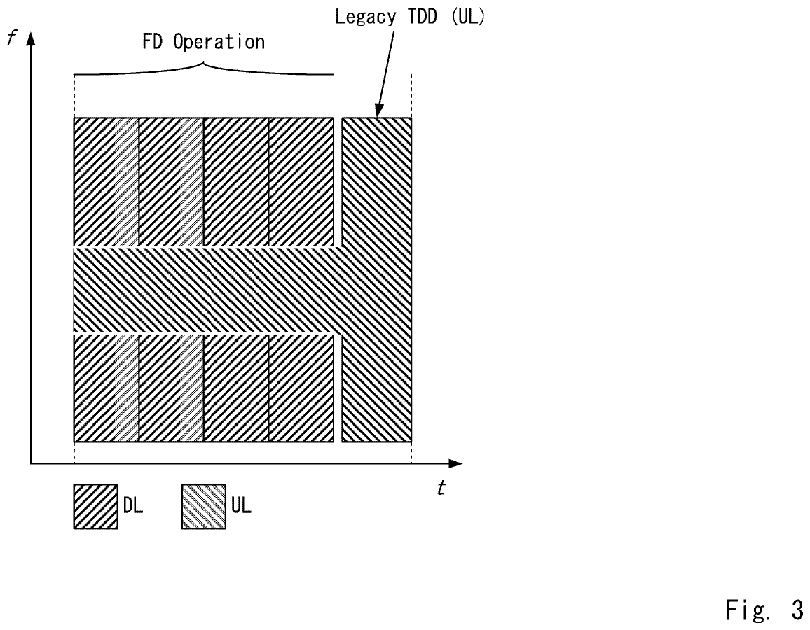

FIG. 4 is simplified time frequency diagrams illustrating a subband non-overlapping full duplex scheme and the exemplary implementations of such a scheme;

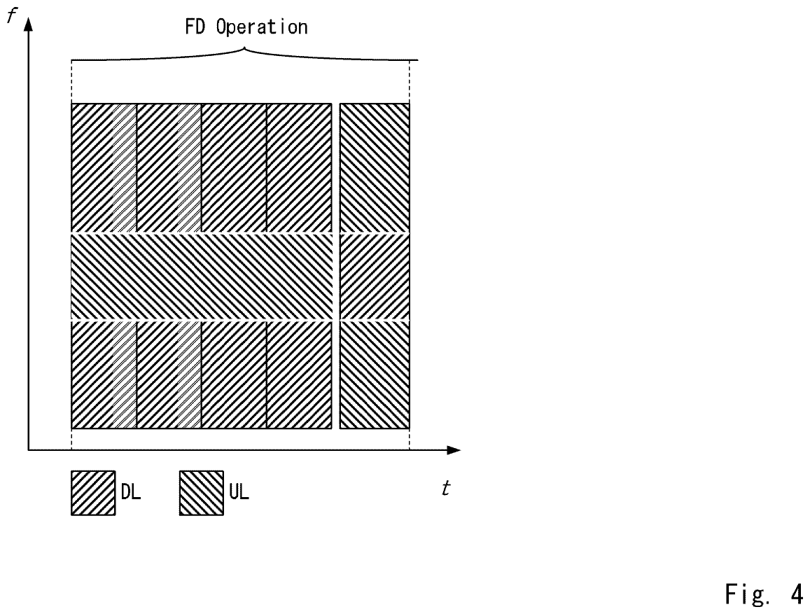

FIG. 5 is a simplified block schematic illustrating a possible open RAN (ORAN) network architecture for a RAN of the telecommunication system of FIG. 5;

FIG. 6 is a simplified block schematic illustrating a possible open RAN (ORAN) network architecture for a RAN of the telecommunication system of FIG. 5;

FIG. 7 illustrates a typical frame structure that may be used in the telecommunication system of FIG. 5;

FIG. 8 is a simplified sequence diagram illustrating different slot configuration procedures that can be employed in the telecommunication system of FIG. 5;

FIG. 9 shows illustrative examples of slot configurations configured by the procedures of FIG. 8;

FIG. 10 is a simplified time frequency diagram showing an illustrative example of a full duplex configuration that may be used in the telecommunication system of FIG. 5;

FIG. 11 is a simplified time frequency diagram showing an illustrative example of another full duplex configuration that may be used in the telecommunication system of FIG. 5;

FIG. 12 is a simplified time frequency diagram showing an illustrative example of another full duplex configuration that may be used in the telecommunication system of FIG. 5;

FIG. 13 is a simplified illustration of an antenna panel configuration for full duplex communication in the telecommunication system of FIG. 5;

FIG. 14 is a simplified sequence diagram illustrating different procedures for exchanging slot configurations that may be employed in the telecommunication system of FIG. 5;

FIG. 15 is a simplified sequence diagram illustrating a control plane and user plane message transfer procedure for sending user plane data in the downlink that may be used in the telecommunication system of FIG. 5;

FIG. 16 shows an exemplary message structure for control plane and/or user plane messages that may be used in the telecommunication system of FIG. 5;

FIG. 17 is a simplified sequence diagram illustrating a procedure for configuring TDD patterns at a radio/remote unit that may be used in the telecommunication system of FIG. 5;

FIG. 18 shows a simplified antenna panel configuration that may be used for beamforming in the telecommunication system of FIG. 5;

FIG. 19 shows a radio/remote unit transceiver virtualization models that may be used in the telecommunication system of FIG. 5;

FIG. 20 shows another radio/remote unit transceiver virtualization models that may be used in the telecommunication system of FIG. 5;

FIG. 21 shows a beamforming implementation that may be supported in the communication system 1;

FIG. 22 shows another beamforming implementation that may be supported in the communication system 1;

FIG. 23 shows a simplified illustration of an example of weight-based dynamic beamforming that may apply in the communication system 1;

FIG. 24 is a is simplified sequence diagram illustrating a procedure for indicating a capability of a radio/remote unit to a distributed unit that may be used in the telecommunication system of FIG. 5;

FIG. 25 is a is simplified sequence diagram illustrating another procedure for indicating a capability of a radio/remote unit to a distributed unit that may be used in the telecommunication system of FIG. 5;

FIG. 26 is a is simplified sequence diagram illustrating another procedure for indicating a capability of a radio/remote unit to a distributed unit that may be used in the telecommunication system of FIG. 5;

FIG. 27 is a is simplified sequence diagram illustrating another procedure for indicating a capability of a radio/remote unit to a distributed unit that may be used in the telecommunication system of FIG. 5;

FIG. 28 is a simplified sequence diagram illustrating a number of possible procedures for TDD information exchange between a distributed unit and a radio/remote unit that may be used in the telecommunication system of FIG. 5;

FIG. 29 is a simplified sequence diagram illustrating another procedure for TDD information exchange between a distributed unit and a radio/remote unit that may be used in the telecommunication system of FIG. 5;

FIG. 30 is a simplified sequence diagram illustrating another procedure for TDD information exchange between a distributed unit and a radio/remote unit that may be used in the telecommunication system of FIG. 5;

FIG. 31 is a simplified sequence diagram illustrating a procedure for TDD information exchange between a transmitting node (central unit/distributed unit) and a receiving node (central unit/distributed unit) that may be used in the telecommunication system of FIG. 5;

FIG. 32 is a simplified sequence diagram illustrating another procedure for TDD information exchange between a transmitting node (central unit/distributed unit) and a receiving node (central unit/distributed unit) that may be used in the telecommunication system of FIG. 5;

FIG. 33 is a simplified sequence diagram illustrating a procedure for TDD information exchange between a transmitting node (central unit/distributed unit) and a central unit that may be used in the telecommunication system of FIG. 5;

FIG. 34 is a simplified sequence diagram illustrating another procedure for TDD information exchange between a transmitting node (central unit/distributed unit) and a central unit that may be used in the telecommunication system of FIG. 5;

FIG. 35 is a simplified sequence diagram illustrating another procedure for TDD information exchange between a transmitting node (central unit/distributed unit) and a central unit that may be used in the telecommunication system of FIG. 5;

FIG. 36 is a simplified sequence diagram illustrating a procedure for TDD information exchange between a central unit and a distributed unit that may be used in the telecommunication system of FIG. 5;

FIG. 37 is a simplified sequence diagram illustrating another procedure for TDD information exchange between a central unit and a distributed unit that may be used in the telecommunication system of FIG. 5;

FIG. 38 is a simplified sequence diagram illustrating another procedure for TDD information exchange between a central unit and a distributed unit that may be used in the telecommunication system of FIG. 5;

FIG. 39 is a simplified sequence diagram illustrating another procedure for TDD information exchange between a central unit and a distributed unit that may be used in the telecommunication system of FIG. 5;

FIG. 40 is a simplified sequence diagram illustrating another procedure for TDD information exchange between a central unit and a distributed unit that may be used in the telecommunication system of FIG. 5;

FIG. 41 is a simplified sequence diagram illustrating another procedure for TDD information exchange between a central unit and a distributed unit that may be used in the telecommunication system of FIG. 5;

FIG. 42 is a simplified sequence diagram illustrating is a simplified sequence diagram illustrating a number of possible procedures for supporting antenna based isolation that may be used in the telecommunication system of FIG. 5;

FIG. 43 is a simplified schematic block diagram illustrating the main components of a user equipment for the telecommunication system shown in FIG. 5;

FIG. 44 is a simplified schematic block diagram illustrating the main components of a radio/remote unit of a RAN for the telecommunication system shown in FIG. 5;

FIG. 45 is a simplified schematic block diagram illustrating the main components of a distributed unit of a RAN for the telecommunication system shown in FIG. 5; and

FIG. 46 is a simplified schematic block diagram illustrating the main components of a central unit of a RAN for the telecommunication system shown in FIG. 5.

### DESCRIPTION OF EMBODIMENTS

### Overview

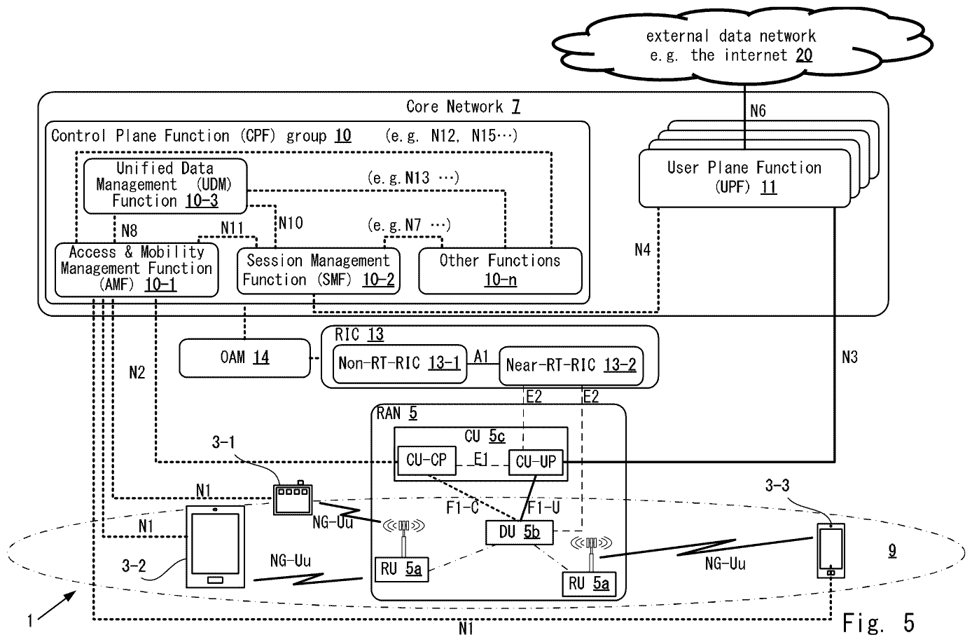

An exemplary telecommunication system will now be described in general terms, by way of example only, with reference to FIGS. 5 to 23.

FIG. 5 schematically illustrates a mobile (‘cellular’ or ‘wireless’) communication system 1 to which example embodiments of the present disclosure are applicable.

In the communication system 1 user equipment (UEs) 3-1, 3-2, 3-3 (e.g. mobile telephones and/or other mobile devices) can communicate with each other via a radio access network (RAN) 5 that operates according to one or more compatible radio access technologies (RATs). In the illustrated example, the RAN 5 comprises RAN equipment (or (R)AN node) forming a distributed NR/5G base station or ‘gNB’ operating one or more associated cells 9. Communication via the RAN 5 is typically routed through a core network 7 (e.g. a 5G core network or evolved packet core network (EPC)).

As those skilled in the art will appreciate, whilst three UEs 3 and one RAN 5 are shown in FIG. 5 for illustration purposes, the system, when implemented, will typically include other RAN node and UEs.

Each RAN 5 controls one or more associated cells 9 either directly, or indirectly via one or more other nodes (such as home base stations, relays, remote radio heads, distributed units, and/or the like). It will be appreciated that the RAN node may be configured to support both 4G and 5G, and/or any other 3GPP or non-3GPP communication protocols.

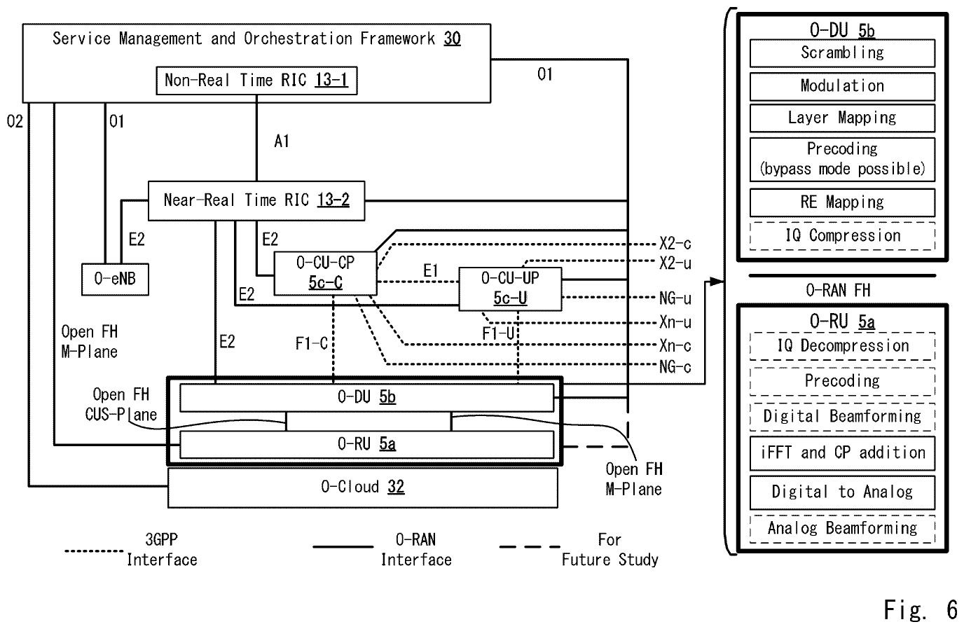

As seen in FIG. 5, in this example the illustrated RAN node comprises a distributed base station comprising a plurality of radio/remote units (RUs) 5a, a distributed unit (DU) 5b, and a central unit (CU) 5c. FIG. 6 is a simplified block schematic illustrating a possible open RAN (ORAN) network architecture for the RAN 5 of FIG. 5 although it will be appreciated that the RAN is not limited to this architecture.

As seen in FIG. 5 and FIG. 6, the CU 5c employs a separated control plane and user plane and so is, itself, split between a (‘open’) control plane function (CU-CP/O-CU-CP) 5c-C and a (‘open’) user plane function (CU-UP/O-CU-UP) 5c-U which respectively communicate, with the DU (or ‘O-DU’) via an F1-C logical interface and an F1-U logical interface (together forming an F1 interface (or ‘reference point’)), and with one another via an E1 logical interface.

The illustrated RAN node is controlled by a RAN intelligent controller (RIC) 13 comprising a non-real time RIC (non-RT-RIC) 13-1 and a near-real time RIC (near-RT-RIC) 13-2 that communicate with one another via an A1 interface. The near-real time RIC 13-2 supports tasks that require short (<1s) latencies while the non-real time RIC 13-1 supports tasks that can be performed with a longer latency (<1s). The near-RT RIC 13-2 is responsible for per-UE controlled load-balancing, resource (resource block (RB)) management, interference detection and mitigation. The non-RT RIC 13-1 forms part of a service management and orchestration (SMO) layer 30 and communicates with the near-RT RIC 13-2, via the A1 interface, for the management and optimization of the RAN 5. As seen in FIG. 6, in the context of an ORAN architecture, a cloud computing platform 32 known as an Open Cloud or O-Cloud is provided. The O0Cloud 32 comprises the physical infrastructure nodes to meet O-RAN requirements for hosting the O-RAN CUs 5c, DUs 5b, supporting software and the appropriate management and orchestration functions. An O-Cloud node typically includes, for example: a number of processors (central processing units, ‘CPUs’); memory storage; network infrastructure cards (NICs); the basic input/output system (BIOS); the baseband management controllers (BMCs), and the accelerators needed to offload computational intense functions (e.g., forward error correction (FEC)).

Physical layer functions are divided between DU 5b and RU 5a with higher physical layer functions provided by the DU 5b and lower physical layer functions by the RU 5a. An open fronthaul (FH) Control, User and Synchronization plane (CUS-plane) interface and a management plane (M-plane) interface are provided to handle interactions between DU 5b and RU 5a.

As seen in FIG. 6 the DU 5b may, for example, be responsible for functions such as scrambling, modulation, layer mapping, resource element (RE) mapping, in-phase/quadrature (IQ) compression, and precoding (which may be bypassed in a bypass mode). The RU 5a may, for example, be responsible for I/Q decompression, precoding, digital beamforming, inverse fast Fourier transformation (IFFT), CP addition, digital-to-analog conversion, and/or analog beamforming. It can be seen that precoding can be performed either at the DU 5b or the RU 5a and that other functions (e.g., illustrated by the dashed lines are optional).

Above the physical layer, the CU 5c provides higher layer functionality (for example, but not necessarily or exclusively, Packet Data Convergence Protocol (PDCP) and Radio Resource Control (RRC) layers) and the DU 5b provides lower layer functionality (for example, but not necessarily or exclusively, Radio Link Control (RLC), Media Access Control (MAC), and Physical (PHY) layers).

It will be appreciated that whilst distributed RAN node is shown and described, the RAN node may be provided in a non-distributed (or less distributed) form, for example as an integrated gNB or eNB (in which at least some of the functions of the RU 5a, DU 5b, and/or CU 5c are integrated in the same equipment).

As seen in FIG. 5, the UEs 3 and their serving RAN 5 are connected via an appropriate air interface (for example the so-called ‘Uu’ interface and/or the like). Equipment of neighbouring RANs 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the communication system 1. In this example, the core network 7 comprises a number of control plane functions (CPFs) 10 and one or more user plane functions (UPFs) 11. The CPFs 10 include one or more Access and Mobility Management Functions (AMFs) 10-1, one or more Session Management Functions (SMFs), one or more unified data management (UDM) functions 10-3, and a number of other functions 10-n (such as, for example an Authentication Server Function (AUSF) which facilitates 5G security processes).

The communication system also includes an Operations, Administration and Maintenance (OAM) system 14 comprising one or more OAM functions for provisioning and managing network or elements within the wider communication system 1. The OAM 14 may be responsible for the storage and analysis of some radio-related measurements and may perform some data analytics functions including some RAN analytics.

The nodes of the RAN 5 are connected to the core network nodes via appropriate interfaces (or ‘reference points’) such as an N2 reference point between the RAN 5 and the AMF 10-1 for the communication of control signalling, and an N3 reference point between the RAN 5 and each UPF 11 for the communication of user data. The UEs 3 are each connected to the AMF 10-1 via a logical non-access stratum (NAS) connection over an N1 reference point (analogous to the S1 reference point in LTE). It will be appreciated, that N1 communications are generally routed transparently via the RAN node.

One or more UPFs 11 are connected to an external data network (e.g. an IP network such as the internet) via reference point N6 for communication of the user data.

The AMF 10-1 performs mobility management related functions, maintains the NAS signalling connection with each UE 3 and manages UE registration. The AMF 10-1 receives user information sent through the network and forwards the information to the SMF. The AMF 10-1 is also responsible for managing paging.

The SMF 10-2 provides session management functionality (that formed part of MME functionality in LTE) and additionally combines some control plane functions (provided by the serving gateway and packet data network gateway in LTE). The SMF uses user information provided via the AMF 10-1 to determine what session manager would be best assigned to the user. The SMF 10-2 may be considered effectively to be a gateway from the user plane to the control plane of the network. The SMF 10-2 also allocates IP addresses to each UE 3.

The UDM function 10-3 manages network user data in a single, centralised, element. For example, the UDM 10-3 manages data for access authorization, user registration, and data network profiles, and provides subscriber data to the SMF. The UDM function 10-3 is typically provided as a cloud-native function and is typically paired with one or more user data repositories (UDRs) which store user data such as customer profile information, customer authentication information, and encryption keys for the information. Effectively, user information is stored in the UDR, and the UDM function 10-3 retrieves the data, sends it to other network functions, and generally manages it. The UDM 10-3 uses microservices to communicate between the user plane and the control plane.

The RAN 5 of the communication system 1 is configured to operate at least one cell 9 on an associated TDD carrier that operates in unpaired spectrum. It will be appreciated that the RAN 5 may also operate at least one cell 9 on an associated FDD carrier that operates in paired spectrum.

The RAN 5 is also configured for transmission of, and the UEs 3 are configured for the reception of, control information and user data via a number of downlink (DL) physical channels and for transmission of a number of physical signals. The DL physical channels correspond to resource elements (REs) carrying information originated from a higher layer, and the DL physical signals are used in the physical layer and correspond to REs which do not carry information originated from a higher layer.

The physical channels may include, for example, a physical downlink shared channel (PDSCH), a physical broadcast channel (PBCH), and a physical downlink control channel (PDCCH). The PDSCH carries data sharing the PDSCH's capacity on a time and frequency basis. The PDSCH can carry a variety of items of data including, for example, user data, UE-specific higher layer control messages mapped down from higher channels, system information blocks (SIBs), and paging. The PDCCH carries downlink control information (DCI) for supporting a number of functions including, for example, scheduling the downlink transmissions on the PDSCH and also the uplink data transmissions on a physical uplink shared channel (PUSCH). The PBCH provides UEs 3 with the Master Information Block, MIB. It also, in conjunction with the PDCCH, supports the synchronisation of time and frequency, which aids cell acquisition, selection and re-selection.

The DL physical signals may include, for example, reference signals (RSs) and synchronization signals (SSs). A reference signal (sometimes known as a pilot signal) is a signal with a predefined special waveform known to both the UE 3 and the RAN 5. The reference signals may include, for example, cell specific reference signals, UE-specific reference signal (UE-RS), downlink demodulation signals (DMRS), and channel state information reference signal (CSI-RS).

Similarly, the UEs 3 are configured for transmission of, and the RAN 5 is configured for the reception of, control information and user data via a number of uplink (UL) physical channels corresponding to REs carrying information originated from a higher layer, and UL physical signals which are used in the physical layer and correspond to REs which do not carry information originated from a higher layer. The physical channels may include, for example, the PUSCH, a physical uplink control channel (PUCCH), and/or a physical random-access channel (PRACH). The UL physical signals may include, for example, demodulation reference signals (DMRS) for a UL control/data signal, and/or sounding reference signals (SRS) used for UL channel measurement.

### Frame Structure

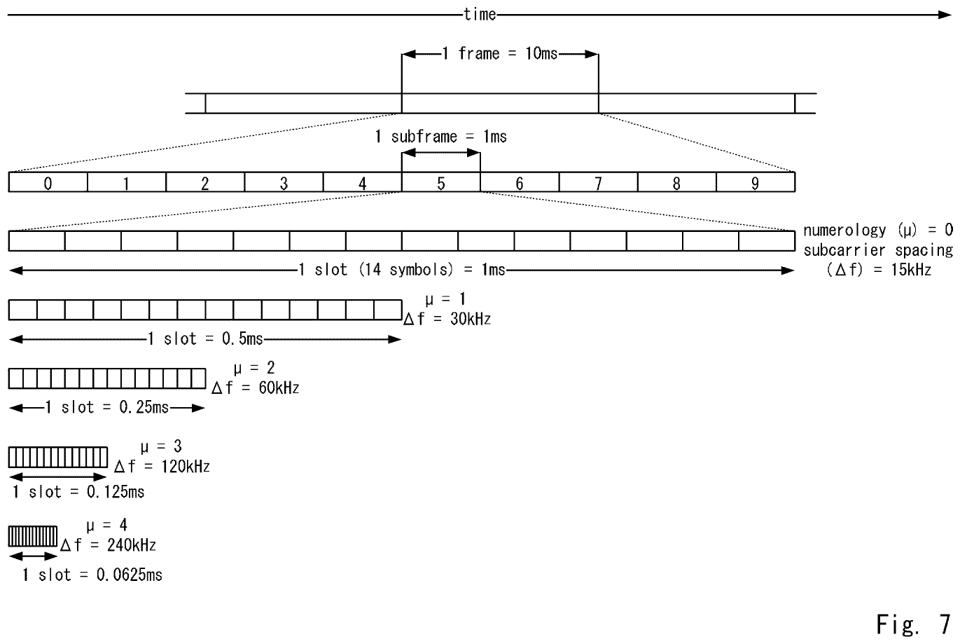

Referring to FIG. 7, which illustrates the typical frame structure that may be used in the communication system 1, the RAN 5 and UEs 3 of the communication system 1 communicate with one another using resources that are organised, in the time domain, into frames of length 10 ms. Each frame comprises ten equally sized subframes of 1 ms length. Each subframe is divided into one or more slots comprising 14 Orthogonal frequency-division multiplexing (OFDM) symbols of equal length.

As seen in FIG. 7, the communication system 1 supports multiple different numerologies (subcarrier spacing (SCS), slot lengths and hence OFDM symbol lengths). Specifically, each numerology is identified by a parameter, μ, where μ=0 represents 15 kHz (corresponding to the LTE SCS). Currently, the SCS for other values of μ can, in effect, be derived from μ=0 by scaling up in powers of 2 (i.e. SCS=15×2μ kHz). The relationship between the parameter, μ, and SCS (Δf) is as shown in Table 1:

TABLE 1
5G Numerology

| | | Number of slots | Slot length |
|---|---|---|---|
| μ | Δf = 2^{μ} · 15[kHz] | per subframe | (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

### General Slot Configuration

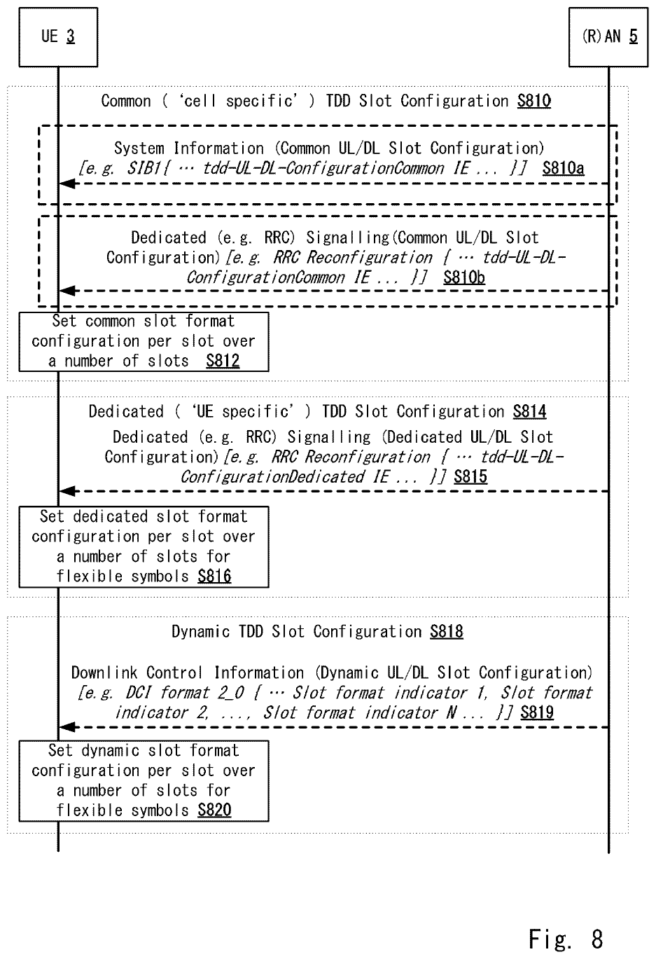

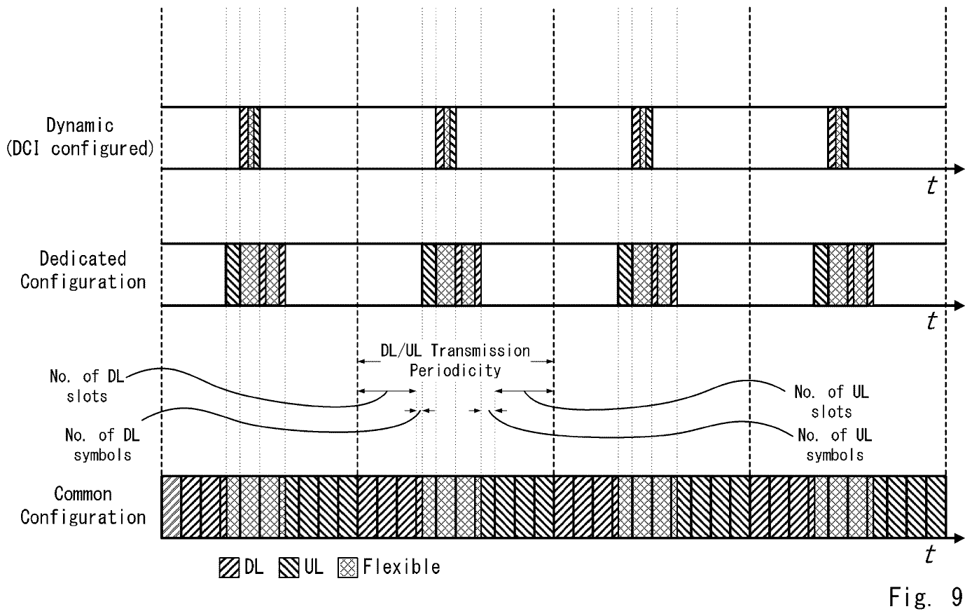

Referring to FIGS. 8 and 9 the RAN 5 configures the slot usage within each cell 9 operated on a TDD carrier appropriately.

As seen in FIG. 8, which is a simplified sequence diagram illustrating different slot configuration procedures (S810, S814, S818) that can be employed in the communication system 1, the RAN 5 is capable of employing a number of different procedures for configuring slot usage in each cell 9 operated on the TDD carrier.

As seen in procedure S810, for example, the RAN 5 of the communication system 1 is configured for providing a respective common (or ‘cell specific’) slot configuration, for each cell 9 operated on a TDD carrier. This common slot configuration can be provided using system information (as illustrated at S810a) to all UEs 3 within the cell (for example in a tdd-UL-DL-ConfigurationCommon information element (IE) of system information block type 1 (SIB1)). This common slot configuration can also be provided using dedicated (e.g., radio resource control (RRC)) signalling (as illustrated at S810b) to specific UEs 3 within the cell (for example in a tdd-UL-DL-ConfigurationCommon IE of an RRC message such as an RRC reconfiguration message or the like). On receipt of the common slot configuration a UE 3 can thus set a common slot format configuration per slot over a number of slots (as seen at S812).

As seen in FIG. 9, which shows illustrative examples of slot configurations configured by the procedures of FIG. 8, the slots may be configured as downlink only slots, as uplink only slots, or as unallocated or ‘flexible’ slots (that may be downlink or uplink).

The common slot configuration is defined by a number of parameters provided by the RAN 5 as part of a common UL/DL slot configuration. These parameters include: a slot configuration period (e.g., configured by a dl-UL-TransmissionPeriodicity IE); a number of slots with only downlink symbols (e.g., configured by a nrofDownlinkSlots IE); a number of downlink symbols (e.g., configured by a nrofDownlinkSymbols IE); a number of slots with only uplink symbols (e.g., configured by a nrofUplinkSlots IE); and a number of uplink symbols (e.g., configured by a nrofUplinkSymbols IE). As seen in FIG. 9, these effectively configure a repeating pattern of slot types (repeating at the slot configuration period), which in this example comprises DL only slots and symbols, followed by flexible slots and symbols, followed by UL only slots and symbols. The repeating pattern starts with a DL group comprising the defined number of DL only slots followed by the defined number of DL only symbols in the next slot. The repeating pattern ends with a UL group comprising the defined number of UL only slots preceded by the defined number of UL only symbols in the preceding slot. The flexible symbols and slots are those, between the DL group of DL only slots and symbols and the UL group of UL only slots and symbols.

As seen in procedure S814, the RAN 5 of the communication system 1 is also configured for providing, if required, a dedicated (or ‘UE specific’) slot configuration for a specific UE 3. This dedicated slot configuration can be provided using dedicated (e.g., radio resource control (RRC)) signalling (as illustrated at S815) to a specific UE 3 within the cell (for example in a tdd-UL-DL-ConfigurationDedicated IE of an RRC message such as an RRC reconfiguration message or the like).

If a UE 3 is provided with the dedicated slot configuration in addition to the common slot configuration, then the dedicated slot configuration overrides only the symbols and slots configured as flexible symbols and slots, per slot, over the number of slots configured by the common slot configuration (as seen in the example of FIG. 9).

The dedicated configuration, if provided, includes one or more individual slot specific configurations (e.g., using a slotSpecificConfigurationsToAddModList IE) in which each slot configuration contains information (e.g., a slotindex IE) identifying a specific slot within the slot configuration period defined by the common slot configuration, and information defining a symbol structure (e.g., a symbols IE). The information defining the symbol structure provides the direction (downlink or uplink) for the symbols within the specific slot that is being configured. The information defining the symbols structure may, for example: indicate that all symbols in the specific slot are used for the downlink (e.g., by setting the symbols IE to ‘allDownlink’); indicate that all symbols in the specific slot are used for the uplink (e.g., by setting the symbols IE to ‘allUplink’); or explicitly indicate how many symbols at the beginning and the end of the specific slot are allocated to downlink and uplink, respectively (e.g., a nrofDownlinkSymbols IE may indicate the number of consecutive downlink symbols in the beginning of the slot identified by the slot index, and a nrofUplinkSymbols IE may indicate the number of consecutive uplink symbols at the end of the slot identified by the slot index).

A UE 3 can thus set a dedicated slot format configuration per slot over a number of slots (as seen at S816).

A UE 3 thus teats symbols in a slot indicated as downlink by the common slot configuration, or by the dedicated slot configuration, as being available for receptions. Similarly a UE 3 teats symbols in a slot indicated as uplink by the common slot configuration, or by the dedicated slot configuration, as being available for transmissions.

Even after the slot configurations in a cell-specific and UE-specific manner described above, the slot configuration may have some more flexible slots/symbols left unallocated. By making use of layer 1 signalling, the remaining (if any) flexible symbols can be reconfigured dynamically.

As seen in procedure S818, for example, the RAN 5 of the communication system 1 is also configured for providing one or more dynamic slot configurations to a group of one or more UEs 3 by means of a physical downlink control channel (PDCCH). One or more dynamic slot configurations can be provided using downlink control information (DCI) using an appropriate DCI format (e.g., DCI format 2_0), as illustrated at S819, to a specific group of one or more UEs 3 within the cell 9.

Indexes of one or more slot format indicators (SFIs) are provided within the payload of the DCI for the group of one or more UEs 3. To allow the DCI to be addressed to and decoded by one or more UEs 3 of the group, cyclic redundancy check (CRC) bits of the DCI are scrambled with an associated radio network temporary identifier (RNTI), for example a slot format indicator RNTI (′SFI-RNTI′) or the like. One or more UEs in the group are allocated with the same RNTI. Each UE 3 of the group is configured to extract its own SFI-index based on the position of the SFI-index within the DCI payload (this position may, for example, be configured by UE specific RRC signalling). The RRC configuration may, for example, be by means of an RRC message carrying a PDCCH serving cell configuration IE having a slot format indicator (SFI) IE that, for a specific serving cell (identified by a serving cell ID (e.g., by a servingCellId IE)): provides an SFI-RNTI; defines one or more slot format combinations (e.g., by a slotFormatCombinations IE); and specifies the starting position (bit), in the DCI, of the SFI index that is applicable for the configured UE (e.g., by a positionInDCI IE).

Each SFI-index provided by the DCI acts as a pointer to a combination of slot formats (where each slot format corresponds to a respective combination of downlink, uplink, and/or flexible symbols) for defining a slot format for each slot in a number of slots starting from a slot where the UE detects the dynamic slot configuration DCI format.

Thus, for any slot indicated to a UE 3 as flexible by both a common slot configuration and a dedicated slot configuration, the DCI can be used to dynamically configure downlink, uplink, and/or flexible symbols within that slot (as seen in the example of FIG. 9).

A UE 3 can thus set a dynamic slot format configuration per slot over a number of slots (as seen at S820).

### Bandwidth Parts (BWPs)

In the communication system 1 the cell bandwidth can be divided into multiple bandwidth parts (BWPs) that each start at a respective common resource block (RB) and respectively comprises of a set of contiguous RBs with a given numerology (sub-carrier spacing, ‘SCS’, and cyclic prefix, ‘CP’) on a given carrier. It will be appreciated that conventionally the number of downlink symbols, uplink symbols, and flexible symbols in each slot of the slot configuration (e.g., common or dedicated) would be common to each configured BWP.

The UEs 3 and RAN 5 of the communication system 1 are thus configured for operation using BWPs. For each serving cell of a UE 3, the RAN 5 can configure at least one downlink (DL) BWP (e.g., an initial DL BWP). The RAN 5 may configure the UE 3 with up to a maximum (typically four) DL BWPs with only a single DL BWP being active at a given time. The UE 3 is not expected to receive PDSCH, PDCCH, or CSI-RS (except for radio resource management (RRM)) outside an active bandwidth part. Where the serving cell is configured with an uplink (UL), the RAN 5 can configure at least one UL BWP (e.g., an initial UL BWP). The RAN 5 may configure the UE 3 with up to a maximum (typically four) UL BWPs with only one UL BWP being active at a given time. The UE 3 does not transmit PUSCH or PUCCH outside an active bandwidth part. For an active cell, the UE 3 does not transmit SRS outside an active bandwidth part. It will be appreciated that the slot format indicator (e.g., an SFI-index field value) in the dynamic slot configuration DCI format may indicate to a UE 3 a slot format for each slot in a number of slots for each DL BWP or each UL BWP.

A BWP identifier or index (BWP-ID) is used to refer to BWPs (in UL and DL independently). Various radio resource control (RRC) configuration procedures can thus use the BWP-ID to associate themselves with a particular BWP.

While for paired spectrum (FDD), DL BWPs and UL BWPs are configured separately, for unpaired spectrum (TDD), a DL BWP is effectively linked to (paired with) a UL BWP, with the paired DL BWP and UL BWP sharing the same BWP-ID and centre frequency (but possibly different bandwidths).

Specifically, the RAN 5 is able to configure an initial DL BWP (e.g. by means of an initialDownlinkBWP IE) via system information (e.g. system information block 1, ‘SIB1’) and/or via dedicated (e.g. RRC) signalling (e.g. an RRC reconfiguration, RRC resume, or RRC setup message). For example, the common parameters for the initial DL BWP may be provided via system information whereas UE specific parameters may be provided via dedicated signalling (e.g. in a ServingCellConfig IE within an RRC message that contains a dedicated, UE-specific, BWP configuration). The dedicated signalling may also contain some cell-specific information which may be useful for specific scenarios (e.g. handover).

The RAN 5 is able to configure an initial UL BWP (e.g. by means of an initialUplinkBWP IE) via system information (e.g. system information block 1, ‘SIB1’) and/or via dedicated (e.g. RRC) signalling (e.g. an RRC reconfiguration, RRC resume, or RRC setup message). For example, the common parameters for one or more initial UL BWPs may be provided via system information whereas UE specific parameters may be provided via dedicated signalling (e.g. in a ServingCellConfig IE within an RRC message that contains a dedicated, UE-specific, BWP configuration). This provides configuration information either for a so-called special cell (SpCell)—which is a primary cell (PCell) of a master cell group (MCG) or secondary cell group (SCG)—or a secondary cell (SCell).

The initial DL and UL BWPs are used at least for initial access before an RRC connection is established. The initial BWP is known as BWP #0 as it has a BWP identifier (or ‘index’) of zero. Prior to receiving system information defining a UE's initial DL BWP, the DL BWP for each UE 3 has a frequency range and numerology corresponding to a control resource set (CORESET)—e.g. CORESET #0—defined by a master information block (MIB) (or possibly dedicated RRC signalling). The CORESET is used to carry downlink control information (DCI) transmitted via a PDCCH for scheduling system information blocks.

After receiving the system information (e.g. SIB1) a UE 3 uses the BWP configuration defined by that system information to configure the initial DL BWP and initial UL BWP. The configured initial UL BWP is then used to initiate a random-access procedure for setting up an RRC connection. The RAN 5 configures the frequency domain location and bandwidth of the initial DL BWP in the system information so that the initial DL BWP contains the entire CORESET #0 in the frequency domain.

For each DL BWP in a set of DL BWPs for a primary cell (PCell), a UE 3 can be configured with CORESETs for every type of common search space (CSS) set (sometimes referred to as a cell-specific search space (CSS)) and for a UE-specific search space (USS) set. For each UL BWP in a set of UL BWPs of a PCell, or of a PUCCH-secondary cell, the UE 3 is configured resource sets for PUCCH transmissions.

The UE 3 is configured for switching its active BWP between its configured BWPs when required. For example, switching at the UE 3 may be initiated by receipt of a scheduling DCI, by expiry of an inactivity timer (e.g., a BWPInactivity Timer), and/or by initiation of a random-access procedure.

### Provision of Full Duplex

The UEs 3 and RAN 5 of the communication system 1 are mutually configured for providing full duplex (FD) communication on a TDD carrier. Specifically, the UEs 3 and RAN 5 of the communication system 1 are configured to facilitate subband non-overlapping FD (SBFD) communication.

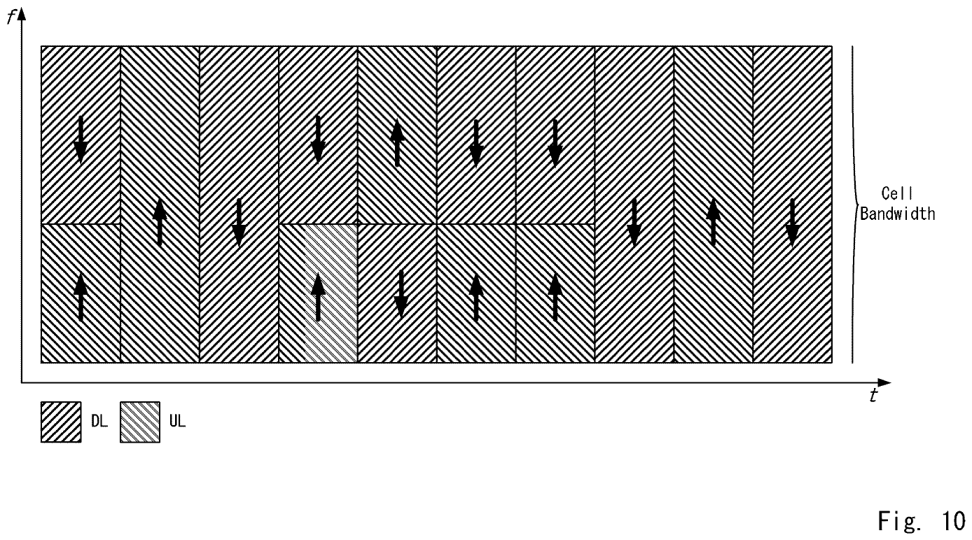

For example, as seen in FIG. 10, which is a simplified time frequency diagram showing an illustrative example of a full duplex configuration that may be used in the communication system 1, the different UE specific slot configurations allow a slot within the cell bandwidth to effectively be configured as an FD slot by configuring that slot for one UE as an uplink slot, while the same slot is configured as a downlink slot for another UE (or vice versa). Thus, UL communication from one UE 3 in the cell bandwidth may occur in parallel with DL communication to another UE 3. It will be appreciated that while not specifically illustrated the parallel UL/DL communication may be configured at a symbol level as well as at the slot level.

It will be appreciated that the RAN 5 is configured to schedule frequency resources of any slot configured as an FD slot, to ensure that the frequency resources scheduled for UL communication by one UE 3 are part of a different subband than the frequency resources scheduled for DL communication to another UE 3. Accordingly, subband non-overlapping FD communication can thus take place at the RAN 5 while half-duplex communication takes place at the UEs 3.

The RAN 5 is thus able to configure one or more of the slots (and/or symbols) of the TDD carrier as FD slots (and/or symbols) or more specifically, in a case where, subband non-overlapping full duplex (SBFD) is used for full duplex operation, SBFD slots (and/or symbols). For convenience, slots/symbols which contain both UL and DL subbands, from the RAN's perspective, will be referred to generally as ‘SBFD’ slots/symbols, or slots/symbols with a configured UL subband/DL subband. Other slots/symbols, which only contains communication in a single transmission direction (UL or DL) will generally be referred to as legacy (UL or DL) slots/symbols or non-SBFD (UL or DL) slots/symbols.

It will be appreciated that, from a UE perspective, an SBFD slot or symbol may appear to be a legacy UL, DL, or flexible symbol because the UE 3 is operating using half duplex on the TDD carrier. Nevertheless, a UE 3 may be informed of the FD/SBFD slots/symbols, either implicitly or explicitly, to allow the UE 3 to assist with interference avoidance/alleviation. For example, if the UE 3 can identify the FD/SBFD slots/symbols then the UE 3 may: contribute to the implementation of an appropriate frequency gap between the frequency resources used by that UE 3 (e.g., for UL or DL) and the frequency resources used by another UE 3 (e.g., for DL or UL); avoid, reconfigure, and/or apply updated resources, in respect of certain transmissions/receptions (e.g., for semi-static transmission such as SPS).

For example, the RAN 5 may explicitly indicate which slots/symbols are configured as FD/SBFD type slots/symbols, for example, dynamically using DCI with an appropriate DCI format and/or using a Medium Access Control (MAC) Control Element (CE). The RAN 5 may, alternatively or additionally explicitly indicate which slots/symbols are configured as FD/SBFD type slots/symbols via system information or dedicated (RRC) signalling (for example, by means of frame structure signalling similar to that used for the cell specific and/or dedicated TDD UL/DL slot configuration). A UE 3 may implicitly determine whether a slot/symbol is configured as an FD/SBFD type slots/symbol based on other information received from the network (RAN 5). For example, the UE may assume that an SBFD slot occurs when the RAN 5 indicates that an UL transmission is to take place during a DL configured slot or that a DL transmission is to take place during a UL configured slot.

It will be appreciated that there are different variations which exist for implementation of SBFD, and the communication system 1 may be configured to provide support for any suitable SBFD schemes. Such schemes may include, for example, inter-BWP full duplex and/or intra-BWP full duplex.

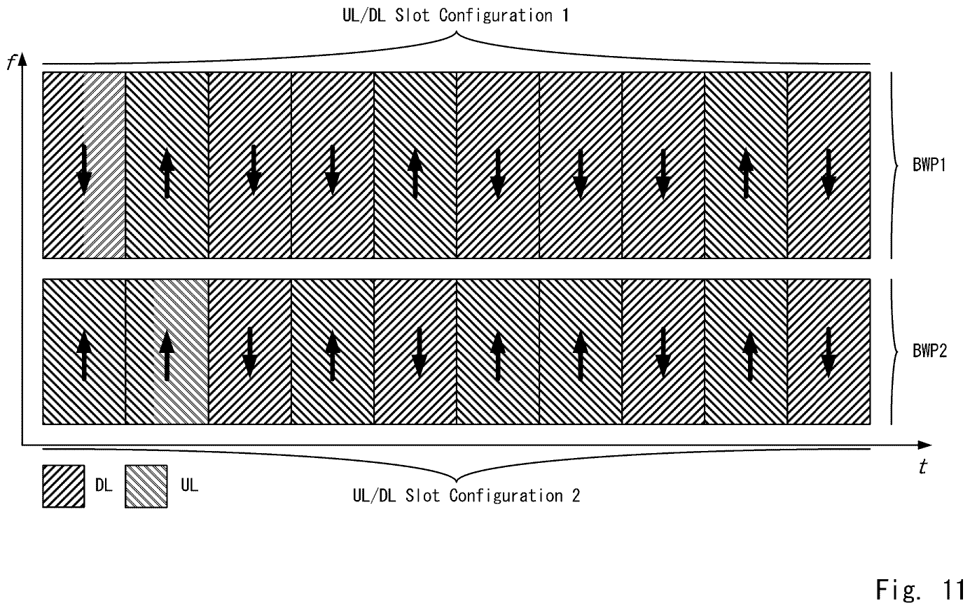

Referring to FIG. 11, for example, which is a simplified time frequency diagram showing an illustrative example of an inter-BWP type of full duplex configuration, inter-BWP full duplex involves parallel UL and DL transmission in different BWPs in which a particular slot of one BWP may be configured as an uplink slot while the corresponding slot (i.e., having the same timing) in another BWP may be configured as a downlink slot (or vice versa). Thus, UL from one UE 3 in one BWP may occur in parallel with DL communication to another UE 3 in another BWP.

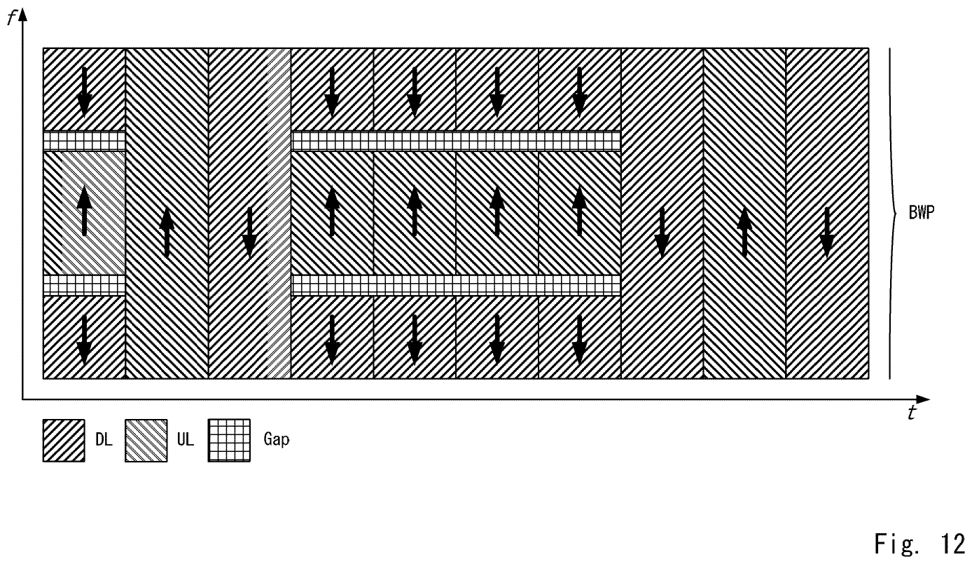

Referring to FIG. 12, on the other hand, which is a simplified time frequency diagram showing an illustrative example of an intra-BWP type of full duplex configuration, intra-BWP full duplex involves parallel UL and DL transmission in the same BWP. In the example illustrated in FIG. 12, an UL subband is effectively inserted within a slot/symbol configured as a (legacy) DL or flexible slot/symbol of a BWP. Specifically, each time resource of the BWP is configured as a DL, a UL, or a flexible slot/symbol (for example using a TDD configuration technique as described with reference to FIGS. 8 and 9). An UL subband (e.g., a set of contiguous UL frequency resources) is then configured within the BWP for at least a subset of one or more of the DL or flexible slots/symbols to effectively form a slot/symbol that consists of a UL subband and one or two DL subbands. The configuration of one or more UL subbands may be achieved in any suitable way, for example by semi-static configuration and/or dynamic configuration. A guard band (frequency gap) may be configured, between the UL subband and each DL subband, where no transmission is performed, thereby helping to avoid interference. The RAN 5 can then schedule UL transmission in the UL subband and DL transmission in one or more DL subbands as necessary.

It will also be appreciated that while FIG. 12 shows a UL subband being inserted in a downlink or flexible slot/symbol, a similar mechanism may also be used to insert a DL subband within an UL or flexible slot/symbol to achieve SBFD.

Notwithstanding that an UL (or DL) subband may be configured in a slot/symbol configured (e.g., by a TDD configuration) as a DL (or UL) slot/symbol, it will be appreciated that it would be particularly beneficial for the RAN to be able to schedule DL (or UL) transmission within a configured UL (or DL) subband dynamically (for example, when there is no UL (or DL) transmission required) to improve radio resource utilisation.

Segregation of Different Antenna Elements into UL and DL

In the communication system 1, the RAN 5 may also be configured for, in one or more same SBFD slots (or symbols), transmission to a UE 3 in the downlink via a first set (or group) of antenna elements, and for reception from another UE 3 in the uplink via a second set (or group) of antenna elements that is spatially separated from the first set of antenna elements. This spatial separation between the antenna elements used for UL and DL can result in lower interference being observed during UL reception at the RAN 5.

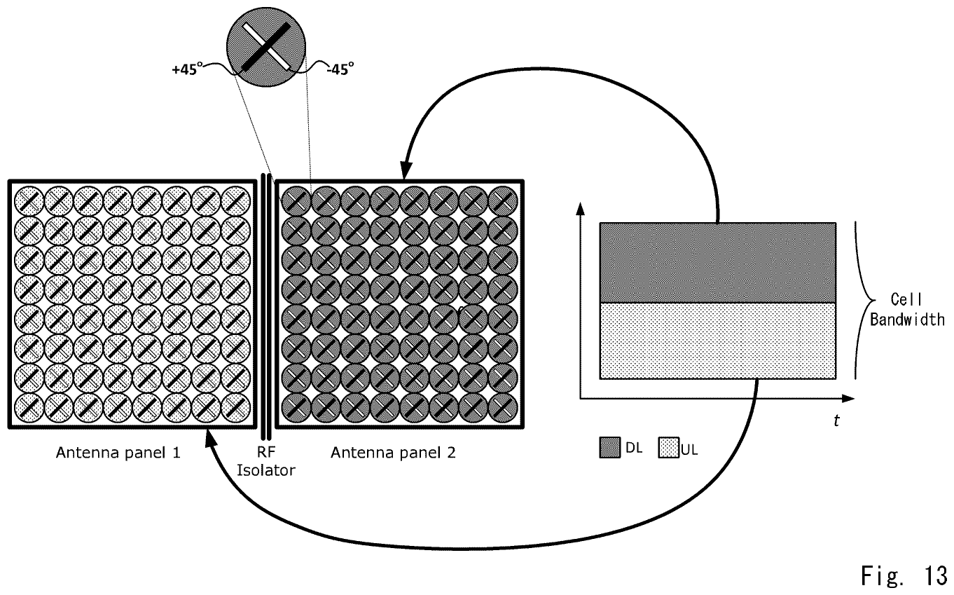

Referring to FIG. 13 which is a simplified illustration of an antenna panel configuration for full duplex communication in the communication system 1, the spatial separation is achievable by using a different antenna panel for DL communication than is used for UL communication. A radio frequency (RF) isolator is also provided in this example to further reduce any interference during UL reception at the RAN 5.

During legacy TDD slots/symbols (e.g., dedicated UL only slots/symbols or dedicated DL only slots/symbols) antenna elements of both the first and second sets of antenna elements can still be used for the same transmission direction (e.g., reception in UL/transmission in downlink).

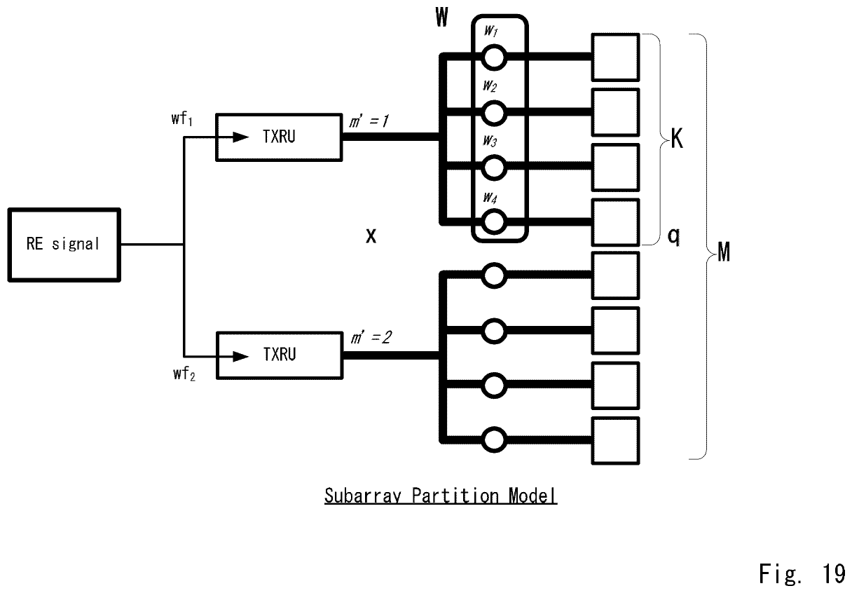

As described above, the RAN 5 (or another similar RAN 5 of the communication system 1) may have a single panel. For a RAN 5 that communicates via a single antenna panel, the RAN 5 may, beneficially, be configured for in panel segregation of antenna elements. One such arrangement is illustrated in FIG. 19, which is a simplified illustration of another antenna panel configuration for full duplex communication in the communication system 1.

### TDD Configuration Exchange (e.g., DU-CU/F1 Interface)

For RANs 5 comprising a DU 5b and CU 5c, both the DU 5b and CU 5c can exchange TDD slot configuration information (e.g., over the DU-to-CU/F1 interface) to ensure that the both the DU 5b and CU 5c are each aware of one or more relevant TDD slot configurations applicable at/known by the other unit.

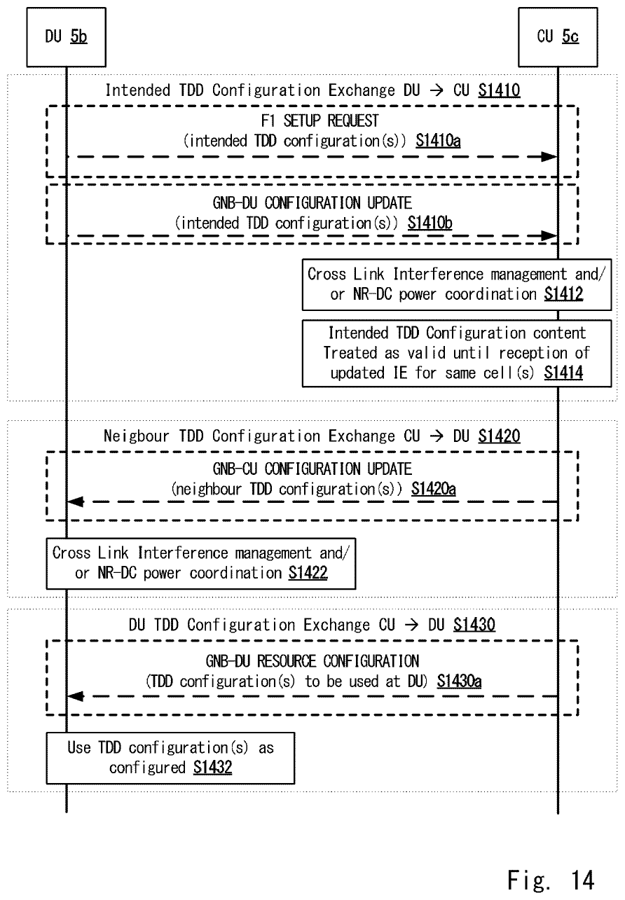

FIG. 14 is a simplified sequence diagram illustrating different procedures (S1410, S1420, S1430), for exchanging slot (TDD) configurations, that may be employed in the communication system 1.

As seen in FIG. 14, in one procedure S1410, a given DU 5b can provide information indicating that DU's intended TDD (UL and/or DL) configuration to the CU 5c (e.g., as part of an ‘Intended TDD DL-UL Configuration’ information element (IE)). This information may, for example, comprise the subcarrier spacing, cyclic prefix and TDD DL-UL slot configuration of a cell that the receiving CU 5c needs to take into account for cross-link interference mitigation, and/or for dual connectivity (DC) power coordination, when operating its own cell.

The information identifying the intended TDD configuration may, for example, be provided as part of a procedure for exchanging application level data needed for the DU 5b and the CU 5c to correctly interoperate over the DU-CU (‘F1’) interface (end hence create a logical (e.g., ‘F1’) connection between the CU 5c control plane and the DU 5b). The DU 5b may, for example, provide the information indicating that DU's intended TDD configuration to the CU 5c in a setup request message (e.g., F1 Setup Request) for initiating the procedure (as seen at S1410a). While not shown in FIG. 14, the CU 5c (control plane) may complete the procedure by returning an appropriate setup response (e.g., a F1 Setup Response). The setup request may include information for informing the CU 5c (control plane) about the DU's identity and the set of cells supported by the DU 5b. The setup response may include information for informing the DU 5b which cells should be activated at the DU 5b.

Alternatively, or additionally, information identifying the intended TDD configuration may be provided to the CU 5c by the DU 5b as part of a procedure for updating application level configuration data needed for the DU 5b and the CU 5c to interoperate correctly over the F1 interface. The DU 5b may, for example, provide the information indicating that DU's intended TDD configuration to the CU 5c in a configuration update message (e.g., GNB-DU Configuration Update) as seen at S1410b. While not shown in FIG. 14, the CU 5c may respond by returning an appropriate acknowledgement message (e.g., a GNB-DU Configuration Update Acknowledge).

The receiving CU 5c can thus use the received information identifying the intended TDD configuration for cross link interference management and/or NR-DC power coordination as seen at S1412.

The receiving CU 5c can consider the received intended information identifying the intended TDD configuration to be valid until reception of an update of the of the information identifying the intended TDD configuration for one or more same cells.

As seen in FIG. 14, in another procedure S1420, a given CU 5c can provide information indicating one or more neighbour TDD configurations (e.g., one or more TDD configurations to be used by neighbouring DUs) to the DU 5b (e.g., as part of an ‘Intended TDD DL-UL Configuration NR’ information element (IE)). This information may, for example, comprise the subcarrier spacing, cyclic prefix and TDD DL-UL slot configuration of a cell that a neighbour RAN node needs to take into account for cross-link interference mitigation, and/or for DC power coordination, when operating its own cells.

The information identifying one or more neighbour TDD configurations may, for example, be provided to the DU 5b by the CU 5c as part of a procedure for updating application level configuration data needed for the DU 5b and the CU 5c to interoperate correctly over the F1 interface. The CU 5c may, for example, provide the information indicating one or more neighbour TDD configurations to the DU 5b in a configuration update message (e.g., GNB-CU Configuration Update) as seen at S1420a. While not shown in FIG. 14, the DU 5b may respond by returning an appropriate acknowledgement message (e.g., a GNB-CU Configuration Update Acknowledge). The information identifying one or more neighbour TDD configurations may, for example, be provided along with appropriate cell identification information (e.g., one or more NR cell global identities (NR CGIs)) within a neighbour cell information list.

The receiving DU 5b can thus use the received information identifying one or more neighbour TDD configurations for cross link interference management and/or NR-DC power coordination as seen at S1422.

As seen in FIG. 14, in another procedure S1430, a given CU 5c can provide, to the DU 5b, information indicating one or more TDD configurations to be used by the DU 5b.

The information indicating one or more TDD configurations to be used may, for example, be provided to the DU 5b by the CU 5c as part of a procedure for configuring the resource usage for the DU 5b (e.g., as part of a ‘gNB-DU Cell NA Resource Configuration-TD’ IE/‘gNB-DU Cell Resource Configuration’ IE). This information may, for example, include the subcarrier spacing and slot configuration to be used in a cell.

The CU 5c may, for example, provide the information indicating one or more TDD configurations to be used by the DU 5b in a resource configuration message (e.g., GNB-DU Resource Configuration) as seen at S1430a. While not shown in FIG. 14, the DU 5b may respond by returning an appropriate acknowledgement message (e.g., a GNB-DU Resource Configuration Acknowledge). The information indicating one or more TDD configurations to be used by the DU 5b may, for example, for specific cells and/or integrated access and backhaul (IAB) nodes associated with the DU 5b.

The receiving DU 5b can thus use the received information identifying one or more TDD configurations to be used by the DU 5b for the associated cells/IAB nodes as seen at S1432.

It will be appreciated that whilst any of the procedures described with reference to FIG. 14 may be used in the communication system 1 in isolation, the communication system may be configured with all or a subset of the procedures. For example, the different procedures (S1410, S1420, S1430), for exchanging slot (TDD) configurations, may occur in the sequence illustrated. For example, a DU 5b may send TDD information to a CU 5c indicating its intended TDD configuration during setup, the CU 5c may pass the given intended TDD configuration to other connected CUs 5c or DUs 5b (i.e., as a neighbour TDD configuration) and, if there is no conflict with another DU's TDD configuration, then the CU 5c may indicate to a DU 5b to use a particular TDD configuration.

The TDD configuration configured by a CU 5c to a DU 5b, the intended TDD configuration, and/or the neighbour DU's TDD configuration may include, for example: the subcarrier spacing, cyclic prefix and TDD DL-UL slot configuration of an NR cell. The TDD DL-UL slot configuration may include the DL/UL/flexible slot/symbol information for that cell.

Open Fronthaul (O-FH) Management (M) and Control/User/Synchronisation (CUS) Planes (DU-RU Interface)

The open FH M-plane is used for management of an (open) RU 5a, including the exchange of capability information between the (open) RU 5a and (open) DU 5b. For example, the capability information may indicate the capability of an (open) RU 5a to perform beam forming and/or an antenna structure for the capability information.

The open CUS-plane is used for forwarding of user plane and control plane messages. In this example, a ‘user plane’ message refers to refers to a message carrying IQ sample data for transfer between an (open) DU 5b and (open) RU 5a. A U-plane message may include any radio transmission between the RAN 5 and the UE 3 (including both user data and control messages such as RRC, NAS, PRACH messages or the like). The RU 5a is, in general, unaware of the type of data which is sent by a DU 5b/received by the RU 5a. The RU 5a simply performs forwarding of packets between DU 5b and UE 3 transparently. It will be appreciated that a single user plane message can include one or more transmissions for multiple UEs. A ‘control plane’ message in this example, on the other hand, refers specifically to a message for real-time control between the DU 5b and RU 5a (and should not be confused with messages sent over the UE's control plane). A control plane message will typically carry scheduling information for one or more O-FH user plane messages. Specifically, the control plane message may include information indicating an association between the user plane message and the control plane message including, for example, information identifying a symbol identifier, a slot identifier, a frame identifier, a start physical resource block (PRB) and/or an end PRB (and/or number of contiguous PRBs/length in PRBs). The control plane message may also include information about one or more radio resource (time/frequency) allocations, antenna/beam allocations, cyclic prefix (CP)/CP length to be used, fast Fourier transform (FFT) size, filter identifier/index and/or the like.

The timing relationships between control plane and user plane messages are defined by the O-RAN specification based, for example, on how much earlier a control plane message should be received by an RU 5a before arrival of an associated user plane message, and/or the processing time for user plane messages.

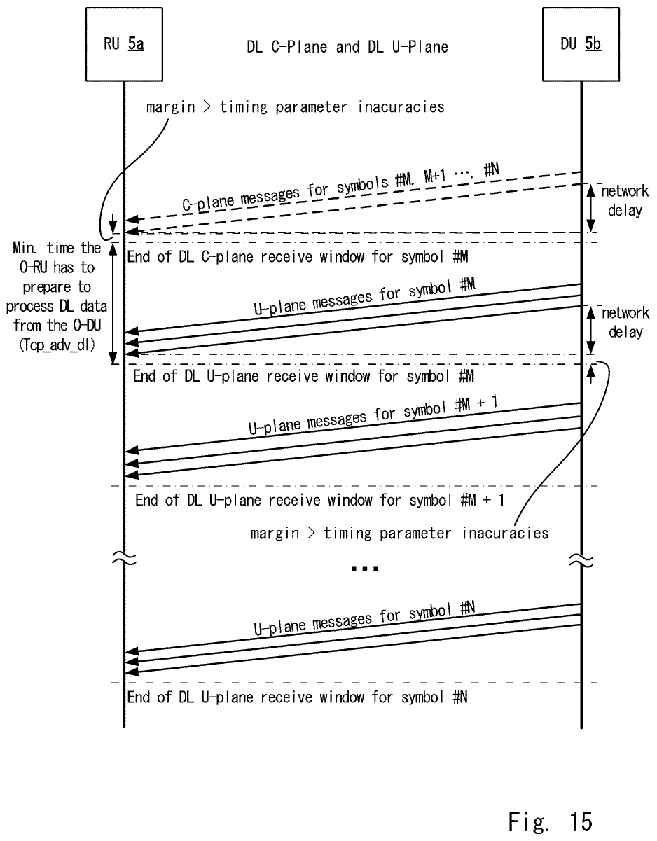

FIG. 15, for example, is a simplified sequence diagram illustrating a control plane and user plane message transfer procedure for sending user plane data in the downlink. It will be appreciated that a similar procedure also applies for sending user plane data in the uplink.

Referring to FIG. 15, the control plane messages for a given slot and one or more given symbols exchanged between the DU 5b and RU 5a are followed by the user plane data for that slot and one or more symbols, one symbol at a time. User plane messages are sent by the DU 5b in the downlink case (and RU 5a in the uplink case) in order of the symbol for which they carry IQ data. Control plane and downlink user plane messages are sent by the DU 5b in advance such that they arrive at RU 5a within a time window that is early enough to leave the RU 5a time to process them. FIG. 15 shows an example in which a DU 5b sends one or more downlink control plane messages describing symbols #M, M+1, . . . , #N of a given slot S in a timing window defined by a maximum time (e.g., defined by a maximum timing parameter such as “Tla_max_cp_dl”) and a minimum time (e.g., defined by a minimum timing parameter such as “Tla_min_cp_dl”) before the start of downlink symbol #M (the earliest symbol described by the message). As shown in FIG. 15, the end of the receive time window for downlink control plane messages describing symbol #M, M+1, . . . , #N of slot S (where M is the earliest symbol described by each of messages) occurs a time period (e.g., defined by another timing parameter such as “Tcp_adv_dl”) earlier than the end of receive time window for downlink user plane messages carrying IQ data for symbol #M. The DU 5b sends (and the RU 5a receives) downlink user plane messages in a specific transmission window (and in a specific reception window).

Similarly, for user plane data in the uplink, the DU 5b sends UL control plane messages describing symbols #M, M+1, . . . , N of slot S in a timing window defined by a maximum time (e.g., defined by a maximum timing parameter such as “Tla_max_cp_ul”) and a minimum time (e.g., defined by a minimum timing parameter such as “Tla_min_cp_ul”) before the start of the uplink symbol #M (the earliest symbol described by the message). The end of receive time window for uplink control plane messages describing symbol #M, M+1, . . . , N (where M is the earliest symbol described by each of messages) occurs a time period (e.g., defined by another timing parameter such as “T2a_min_cp_ul”) earlier than the start of uplink symbol #M. The RU 5a sends (and DU 5b receives) uplink user plane message in a specific transmission window (and in a specific reception window).

As seen in FIG. 15 there is also a period of time between the RU's receipt of control plane messages for a symbol and the need for the RU 5a to process user plane data for that symbol. In particular, in the downlink, there is a period of time (e.g. defined by the parameter “Tcp_adv_dl”) which provides a number of microseconds (or the like) for the RU 5a to, for example, update beamforming weights prior to processing the downlink data arriving from the DU 5b. Similarly, in the uplink there will be a period of time (e.g. defined by parameter “t2a_min_cp_ul”) between the RU 5a receiving the control plane messages governing the processing of uplink data and the receipt of uplink signals at the RU's antennas. These time intervals, when combined with network delays and other processing latencies, result in the RAN 5 using a closed hybrid automatic repeat request (HARQ) loop allowing feedback in the air interface processing.

The control plane messages, and user plane messages are, in the context of the described O-RAN example, transferred using an enhanced Common Public Radio Interface (eCPRI) message structure. eCPRI is a standard for transporting radio signals between CUs/DUs and RUs. The eCPRI standard is designed to enable the transport of high-bandwidth, low-latency data streams over Ethernet-based networks.

O-RAN allows for multiple different transport headers, within an Ethernet payload, to further describe how the application data is to be handled in the control and user planes. In each case the transport header is 8 bytes in length and provides basic data routing capabilities, including description of the data flow type, sending and reception port identifiers, ability to support concatenation of multiple application messages in a single packet, and sequence numbering.

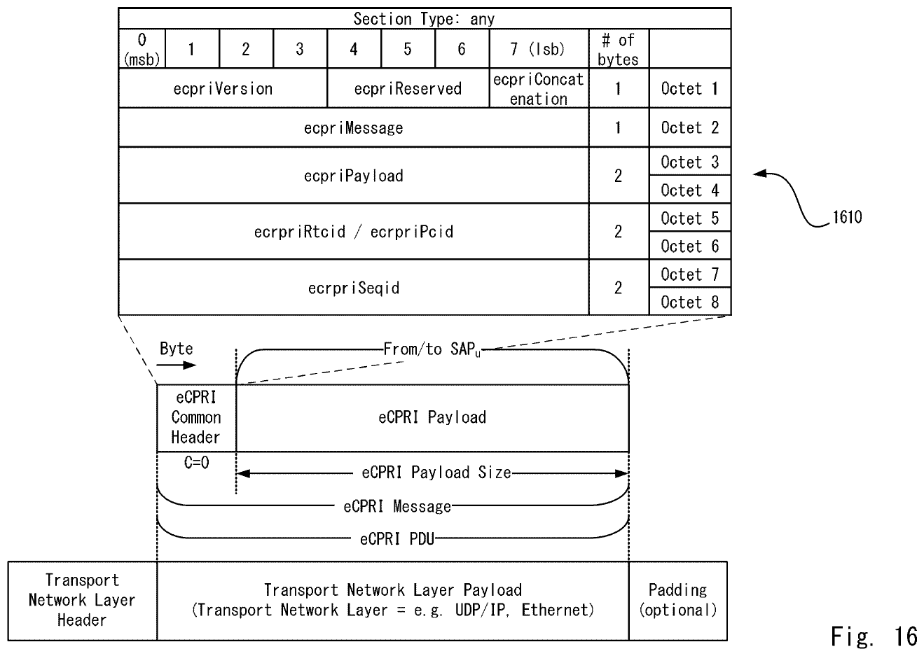

Referring to FIG. 16, which shows an exemplary message structure for control plane and/or user plane messages in the communication system 1 (e.g., an O-FH CUS plane message), a definition of an eCPRI transport header is shown at 1610.

The eCPRI transport header shown at 1610 includes: an eCPRI protocol revision (ecpriVersion) parameter; an eCPRI reserved (ecpriReserved) parameter; an eCPRI concatenation indicator (ecpriConcatenation) parameter; an eCPRI message type (ecpriMessage) parameter; an eCPRI payload size (ecpriPayload) parameter; a real time control data/IQ data transfer message series (ecpriRtcid/ecpriPcid) parameter; and a message identifier (ecpriSeqid) parameter.

The eCPRI protocol revision (ecpriVersion) parameter indicates the eCPRI protocol version. The eCPRI reserved (ecpriReserved) parameter is reserved for eCPRI future use. The eCPRI concatenation indicator (ecpriConcatenation) parameter indicates when eCPRI concatenation is in use (allowing multiple eCPRI messages in a single Ethernet payload). The eCPRI message type (ecpriMessage) parameter indicates the type of service conveyed by the message type. The eCPRI payload size (ecpriPayload) parameter represents the size in bytes of the payload part of the corresponding eCPRI message. The real time control data/IQ data transfer message series (ecpriRtcid/ecpriPcid) parameter is an ‘enhanced’ antenna-carrier (eAxC) identifier (eAxC ID) that identifies a specific data flow associated with each control plane (ecpriRtcid) or user plane (ecpriPcid) message—this effectively identifies the antenna carrier, component carrier and multiple input multiple output (MIMO) stream. The message identifier (ecpriSeqid) parameter provides unique message identification and ordering on two different levels. The first octet of the ecpriSeqid parameter is the Sequence ID, which is used to identify ordering of messages within an eAxC message stream.

### TDD Pattern Configuration

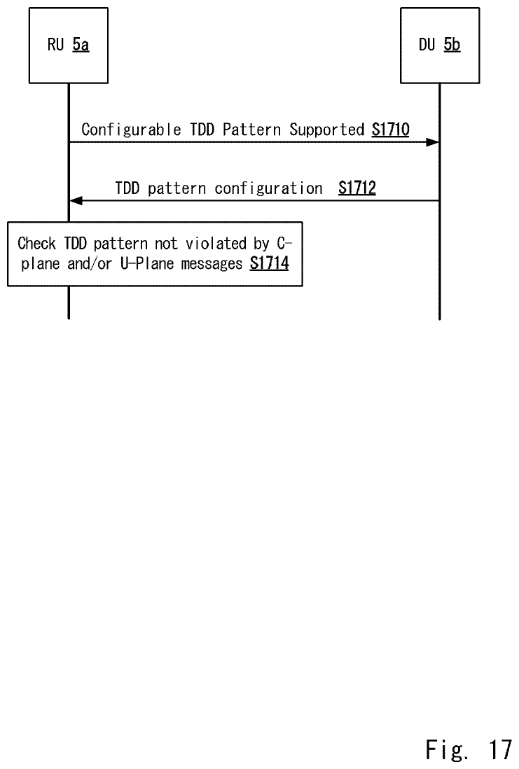

Referring to FIG. 17, which is a simplified sequence diagram illustrating a procedure for configuring TDD patterns at a radio/remote unit in the communication system 1, the (open) RU 5a can expose its ability to support TDD pattern configuration by indicating support of a configurable TDD pattern supported (CONFIGURABLE-TDD-PATTERN-SUPPORTED) feature (S1710).

The (open) DU 5b can thus configure a TDD pattern configuration for the RU 5a (S1712). A single TDD pattern configuration may include a list of records (e.g., a respective record for each of a plurality of different channels/carriers). Each record may, for example, include details of a frame-offset and ‘direction’ of a signal, that shall be applied at the moment a specific frame-offset occurs at that air interface. The supported directions include, for example, uplink, and guard period (GP)—i.e., neither uplink nor downlink. The RU 5a checks that the configured TDD pattern is not violated by any control plane and/or user plane messages as S714.

### Antenna Panel Configuration/Beamforming

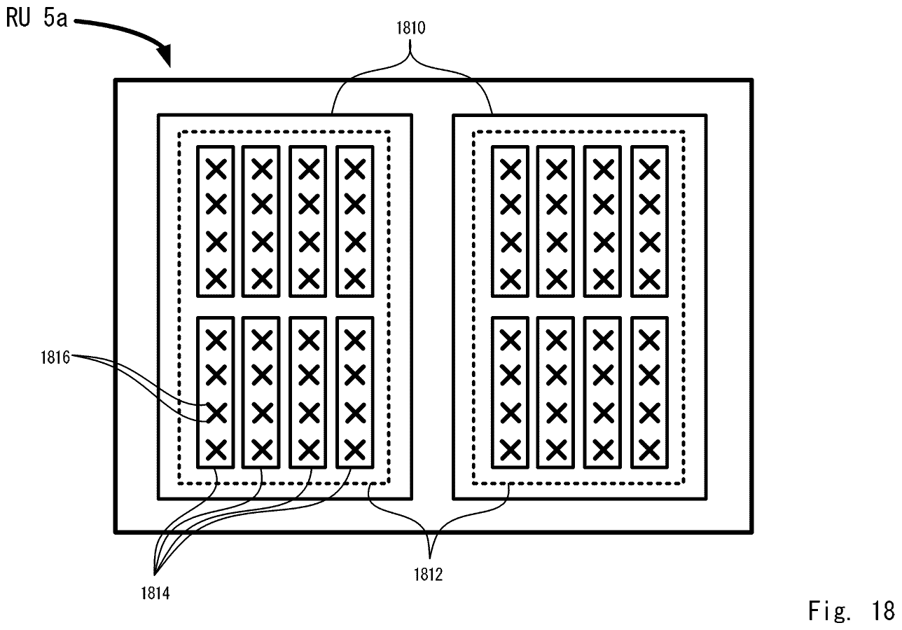

Referring to FIG. 18, which is a simplified illustration of an antenna panel configuration for a RU 5a of the RAN 5 in the communication system 1, the RU 5a includes an antenna that has a plurality of antenna panels 1810 (two in this example although more are possible). Each antenna panel 1810 comprises at least one antenna array 1812, which may be transceiver (TX) and/or a receiver antenna array. Each antenna array includes a respective arrangement of a plurality of array elements 1814 (in the example eight arranged in two rows of four, although any suitable arrangement of any appropriate number is possible). Each array element 1814 comprises, in this example, a plurality of physical antenna elements 1816 (also referred to as ‘radiators’) arranged in cross-polar pairs of antenna elements. In this example, each array element 1814 has eight physical antenna elements 1816 are arranged in a single column of four cross-polar pairs but it will be appreciated that an array element may have any suitable number of antenna elements including a single cross-polar pair of antenna elements in any suitable arrangement. In the illustrated example each cross-polar pair 1816 comprises a plus 45° antenna element and a minus 45° antenna element although it will be appreciated that other arrangements are possible.

The configuration of a two-dimensional planar uniformly spaced antenna array may be represented by a model (M, N, P) where:
M is the number of antenna elements with the same polarization in each column;
N is the number of columns; and
P is the number of polarization dimensions

It will be appreciated that while the RU 5a of the RAN 5 is described as having a plurality of antenna panels the RU 5a may have a single panel because at least some operators currently support a single antenna panel per RAN site. The UE 3 may, of course, also have an antenna having multiple antenna elements.

The use of antennas with multiple physical antenna elements allows the RAN 5 and UE 3 to perform transmissions (and receptions) using logical antenna ports that are mapped to a subset of one or more of the physical antenna elements 1816. Transmissions sharing the same antenna port will therefore experience the same propagation channel.

The use of logical antenna ports at the RU 5a or UE 3 allows multiple input multiple output (MIMO) communication in which plural streams of data (referred to as ‘transmission layers’) may be transmitted (or received), in parallel, using the same time and frequency resources but via different logical antenna ports. Moreover, the ability to map a given logical antenna port to a subset including a plurality of physical antenna elements allows the RAN 5 (or UE 3) to beamform transmissions made via that logical antenna port (i.e., by applying an appropriate amplitude and/or phase adjustments at each physical antenna element 1816).

Accordingly, a distributed RAN 5 may beamform via the antenna panels 1810 of the RU 5a by controlling the amplitude and phase of each array element 1814 within an antenna array 1812. In general, the amplitude and phase of the radiators 1816 within an array element are not changed dynamically in real time. Each TX antenna array/RX antenna array 1812 may, in effect, terminate one or more RU logical antenna ports (identified by RU_port_IDs).

Each RU 5a has a number of transceiver units (TXRUs). Each TXRU includes an FFT unit and, for the purposes of beamforming, frequency domain weights (i.e., for adapting the phase and/or amplitude) can be applied, before the FFT stage, within the TXRU.

Each TXRU is mapped to a group (e.g., a column for elevation beamforming) of antenna elements arranged using an appropriate mapping function. There are a number of different possible TXRU architectures and corresponding TXRU virtualization weight functions for implementing different possible beamforming scenarios.

A TXRU model may be used to represent the arrangement of TXRUs. A possible TRXU model, for example, corresponds broadly to the antenna array model configuration (M, N, P) and is represented by (M_{TXRU}, N, P) where MTXRU is the number of TXRUs per column per polarization dimension, for example:

$$- {M}_{TXRU} = 1 , 2 , 4 , 8 and {M}_{TXRU} \leq M$$

A TXRU is only associated with antenna elements with the same polarization. The total number of TXRUs is equal to

$${M}_{TXRU} \times N \times P .$$

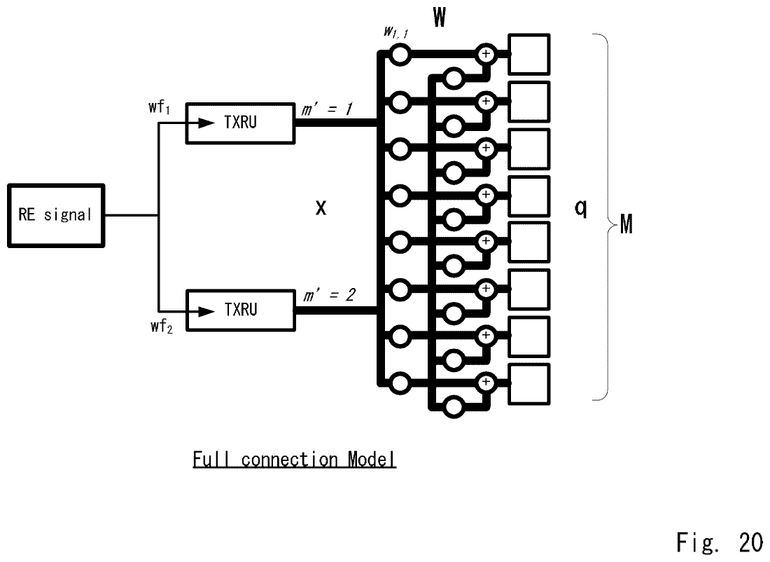

The relationship between the signals at the TXRUs and the signals at the antenna elements for different architectures/scenarios may be defined by corresponding TXRU virtualization models. FIGS. 19 and 20 each show, by way of example only, a different respective TXRU virtualization models that may be used in the communication system 1 to represent the TXRU to antenna element connectivity. Specifically, FIG. 19 illustrates what is known as a sub-array partition model whereas FIG. 20 illustrates what is known as a full connection model.

In FIGS. 19 and 20 the following additional notation may be used:
q is a transmitter signal vector at M co-polarized antenna elements within an antenna element group (e.g., column)
w and W are, respectively, a wideband TXRU virtualization weight vector and matrix
x is a TXRU signal vector at M_{TXRU} TXRUS

The model of FIG. 19 may be a one-dimensional sub-array partition model defined as follows:
q is given by

$$q = x ⊗ w$$

The same TXRU virtualization weight vector is applied for all the columns
The length of w is given by K=M/M_{TXRU}
w is given by

$${w}_{k} = \frac{1}{\sqrt{K}} exp ( - j \frac{2 π}{λ} ( k - 1 ) {d}_{V} cos {θ}_{etilt} ) for k = 1 , … , K$$

The model of FIG. 19 may be a two-dimensional sub-array partition model defined as follows:
q is given by

$$q = x ⊗ ( {v}_{i} ⊗ {w}_{o} )$$

The vertical TXRU virtualization weight vector can be different for different TXRUs
The horizontal TXRU virtualization weight vector can be different for different TXRUs
One TXRU is only connected to antenna elements with the same polarization
The length of wₒ is given by K=M/M_{TXRU}
The length of vᵢ is given by L=N/N_{TXRU}
wₒ for o=1, . . . , M_{TXRU} is given by
Option A:

$${w}_{k , o} = \frac{1}{\sqrt{K}} exp ( - j \frac{2 π}{λ} ( k - 1 ) {d}_{V} cos {θ}_{etilt , o} ) for k = 1 , … , K$$

Option B: Other length K vector with unit power
vᵢ for i=1, . . . , N_{TXRU} is given by
Option A:

$${v}_{l , i} = \frac{1}{\sqrt{L}} exp ( - j \frac{2 π}{λ} ( l - 1 ) {d}_{B} sin {ϑ}_{i} ) for l = 1 , … , L$$

Option B: Other length L vector with unit power

The model of FIG. 20 may be a one-dimensional full-connection model defined as follows:
q is given by q=Wx
W is given by
For m=1, . . . , M and m′=1, . . . , M_{TXRU}: (m, m′) element of W:

$${w}_{m , {m}^{′}} = \frac{1}{\sqrt{M}} exp ( - j \frac{2 π}{λ} ( m - 1 ) {d}_{V} cos {θ}_{etilt , {m}^{′}} )$$

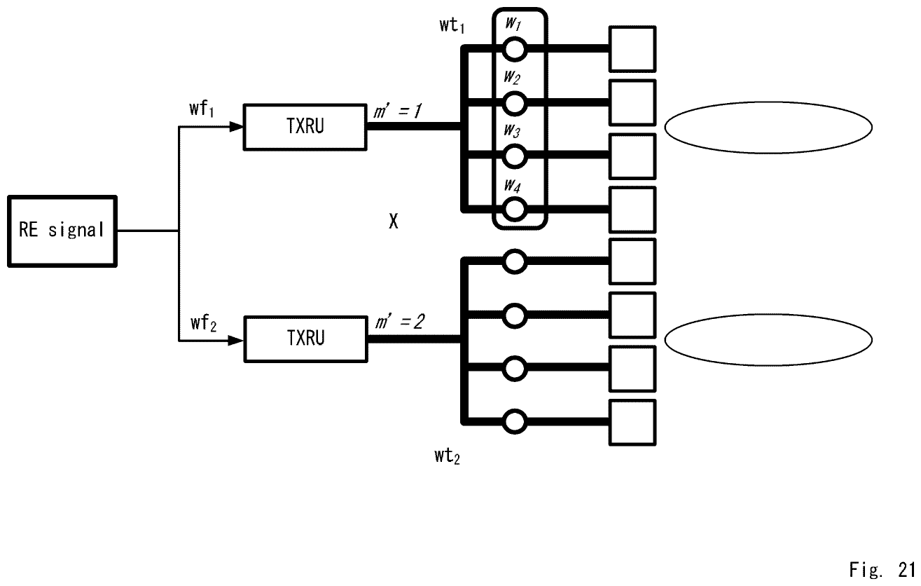

The model of FIG. 21 may be a two-dimensional full-connection model defined as follows:
q is given by q=Wx
W is given by
Option A: For m=1, . . . , M, n=1, . . . . N, p=1 . . . P′, m′=1, . . . . M_{TXRU}, n′=1 . . . , P′*N_{TXRU}
   where, k=m+M(n−1)+MN(p−1), k′=m+M_{TXRU}(n′−1): (k, k′) element of W:

$${w}_{k , {k}^{′}} = \frac{1}{\sqrt{M}} exp ( - j \frac{2 π}{λ} ( m - 1 ) {d}_{V} cos {θ}_{{m}^{′}} ) \frac{1}{\sqrt{{P}^{′} N}} exp ( - j \frac{2 π}{λ} ( n - 1 ) {d}_{B} sin {ϑ}_{{B}^{′}} ) exp ( - j ( p - 1 ) {ψ}_{{m}^{′} , {n}^{′}} )$$

where P′=2 if polarizations are virtualized together, and P′=1 if only co-polarized elements are virtualized together.
Option B: a unity norm vector of the same length as option A.

Different types of beamforming may be employed in the communications system 1. For example time domain beamforming may be employed in which, for an antenna array, different beam weights are not applied to different frequency resources of same symbol. Similarly, frequency domain beamforming may be employed in which, for an antenna array, different beam weights can be applied to different frequency resources. Such frequency domain beamforming may be implemented by using different weights for different resource elements (Res) before the FFT processing stage. Moreover, hybrid beamforming may be employed in which, a combination of time domain and frequency domain beamforming are used.

A number of different beamforming techniques, supported by O-RAN, may be used in the communication system 1.

The possible beamforming techniques include, for example, channel-information-based beamforming in which the DU 5b provides channel information, per UE, periodically to the RU 5a. The DU 5b also provides scheduling information to the RU 5a which the RU 5a uses to calculate appropriate beamforming weights. In this technique there may be no beam identifier (e.g., beamID value) associated with the beamforming—instead a UE identifier (e.g., UEID) is provided in association with each data section/segment to be transmitted.

The possible beamforming techniques may, for example, involve predefined-beam beamforming (which can employ hybrid/frequency domain/time domain beamforming). In this example, the RU 5a is responsible for determining a beam's characteristics and the number of beams. The RU 5a provides the DU 5b with a (limited) set of information about one or more beams, for example via M-plane signalling. The provided information may, for example, include information identifying a given beam to be a coarse beam or a fine beam and/or neighbour beam relation information (and may be associated with a beam identifier (beamID value)). The DU 5b may use the corresponding beam id values.

The possible beamforming techniques may, for example, involve attribute-based dynamic beamforming (e.g., based on real-time-updated beam attributes). In this example, only time domain beamforming may be supported. The RU 5a provides the DU 5b with information about the beam patterns which can be generated by the RU 5a (e.g., vertical and azimuth 3 dB beam width values) e.g., in association with a beam id via the M-plane. The DU 5b can then generate corresponding beam attributes, map one or more associated weights to beam id values, and provide this information to the RU 5b.

The possible beamforming techniques may, for example, involve weight-based dynamic beamforming (based on real-time-updated weights). In this example the beamforming may employ hybrid/frequency domain/time domain beamforming. The RU 5a informs the DU 5b of the number of vertical and/or horizontal antenna elements and of the antenna characteristics (per antenna array), e.g., via the M-plane. This will also typically involve RU 5a indicating to the DU 5b which digital weights are to be applied for each antenna array/antenna array element. The DU 5b can then generate beam forming weights, map one or more weights to beam id values, and provide this information to the RU 5a. For hybrid beamforming, this may include weight generation for both frequency domain and time domain beamforming. Frequency domain weight can be used for general beamforming or for precoding.

Moreover, in the example of weight-based dynamic beamforming, different supported antenna array configurations may be reported by the RU 5a to the DU 5b for different beamforming implementations.

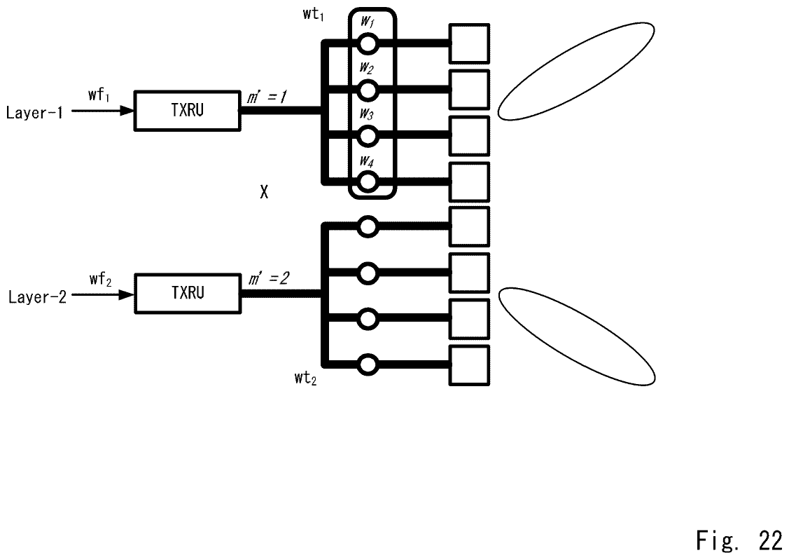

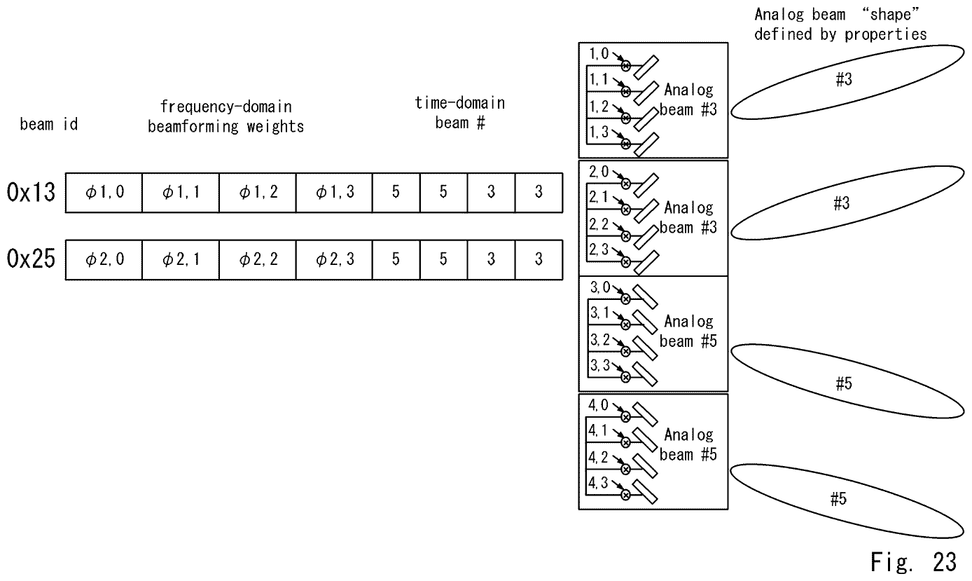

FIGS. 21 and 22 each show, by way of example only, a different respective beamforming implementation-one or both of which may be supported in the communication system 1. FIG. 23 shows a simplified illustration of an example of weight-based dynamic beamforming.

In the first implementation, shown in FIG. 21, the RU 5a indicates one antenna array, to the DU 5b, containing two frequency domain (digital) weight elements. In this example, for each layer, the DU 5b provides a beamforming weight vector of type: {wf₁, wf₂, wt₁, wt₂}. It will be appreciated that multiple layers can be supported by using different frequency domain weights, but any time domain weights will be the same.

In the second implementation, shown in FIG. 22, the RU 5a indicates two antenna arrays, to the DU 5b, each containing a single frequency domain (digital) weight element. In this example, the DU 5b provides a beamforming weight vector of type:
For layer-1: {wf₁, wt₁}
For layer-2: {wf₂, wt₂}

### SBFD Considerations

As described in more detail later, the different communication entities of the RAN 5 of the communication system 1 are mutually configured to implement one or more procedures that have been adapted to support implementation of full duplex in the context of TDD (with specific reference to SBFD).

Beneficially, for example, to contribute to providing the enhanced support for duplexing and filtering requirements needed for SBFD operation, the procedures may include one or more procedures in which an (open) RU 5a is able to indicate whether or not the RU 5a supports SBFD operation and/or one or more associated parameters for indicating a capability of the RU 5a to isolate downlink communication from uplink communication.

Moreover, as described in more detail later, the procedures may include one or more procedures in which a (open) DU 5b is able to provide, to the RU 5a, an enhanced TDD pattern configuration that includes (e.g., as part of an enhanced TDD pattern configuration format) one or more TDD extensions for providing information, catered to semi-static SBFD and/or dynamic SBFD. This information may, for example, include information from which the RU 5a can identify (explicitly or implicitly) symbols/slots that are configured as (or dynamically converted to/from) SBFD symbols/slots. his information may, for example, include information from which the RU 5a can identify (explicitly or implicitly) any frequency regions configured as an uplink subband, a downlink subband, and/or a guard band. This information may, for example, include information from which the RU 5a can identify (explicitly or implicitly) one or more filters to be applied between an uplink and downlink subband. This represents a way to providing the RU 5a with this SBFD related information that is more efficient and flexible than, for example, the DU 5b providing the RU 5a with a TDD pattern configuration defining only downlink/uplink/and ‘guard period’ (GP) symbols/slots, and providing the SBFD related information in some other way.

As described in more detail later, the procedures may include one or more procedures in which a (open) DU 5b (and/or (open) CU 5c) and (another) (open) CU 5c are able to exchange enhanced TDD information that includes (e.g., as part of an enhanced TDD configuration) one or more TDD extensions for providing SBFD related information. The SBFD related information may, for example, be exchanged as part of one or more of the procedures described with reference to FIG. 14. Specifically, the SBFD related information may, for example, be exchanged: as part of one or more intended TDD configurations for a DU 5b provided by the DU 5b to the CU 5c; as part of one or more neighbour DU TDD configurations provided by the CU 5c to the DU 5b; and/or as part of one or more TDD configurations to be used at DU configured by CU to DU.

The SBFD related information may, for example, include one or more SBFD related parameters: defining frequency resources for one or more uplink (and/or downlink) subbands; defining frequency resources for a downlink (and/or uplink) subband (e.g., to be used together with an uplink (and/or downlink) subband for SBFD communication in an SBFD slot); defining frequency resources for one or more guard bands (e.g., between a downlink (or uplink) subband and one or more uplink (or downlink) subbands; and/or defining one or more time locations (slots/symbols) for one or more respective uplink (and/or downlink) subbands used for SBFD, or time occasions for SBFD slots/symbols. This represents a way to exchange SBFD related information that is more efficient and flexible than, for example, exchanging TDD information (between a DU 5b/CU 5c and a CU 5c) that defines only downlink/uplink/flexible symbols/slots, and providing the SBFD related information in some other way.

As described in more detail later, the procedures may include one or more procedures for supporting antenna based isolation between the uplink and the downlink for SBFD. In one such procedure, for example, the (open) RU 5a may indicate different supported beam configurations for SBFD and non-SBFD (uplink-only/downlink-only) symbols/slots. In another such procedure, for example, the (open) RU 5a may indicate different beamforming patterns which can be generated for SBFD and non-SBFD (uplink-only/downlink-only) symbols/slots. In another such procedure, for example, the (open) RU 5a may indicate which set of antenna panels, arrays and/or elements can be (and/or cannot be used) during SBFD operation for the uplink and/or downlink. In another such procedure, for example, the (open) RU 5a may indicate a specific set of one or more antenna array configurations that can be used during SBFD operation for uplink and/or downlink communication. These procedures beneficially allow the impacts on beamforming, of differences between the availability of antenna elements between SBFD and non-SBFD symbols/slots, to be taken into account appropriately (e.g., when generating weights/weight vectors for beamforming).

### Capability of RU for Supporting SBFD

As mentioned above, to contribute to providing the enhanced support for duplexing and filtering requirements needed for SBFD operation, one or more procedures may be implemented in the communication system 1 in which an (open) RU 5a is able to indicate whether or not the RU 5a supports SBFD operation and/or one or more associated parameters for indicating a capability of the RU 5a to isolate downlink communication from uplink communication.

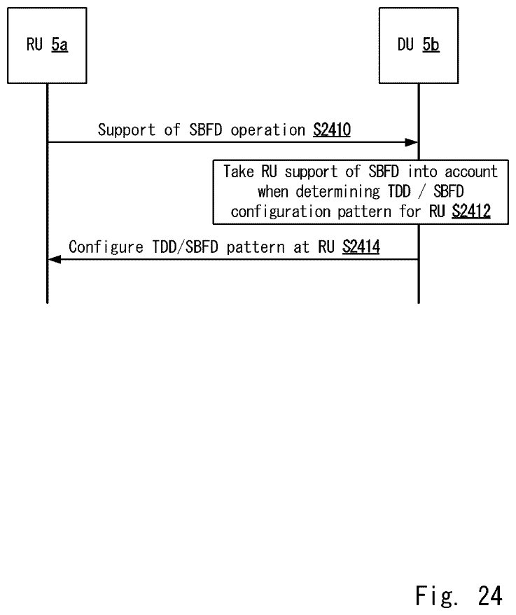

FIG. 24 is a is simplified sequence diagram illustrating a possible procedure for indicating a capability of the RU 5a to the DU 5b that may be used in the communication system 1.

As seen in FIG. 24 the RU 5a can indicate a capability for supporting SBFD operation (at S2510). This may, for example, be sent using M-plane signalling or possibly another appropriate signalling mechanism. Hence, the DU 5b is able to take this capability into account when determining a configuration of TDD and/or SBFD to be used at the RU 5a (at S2412) and configure the RU 5a accordingly (at S2414). This may, for example, be sent using a control plane message as part of CUS-plane signalling or possibly another appropriate signalling mechanism.

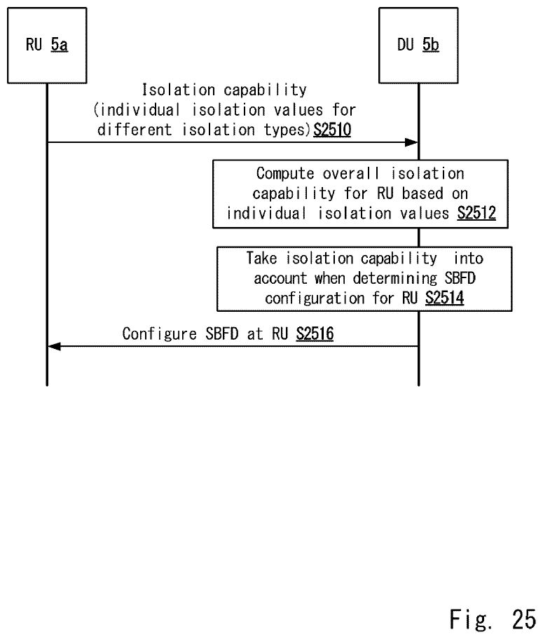

FIG. 25 is a is simplified sequence diagram illustrating another possible procedure for indicating a capability of the RU 5a to the DU 5b that may be used in the communication system 1.

As seen in FIG. 25 the RU 5a can provide isolation capability information indicating a capability of the RU 5a to isolate uplink communication from downlink communication (e.g., for the purposes of interference mitigation during SBFD communication) (at S2510). The isolation capability information may, for example, be sent using M-plane signalling or possibly another appropriate signalling mechanism. In this example, the isolation capability information provided includes individual isolation values for each of a plurality of different isolation schemes/types. The isolation capability information may, for example, include one or more isolation values for each of any combination of the following isolation schemes/types:
Guard band isolation: One or more isolation values may be indicated for each of one or more guard band configurations/combinations that are supported by the RU 5a. Moreover, each isolation value may be provided in association with a value indicating a supported guard band configuration/combination;
Beam pair isolation: One or more isolation values may be provided that indicate a level of isolation between different beam pairs supported by the RU 5a (e.g., in association with information identifying the associated beam pairs);
Antenna array/panel separation based isolation: One or more isolation may be provided that indicate a level of isolation for each of one or more different antenna configurations (e.g., in association with information indicating the associated antenna configuration).
Supported cancellation mechanism based isolation: One or more isolation may be provided that indicate a level of isolation for each of one or more digital and/or analog cancellation mechanisms. In this example the isolation values may be provided per antenna element configuration and/or beam configuration (e.g., in association with information indicating the associated antenna element configuration and/or beam configuration).

Hence, the DU 5b is able to compute an overall isolation capability for the RU 5a based on the individual isolation capabilities for the different isolation schemes/types (at S2512). This allows the DU 5b to identify how to schedule SBFD slots/symbols (e.g. whether better uplink power control is required or not, what kind of beams can be simultaneously used, etc), and hence determine an appropriate configuration for SBFD to be used at the RU 5a (at S2514) that takes the overall isolation capability into account appropriately. The DU 5b can therefore configure the RU 5a for SBFD accordingly (at S2516). This configuration may, for example, be carried out using a control plane message as part of CUS-plane signalling or possibly another appropriate signalling mechanism.

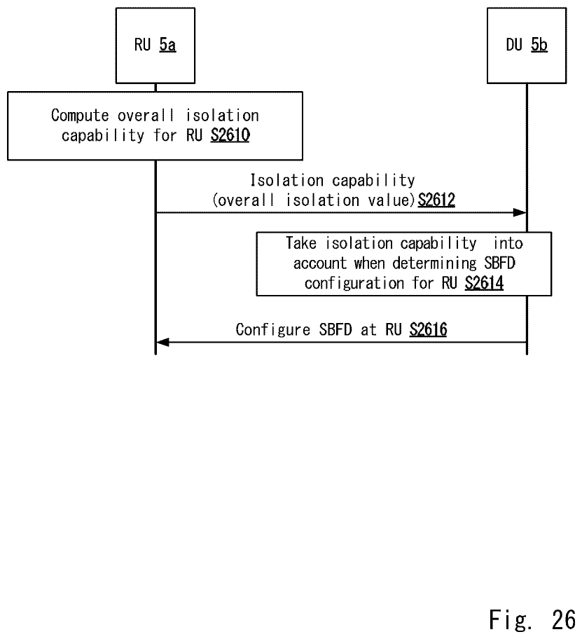

FIG. 26 is a is simplified sequence diagram illustrating another possible procedure for indicating a capability of the RU 5a to the DU 5b that may be used in the communication system 1.

As seen in FIG. 26, in this example, the RU 5a (rather than the DU 5b) computes an overall isolation capability for the RU 5a based on the individual isolation capabilities for the different isolation schemes/types (at S2610). The overall isolation capability may, for example, be based on one or more isolation values for each of any combination of the isolation schemes/types described with reference to FIG. 25.

The RU 5a can then provide information indicating the overall isolation capability of the RU 5a to isolate uplink communication from downlink communication (e.g., for the purposes of interference mitigation during SBFD communication) (at S2612). It will be appreciated that the overall isolation value in this example may be for a specific (e.g., default) configuration and the RU 5a may also provide information indicating the detailed configuration used to determine the overall isolation value (e.g. guard band size, antenna configuration selected, etc), for example as a specific configuration set.

Hence, the DU 5b is able to identify how to schedule SBFD slots/symbols (e.g. whether better uplink power control is required or not, what kind of beams can be simultaneously used, etc), and hence determine an appropriate configuration for SBFD to be used at the RU 5a (at S2614) that takes the overall isolation capability into account appropriately. The DU 5b can therefore configure the RU 5a for SBFD accordingly (at S2616). This configuration may, for example, be carried out using a control plane message as part of CUS-plane signalling or possibly another appropriate signalling mechanism.

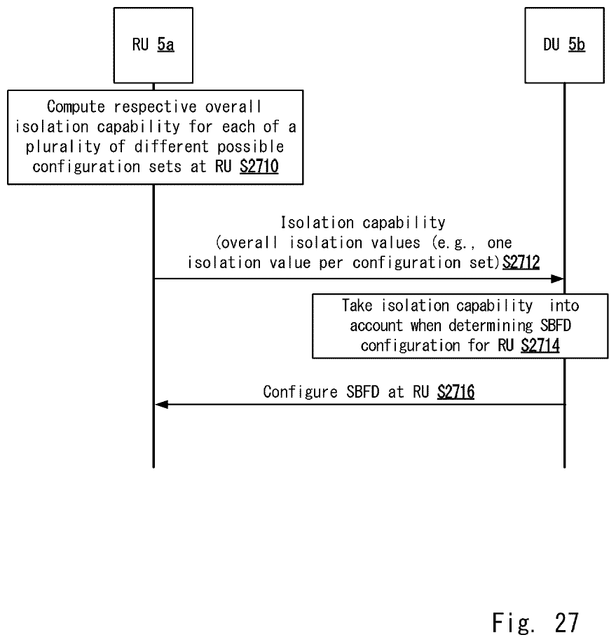

FIG. 27 is a is simplified sequence diagram illustrating another possible procedure for indicating a capability of the RU 5a to the DU 5b that may be used in the communication system 1.

As seen in FIG. 27, in this example, the RU 5a computes a respective overall isolation capability for the RU 5a for each of a plurality of different possible sets of configuration information (at S2710). This may, for example, be based on the individual isolation capabilities for different isolation schemes/types when the RU 5a is configured in accordance with the corresponding configuration set. The overall isolation capability in each case may, for example, be based on one or more isolation values for each of any combination of the isolation schemes/types described with reference to FIG. 25.

The RU 5a can then provide information indicating the respective overall isolation capability of the RU 5a for each configuration set (e.g., for the purposes of interference mitigation during SBFD communication when that configuration set is in use) (at S2712).

Hence, the DU 5b is able to identify how to schedule SBFD slots/symbols (e.g. whether better uplink power control is required or not, what kind of beams can be simultaneously used, etc), and hence determine an appropriate configuration for SBFD to be used at the RU 5a (at S2714) that takes the overall isolation capability for the corresponding configuration set into account appropriately. The DU 5b can therefore configure the RU 5a for SBFD accordingly (at S2716). This configuration may, for example, be carried out using a control plane message as part of CUS-plane signalling or possibly another appropriate signalling mechanism.

It will be appreciated that, in a variation of the procedures of FIGS. 25 to 27, the DU 5b may send a request to the RU 5a to request an isolation value for a specific configuration (e.g. guard band size, beam pair, etc). In this case the RU 5a may compute the expected isolation, based on requested configuration, and indicate this value to the DU 5b. Hence, the DU 5b is able to identify how to schedule SBFD slots/symbols (e.g. whether better uplink power control is required or not, what kind of beams can be simultaneously used, etc), and hence determine an appropriate configuration for SBFD to be used at the RU 5a for the specific configuration to which the request related.

It will also be appreciated that, while the procedures of FIGS. 25 to 27 are described separately, aspects of the procedures may be used in combination. For example, a combined ‘overall’ isolation value may be provided for some of the isolation features (e.g. self-interference capability, antenna panel separation) in a similar manner to the procedure described with reference to FIG. 26 (or FIG. 27), while for other isolation features (e.g., a guard band) one or more separate ‘individual’ isolation values may be provided (e.g., as described with reference to FIG. 25).

### TDD Information Exchange Between DU and RU

As mentioned above, one or more procedures may be implemented in the communication system 1 in which a DU 5b is able to provide, to the RU 5a, an enhanced TDD pattern configuration that includes (e.g., as part of an enhanced TDD pattern configuration format) one or more TDD extensions for providing information, catered to semi-static SBFD and/or dynamic SBFD.

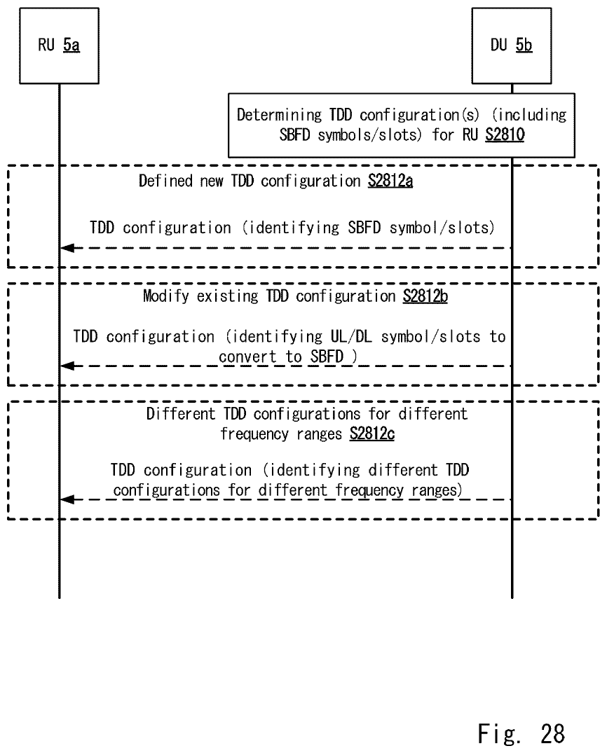

FIG. 28 is a simplified sequence diagram illustrating a number of possible procedures for TDD information exchange between DU 5a and RU 5b that may be used in the communication system 1.

The procedures of FIG. 28 represent different ways in which TDD information may be exchanged between the DU 5b and RU 5a for (semi-statically) configuring SBFD symbols/slots for the RU 5a. It will be appreciated that one or more of these exemplary procedures may be implemented in the communication system (e.g., different procedures may be implemented for use in different circumstances).

As seen in FIG. 28, when a DU 5b determines a TDD configuration for an RU 5a that includes SBFD symbols/slots (at S2810), it provides TDD information (e.g., as part of CUS-plane signalling) for configuring the RU 5a for SBFD in those symbols or slots (as shown generally at S2812a, S2812b, and S2812c).

In one example, the TDD configuration information effectively defines a new TDD configuration for the RU 5a that includes symbols/slots that are expressly indicated (e.g., by means of one or more dedicated IEs) to be SBFD symbols/slots (as seen at S2812a).

In another example, TDD configuration information is sent to the RU 5a that effectively modifies an existing TDD configuration for the RU 5a by identifying existing single-directional (e.g. UL only or DL only) symbol/slots to be converted to full duplex (SBFD) symbols/slots (as seen at S2812b). Effectively, therefore, the DU 5b provides an indication of which slots/symbols are to be SBFD symbols/slots ‘on top of’ an existing TDD configuration. For example, the DU 5b may indicate which symbols/slots of the existing TDD configuration should be converted to an SBFD symbol/slot type.

In another example, TDD configuration information is sent to the RU 5a that configures a different respective TDD pattern, for each of a plurality of different specific frequency regions/ranges, for the RU 5a (as seen at S2812c). This allows for some symbols/slots to be configured for uplink communication in one or more frequency regions, and for downlink communication in one or more other frequency regions-effectively enabling SBFD operation in these slots.

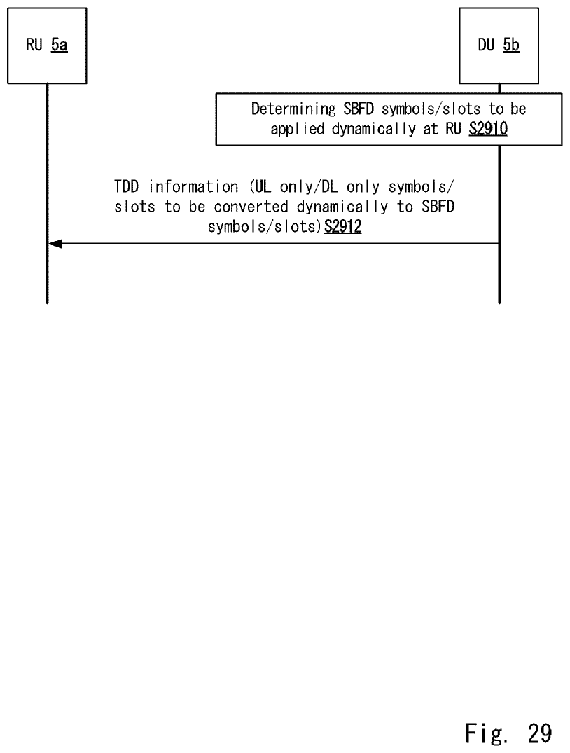

FIG. 29 is another simplified sequence diagram illustrating a possible procedure for TDD information exchange between DU 5a and RU 5b that may be used in the communication system 1.

The procedure of FIG. 29 represents a way in which TDD information may be exchanged between the DU 5b and RU 5a for (dynamically) configuring SBFD symbols/slots for the RU 5a.

As seen in FIG. 29, when a DU 5b determines a TDD configuration for an RU 5a that includes SBFD symbols/slots (at S2910), it provides TDD information (e.g., as part of CUS-plane signalling) for dynamically converting one or more symbols/slots to one or more SBFD symbols/slots from one or more uplink-only and/or downlink-only symbols/slots- or vice versa (at S2912). In the illustrated example, information is provided to the RU 5a that indicates that a previously configured symbol/slot (e.g., of a UL/DL/SBFD type) needs to be updated dynamically (e.g., between UL-only/DL-only symbol/slot type and an SBFD symbol/slot type).

It will be appreciated that, in this example, transmission timing of the information that indicates that a previously configured symbol/slot needs to be updated dynamically may be specifically configured to ensure receipt at the RU 5a a certain (minimum) margin time before receiving a control plane message carrying control information for transmission of IQ data. It will, nevertheless, also be appreciated that in a variation of this the information that indicates that a previously configured symbol/slot needs to be updated dynamically may be transmitted in the same control plane message that schedules transmission of IQ data (i.e., in a user plane message).

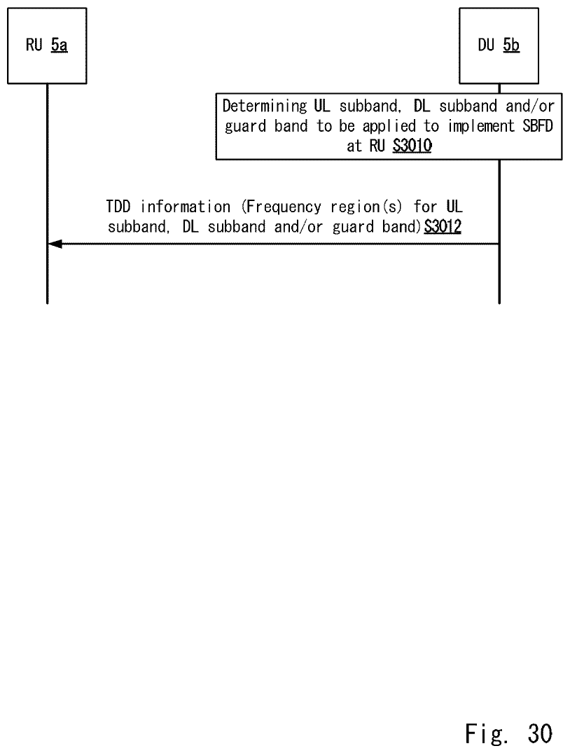

FIG. 30 is another simplified sequence diagram illustrating a possible procedure for TDD information exchange between DU 5a and RU 5b that may be used in the communication system 1.

As seen in FIG. 30, in this example the DU 5b determines a respective frequency region/range for an uplink subband, a downlink subband and/or a guard band to be used for implementing SBFD at the RU 5a (at S3010). The DU 5b then provides TDD information (e.g., as part of CUS-plane signalling) including information for indicating, to the RU 5a, frequency region/range for an uplink subband, a downlink subband and/or a guard band to be used for implementing SBFD (at S3012).

It will be appreciated that, in the example of FIG. 30, the RU 5a may be configured to decide a filter to be applied between uplink and downlink subbands (e.g., based on a guard band configured by the DU 5b). It will, nevertheless, also be appreciated that in a variation of this the DU 5b may indicate, to the RU 5a, a filter to be applied during SBFD symbols/slots.

### TDD Information Exchange Between DU and CU

As mentioned above, one or more procedures may be implemented in the communication system 1 in which a DU 5b (and/or CU 5c) and (another) CU 5c are able to exchange enhanced TDD information that includes (e.g., as part of an enhanced TDD configuration) one or more TDD extensions for providing SBFD related information.

The SBFD related information may, for example, be exchanged as part of one or more of the procedures described with reference to FIG. 14. Specifically, the SBFD related information may, for example, be exchanged: as part of one or more intended TDD configurations for a DU 5b provided by the DU 5b to the CU 5c; as part of one or more neighbour DU TDD configurations provided by the CU 5c to the DU 5b; and/or as part of one or more TDD configurations to be used at DU configured by CU to DU.

The SBFD related information may, for example, include one or more SBFD specific parameters. The SBFD specific parameters may, for example, define frequency resources for one or more uplink (and/or downlink) subbands. The SBFD specific parameters may, for example, define frequency resources for a downlink (and/or uplink) subband (e.g., to be used together with an uplink (and/or downlink) subband for SBFD communication in an SBFD slot). The SBFD specific parameters may, for example, define frequency resources for one or more guard bands (e.g., between a downlink (or uplink) subband and one or more uplink (or downlink) subbands. The SBFD specific parameters may, for example, define one or more time locations (slots/symbols) for one or more respective uplink (and/or downlink) subbands used for SBFD, or time occasions for SBFD slots/symbols.

A number of procedures will now be described in more detail, by way of example only, in which a transmitting node (CU/DU) has an SBFD configuration to send to a receiving node (CU/DU) that may or may not support SBFD.

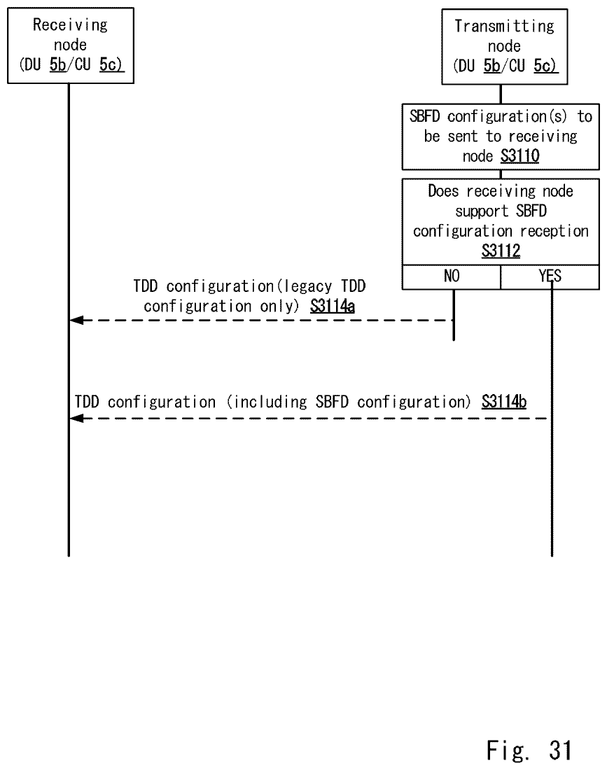

FIG. 31 is a simplified sequence diagram illustrating a possible procedure for TDD information exchange between a transmitting node (CU/DU) and a receiving node (CU/DU) that may be used in the communication system 1.

In the procedure of FIG. 31, when the transmitting node (CU/DU) has an SBFD configuration to send to a receiving node (DU/CU) (at S3110), the transmitting node (CU/DU) determines (at S3112) if the receiving node (DU/CU) supports “SBFD configuration reception”. If the receiving node does not support “SBFD configuration reception”, then when the TDD configuration information is sent to the receiving node (at S3114a) the SBFD configuration is not included (i.e., only a legacy TDD configuration is included) in the TDD configuration information, by the transmitting node. If the receiving node does support “SBFD configuration reception”, then when the TDD configuration information is sent to the receiving node (at S3114b) the SBFD configuration information is included in the TDD configuration information, by the transmitting node.

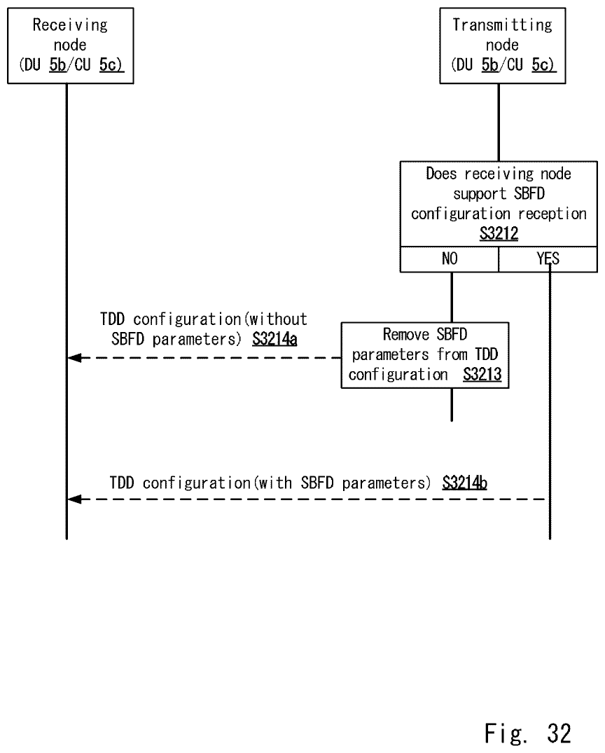

FIG. 32 is a simplified sequence diagram illustrating another possible procedure for TDD information exchange between a transmitting node (CU/DU) and a receiving node (CU/DU) that may be used in the communication system 1.

In the procedure of FIG. 32, when the transmitting node (CU/DU) has an SBFD configuration to send to a receiving node (DU/CU) (at S3210), the transmitting node (CU/DU) determines (at S3212) if the receiving node (DU/CU) supports “SBFD configuration reception”. If the receiving node does not support “SBFD configuration reception”, then when the TDD configuration information is sent to the receiving node (at S3214a) the SBFD parameters are removed from the TDD configuration (at S3213). Hence, only legacy TDD parameters are included in the TDD configuration information (i.e., a legacy TDD configuration is sent by removing SBFD parameters), by the transmitting node. If the receiving node does support “SBFD configuration reception”, then when the TDD configuration information is sent to the receiving node (at S3214b) the SBFD parameters are included in the TDD configuration information, by the transmitting node.

It will be appreciated that in either of the procedures of FIG. 31 and FIG. 32, if the receiving node (CU/DU) does not support “SBFD configuration reception” (e.g., because the receiving node is unable to decode the SBFD configuration), then the receiving node can indicate this to the transmitting node by any appropriate mechanism. For example, the support (or lack of support) may be indicated by the receiving unit to the transmitting unit implicitly or explicitly by means of a supported version/features/capabilities indication or the like. A lack of support may alternatively, or additionally, be indicated implicitly by provision of an error response to a request that carries SBFD configuration information. The error response may include, for example, a cause value indicating an “unknown configuration”, or a “syntax error”, pointing to the SBFD parameters.

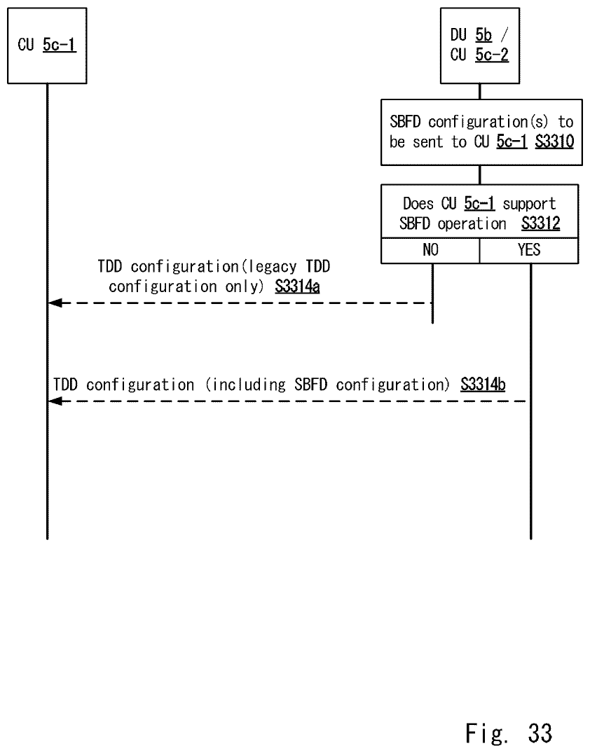

FIG. 33 is a simplified sequence diagram illustrating a possible procedure for TDD information exchange between a transmitting node (CU/DU) and a CU that may be used in the communication system 1.

In the procedure of FIG. 33, when the transmitting node (CU/DU) has an SBFD configuration to send to a CU 5c-1 (at S3310), the transmitting node (CU/DU) determines (at S3312) if the CU 5c-1 supports “SBFD operation”. If the receiving node does not support “SBFD operation”, then when the TDD configuration information is sent to the receiving node (at S3314a) the SBFD configuration is not included (i.e., only a legacy TDD configuration is included) in the TDD configuration information, by the transmitting node. If the receiving node does support “SBFD operation”, then when the TDD configuration information is sent to the receiving node (at S3314b) the SBFD configuration information is included in the TDD configuration information, by the transmitting node.

It will be appreciated that in support of the procedure of FIG. 33, the CU may indicate support (or lack of support) for “SBFD operation” by any appropriate mechanism. For example, the support may be indicated by the CU to the transmitting unit implicitly or explicitly by means of a supported version/features/capabilities indication or the like. A lack of support may alternatively, or additionally, be indicated implicitly by provision of an error response to a request that carries SBFD configuration information. The error response may include, for example, a cause value indicating “SBFD operation is not supported” or “one or more of DUs do not support SBFD” pointing to the SBFD parameters.

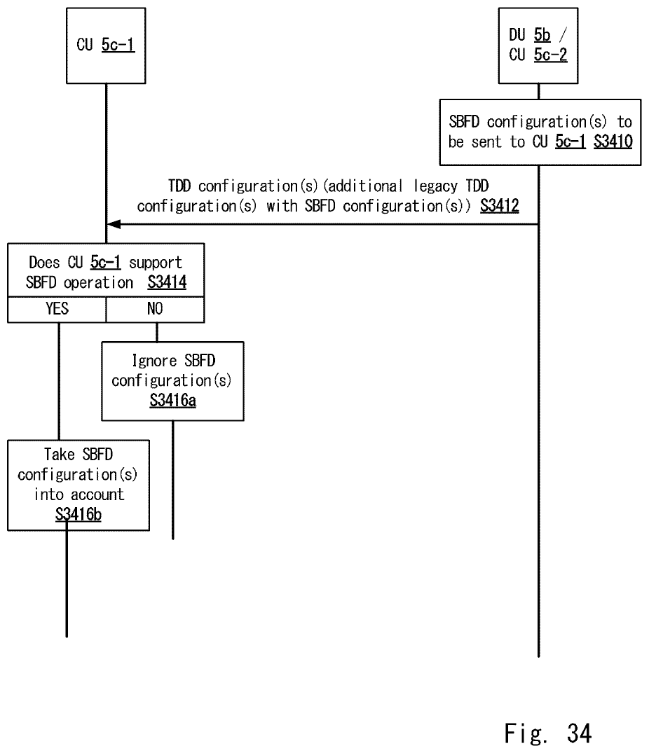

FIG. 34 is a simplified sequence diagram illustrating another possible procedure for TDD information exchange between a transmitting node (CU/DU) and a CU that may be used in the communication system 1.

In the procedure of FIG. 34, if the transmitting node (CU/DU) has an SBFD configuration to send to a CU 5c-1 (at S3410), then when the TDD configuration information is sent to the receiving node (at S3412) at least one additional legacy TDD configuration is included along with SBFD configuration by the transmitting node. At S3414, if the CU 5c-1 does not support “SBFD operation” then the CU simply ignores the SBFD configuration (at S3416a). Otherwise, if the CU 5c-1 does support “SBFD operation” then the CU 5c-1 takes the SBFD configuration into account (at S3416b).

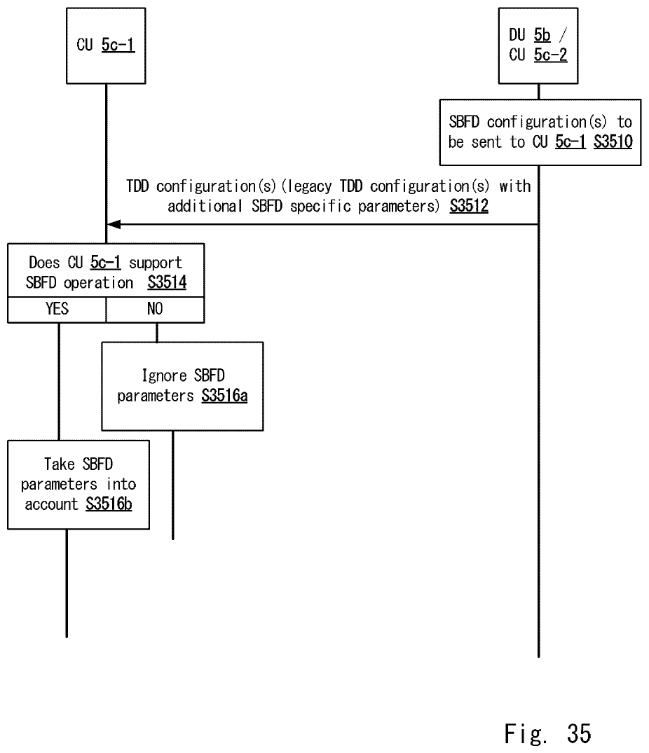

FIG. 35 is a simplified sequence diagram illustrating another possible procedure for TDD information exchange between a transmitting node (CU/DU) and a CU that may be used in the communication system 1.

In the procedure of FIG. 35, if the transmitting node (CU/DU) has an SBFD configuration to send to a CU 5c-1 (at S3510), then when the TDD configuration information is sent to the CU 5c-1 (at S3512) one or more SBFD specific parameters (e.g., uplink (or downlink) subband time and frequency resources, downlink (or uplink) frequency resources and/or guard band frequency resources) are provided along with the legacy TDD configuration by the transmitting node. At S3514, if the CU 5c-1 does not support “SBFD operation” then the CU 5c-1 simply ignores the SBFD parameters (at S3516a). Otherwise, if the CU 5c-1 does support “SBFD operation”, then the CU takes the SBFD parameters into account (at S3516b).

It will be appreciated that in any of the procedures of FIG. 33 to FIG. 35, the CU 5c-1 may not support SBFD operation if one or more DUs 5b which are connected to the CU 5c-1 do not support SBFD. Alternatively, or additionally, the CU 5c-1 may not accept an intended SBFD configuration, from a connected DU 5b, if the CU 5c-1 does not intend to use SBFD operation.

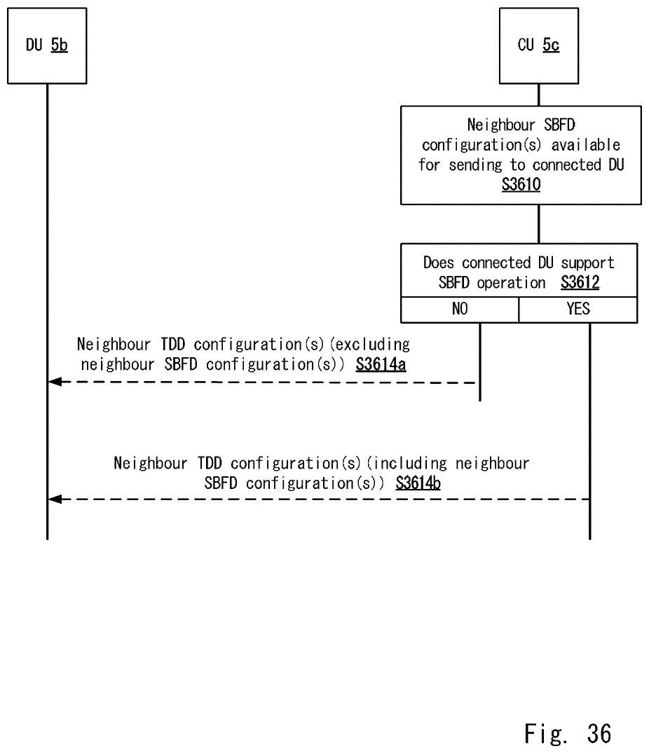

FIG. 36 is a simplified sequence diagram illustrating a possible procedure for TDD information exchange between a CU 5c and a DU 5b that may be used in the communication system 1.

In the procedure of FIG. 36, when the CU 5c has an SBFD configuration (for a neighbouring DU) to send to a connected DU 5b (at S3610), the CU 5c determines (at S3612) if the connected DU 5b supports “SBFD operation”. If the connected DU 5b does not support “SBFD operation”, then when the TDD configuration information is sent to the receiving node (at S3614a) any SBFD configurations of neighbour DUs are not included (i.e., only a legacy TDD configuration is included) in the TDD configuration information, by the CU 5c. If the receiving node does support “SBFD operation”, then when the TDD configuration information is sent to the receiving node (at S3614b) any SBFD configurations of neighbour DUs are included in the TDD configuration information, by the CU 5c.

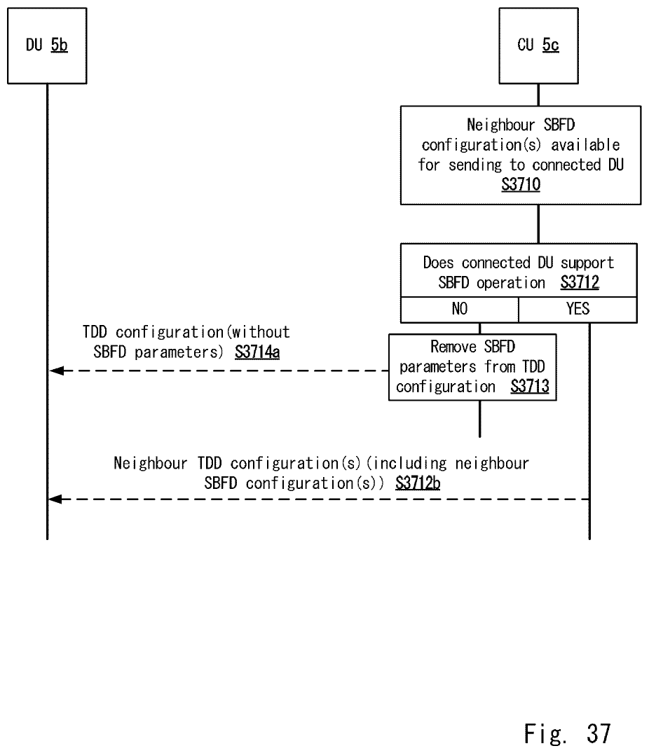

FIG. 37 is a simplified sequence diagram illustrating another possible procedure for TDD information exchange between a CU 5c and a DU 5b that may be used in the communication system 1.

In the procedure of FIG. 37, when the CU 5c has an SBFD configuration (for a neighbouring DU) to send to a connected DU 5b (at S3610), the CU 5c determines (at S3712) if the connected DU 5b supports “SBFD operation”. If the connected DU 5b does not support “SBFD operation”, then when the TDD configuration information is sent to the receiving node (at S3714a) any SBFD parameters for any neighbour SBFD configurations are removed from the TDD configuration (at S3713). Hence, only legacy TDD parameters are included in the TDD configuration information by the CU 5c (i.e., one or more legacy TDD configurations for one or more neighbouring DUs are sent by removing SBFD parameters). If the receiving node does support “SBFD operation”, then when the TDD configuration information is sent to the receiving node (at S3714b) any SBFD parameters for any neighbour SBFD configurations are included in the TDD configuration information by the CU 5c.

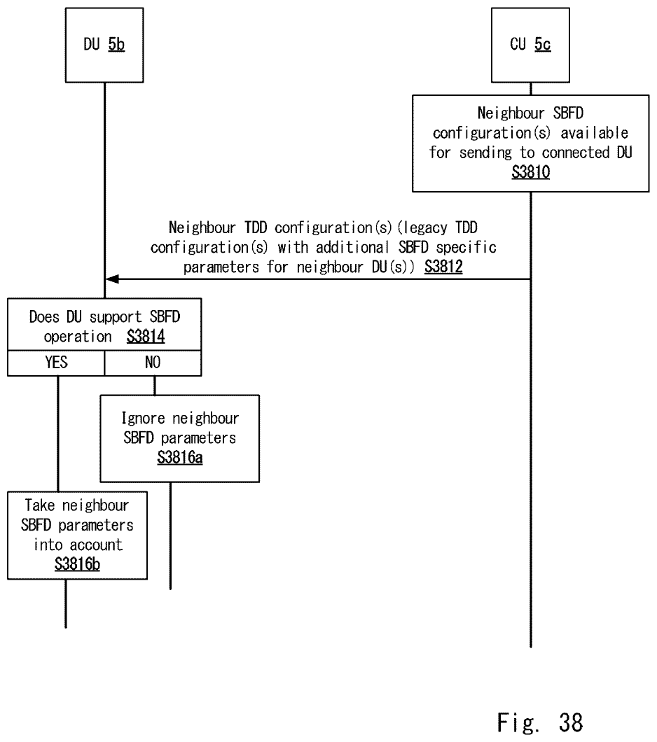

FIG. 38 is a simplified sequence diagram illustrating another possible procedure for TDD information exchange between a CU 5c and a DU 5b that may be used in the communication system 1.

In the procedure of FIG. 38, if the CU 5c has an SBFD configuration (for a neighbouring DU) to send to a connected DU 5b (at S3810), then when the neighbour TDD configuration information is sent to the receiving node (at S3812) one or more SBFD specific parameters for one or more neighbour DUs (e.g., uplink (or downlink) subband time and frequency resources, downlink (or uplink) frequency resources and/or guard band frequency resources) are provided along with the legacy TDD configuration by the CU 5c. At S3814, if the DU 5b does not support “SBFD operation” then the DU 5b simply ignores the SBFD parameters (at S3816a). Otherwise, if the DU 5b does support “SBFD operation”, then the DU 5b takes the SBFD parameters into account (at S3816b).

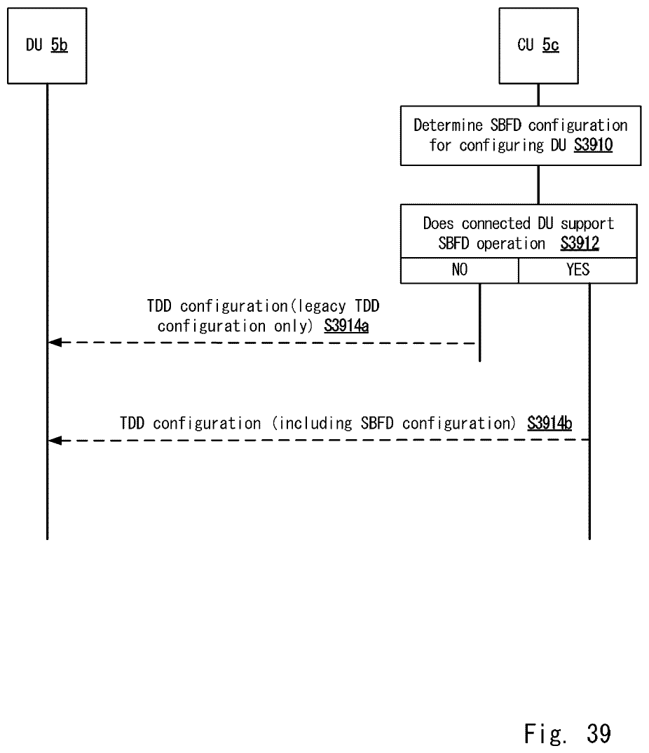

FIG. 39 is a simplified sequence diagram illustrating another possible procedure for TDD information exchange between a CU 5c and a DU 5b that may be used in the communication system 1.

In the procedure of FIG. 39, when the CU 5c has an SBFD configuration to send to a DU 5b for configuring that DU 5b (at S3910), the CU 5c determines (at S3912) if the DU 5b supports “SBFD operation”. If DU 5b does not support “SBFD operation”, then when the TDD configuration information is sent to the DU 5b (at S3914a) the SBFD configuration is not included (i.e., only a legacy TDD configuration is included) in the TDD configuration information by the CU 5c. If the DU 5b does support “SBFD operation”, then when the TDD configuration information is sent to the receiving node (at S3914b) the SBFD configuration information is included in the TDD configuration information by the CU 5c.

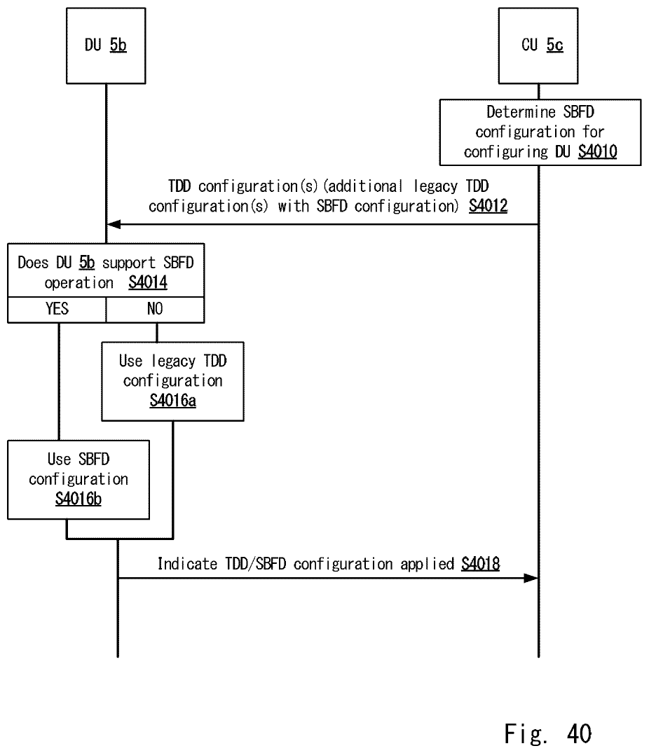

FIG. 40 is a simplified sequence diagram illustrating another possible procedure for TDD information exchange between a CU 5c and a DU 5b that may be used in the communication system 1.

In the procedure of FIG. 40, if the CU 5c has an SBFD configuration to send to a DU 5b for configuring that DU 5b (at S4010), then when the TDD configuration information is sent to the receiving node (at S4012) at least one additional legacy TDD configuration is included along with SBFD configuration by the CU 5c. At S4014, if the DU 5b does not support “SBFD operation” then the DU 5b ignores the SBFD configuration and uses a legacy TDD configuration (at S4016a). Otherwise, if the DU 5b does support “SBFD operation” then the DU 5b uses the SBFD configuration (at S4016b). The DU 5b indicates the legacy TDD/SBFD configuration applied at the DU 5, to the CU 5c, at S4018.

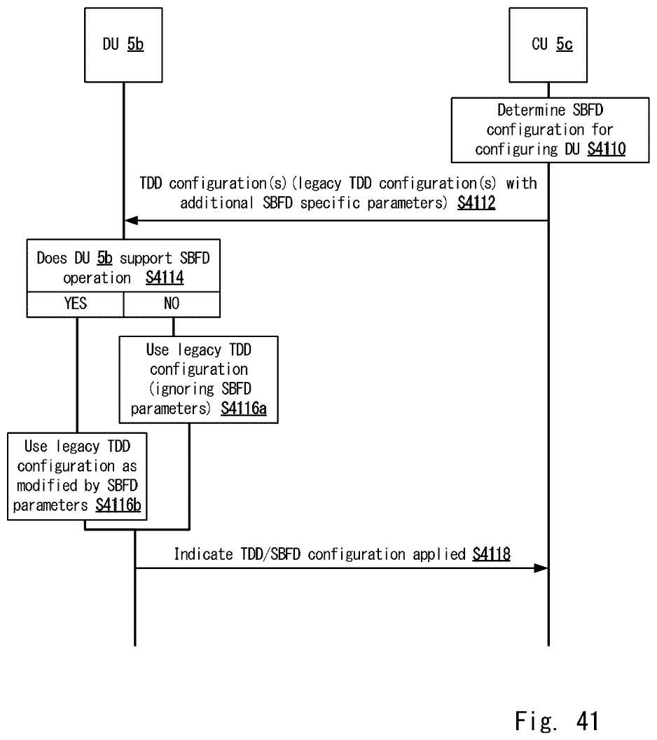

FIG. 41 is a simplified sequence diagram illustrating another possible procedure for TDD information exchange between a CU 5c and a DU 5b that may be used in the communication system 1.

In the procedure of FIG. 41, if the CU 5c has an SBFD configuration to send to a DU 5b for configuring that DU 5b (at S4110), then when the TDD configuration information is sent to the receiving node (at S4112) one or more SBFD specific parameters (e.g., uplink (or downlink) subband time and frequency resources, downlink (or uplink) frequency resources and/or guard band frequency resources) are provided along with the legacy TDD configuration by the transmitting node. At S4114, if the DU 5b does not support “SBFD operation” then the DU 5b ignores the SBFD parameters and uses the legacy TDD configuration (at S4116a). Otherwise, if the DU 5b does support “SBFD operation”, then the DU 5b uses an SBFD configuration based on the SBFD parameters (at S4116b). The DU 5b indicates the legacy TDD/SBFD configuration applied at the DU 5, to the CU 5c, at S4118.

It will be appreciated that in any of the procedures of FIG. 36 to FIG. 41, the DU 5b may not support SBFD operation if SBFD specific enhancements are not supported at the DU 5b. Alternatively, or additionally, the DU 5b may not act on an SBFD configuration if the DU 5b does not intend to use SBFD operation.

It will also be appreciated that in support of any of the procedures of FIG. 36, FIG. 37, or FIG. 39 the DU 5b may indicate support (or lack of support) for “SBFD operation” by any appropriate mechanism. For example, the support may be indicated by the DU 5b to the transmitting unit implicitly or explicitly by means of a supported version/features/capabilities indication or the like. A lack of support may alternatively, or additionally, be indicated implicitly by provision of an error response to a request that carries SBFD configuration information. The error response may include, for example, a cause value indicating “SBFD operation is not supported”.

### Antenna Based Isolation

As mentioned above, one or more procedures may be implemented in the communication system 1 for supporting antenna based isolation between the uplink and the downlink for SBFD.

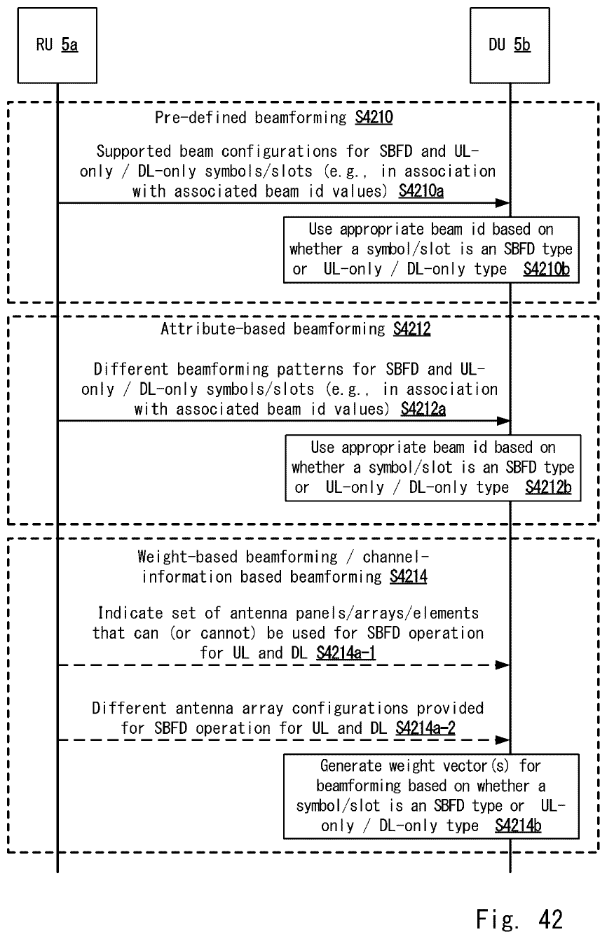

FIG. 42 is a simplified sequence diagram illustrating a number of possible procedures for supporting antenna based isolation between the uplink and the downlink that may be used in the communication system 1.

The procedures illustrated in FIG. 42 include a procedure for supporting different antenna configurations in the context of pre-defined beamforming (as seen at S4210).

As seen in FIG. 42, in the pre-defined beamforming based procedure S4210, the RU 5a provides information (at S4210a) indicating different supported beam configurations respectively for SBFD and for UL-only/DL-only symbols/slots (e.g., in association with associated beam id values). It will be appreciated that the indicating different supported beam configurations may specify multiple beam configurations for SBFD symbols/slots (e.g., for different antenna configurations which can be used for SBFD symbols/slots). The DU 5b can then use (at S4210b) an appropriate beam id value depending on whether a particular symbol/slot is an SBFD type or a DL-only/UL-only type.

The procedures illustrated in FIG. 42 include a procedure for supporting different antenna configurations in the context of attribute-based beamforming (as seen at S4212).

As seen in FIG. 42, in the attribute-based beamforming based procedure S4212, the RU 5a provides information (at S4212a) indicating different beamforming patterns that can be generated for SBFD and for UL-only/DL-only symbols/slots (e.g., in association with associated beam id values). It will be appreciated that the indicating different beamforming patterns may specify multiple beam patterns for SBFD which can be used for SBFD symbols symbols/slots (e.g., for different antenna configurations which can be used for SBFD symbols/slots). The DU 5b can then use (at S4212b) an appropriate beam id value depending on whether a particular symbol/slot is an SBFD type or a DL-only/UL-only type.

The procedures illustrated in FIG. 42 include a procedure for supporting different antenna configurations in the context of weight-based beamforming and/or channel-information based beamforming (as seen at S4214).

As seen in FIG. 42, in the weight-based beamforming and/or channel-information based beamforming based procedure S4214, the RU 5a provides (e.g. as part of RU capability reporting) information (at S4214a-1) indicating which set of antenna panels/arrays/elements can be (and/or cannot be) used for SBFD operation for the uplink and for the downlink. Alternatively, or additionally, the RU 5a provides (e.g. as part of RU capability reporting) information (at S4214a-2) indicating a different set of antenna array configurations for SBFD operation for the uplink and for the downlink. The DU 5b can then take the reported information into account to generate (at S4214b) appropriate weight vectors depending on whether a particular symbol/slot is an SBFD type or a DL-only/UL-only type.

### User Equipment

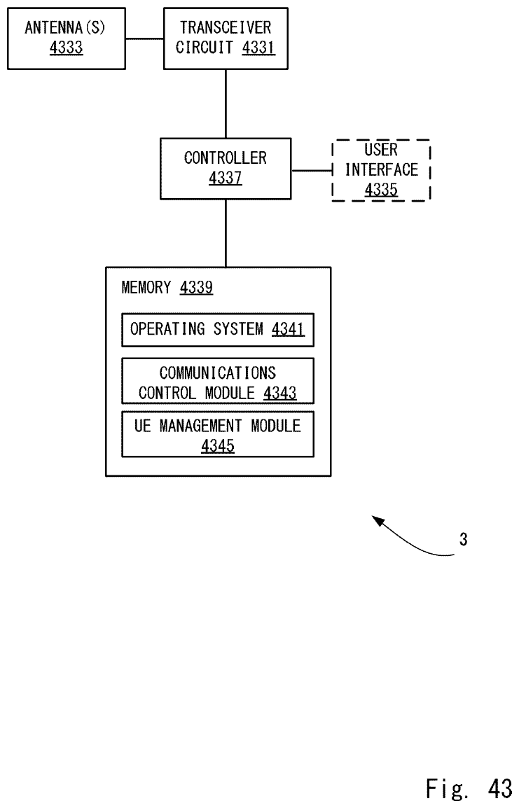

FIG. 43 is a schematic block diagram illustrating the main components of a UE 3 as shown in FIG. 5.

As shown, the UE 3 has a transceiver circuit 4331 that is operable to transmit signals to and to receive signals from a RAN 5 via one or more antenna 4333. The UE 3 has a controller 4337 to control the operation of the UE 3. The controller 4337 is associated with a memory 4339 and is coupled to the transceiver circuit 4331. Although not necessarily required for its operation, the UE 3 might, of course, have all the usual functionality of a conventional UE 3 (e.g. a user interface 4335, such as a touch screen/keypad/microphone/speaker and/or the like for, allowing direct control by and interaction with a user) and this may be provided by any one or any combination of hardware, software and firmware, as appropriate. Software may be pre-installed in the memory 4339 and/or may be downloaded via the telecommunications network or from a removable data storage device (RMD) for example.

The controller 4337 is configured to control overall operation of the UE 3 by, in this example, program instructions or software instructions stored within memory 4339. As shown, these software instructions include, among other things, an operating system 4341, a communications control module 4343, and a UE management module 4345.

The communications control module 4343 is operable to control the communication between the UE 3 and its one or more serving RANs 5 (and other communication devices connected to the RAN 5, such as further UEs and/or core network nodes). The communications control module 4343 is configured for the overall handling uplink communications transmitted by the UE towards the network and for handling receipt of downlink communications from the network.

The UE management module 4345 is responsible for managing the overall operation of the UE and the overall performance of the tasks required of the UE. These tasks include, among other things; the generation and transmission of appropriate messages using appropriate signalling application protocols such as (but not limited to) RRC signalling, MAC signalling, and NAS signalling. The UE management module 4345 is responsible, for example: for determining where to monitor for downlink control information (e.g., the location of CSSs/USSs, CORESETs, and associated PDCCH candidates to monitor); for determining the resources to be used by the UE 3 for transmission/reception of UL/DL communications (including interleaved resources and resources subject to frequency hopping); for managing frequency hopping at the UE side; for determining how slots/symbols are configured (e.g., for UL, DL or SBFD communication, or the like); for determining which one or more bandwidth parts are configured for the UE 3; for determining how uplink transmissions should be encoded; for applying any SBFD specific communication configurations appropriately; and the like.

### RAN Node (RU)

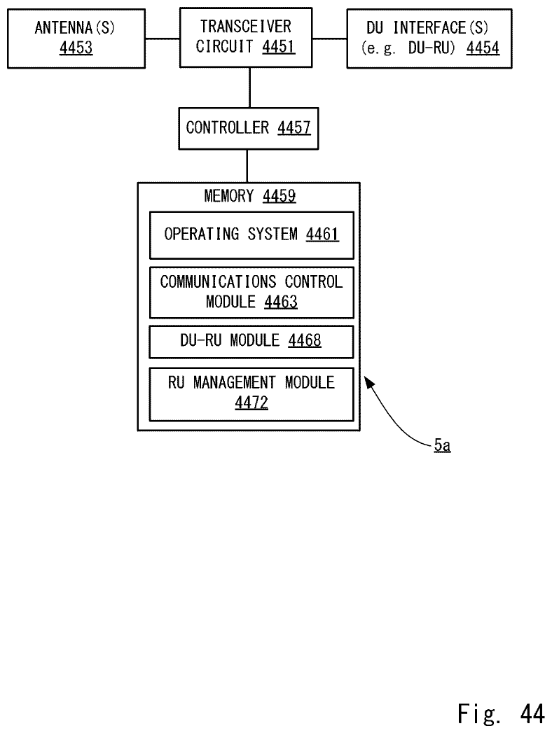

FIG. 44 is a schematic block diagram illustrating the main components of the RU 5a of the RAN 5 for the communication system 1 shown in FIG. 5. As shown, the RU 5a has a transceiver circuit 4451 for: transmitting signals to, and for receiving signals from, the communication devices (such as UEs 3) via one or more antenna 4453 (e.g. an antenna array/massive antenna); and transmitting signals to, and for receiving signals from, the DU 5b of the RAN 5 via a DU interface 4454 (e.g. comprising the DU-RU interface or the like). The RU 5a has a controller 4457 to control the operation of the RU 5a. The controller 4457 is associated with a memory 4459. Software may be pre-installed in the memory 4459 and/or may be downloaded via the communication system 1 or from a removable data storage device (RMD) for example. The controller 4457 is configured to control the overall operation of the RU 5a by, in this example, program instructions or software instructions stored within memory 4459.

As shown, these software instructions include, among other things, an operating system 4461, a communications control module 4463, a DU-RU module 4465, and an RU management module 4472.

The communications control module 4463 is operable to control the communication between the RU 5a and UEs 3, and between the RU 5a and the DU 5b. The communications control module 4463 is configured for the overall control of the reception, at the physical layer level, of signals corresponding to uplink communications from the UE 3 and for handling, at the physical layer level, the transmission of downlink communications to the UE 3.

The DU-RU module 4468 is responsible for the appropriate processing of signals received from, or transmitted to, the DU 5b via one or more DU (e.g. DU-RU) interfaces 4454.

The RU management module 4472 is responsible for managing the overall operation of the RU 5a and the overall performance of the tasks required of the RU 5a. The RU management module 4472 is responsible, for example, for beamforming related actions at the RU 5a, for actions related to the configuration of the RU 5a in accordance with any TDD/SBFD related configurations indicated by the DU 5b, and/or the like.

The RU management module 4472 is also responsible, for example, for any O-FH M-plane capability information exchange with the DU 5b, and transmission/reception over the O-FH CUS-plane, of user plane and control plane messages. The RU management module 4472 is also responsible, for managing generation and transmission of any signalling to the DU 5b to indicate its support of SBFD operation and/or its isolation capability. The RU management module 4472 is also responsible, for example, for the reception and processing of SBFD related signalling from the DU 5b such as: any information indicating a configuration of SBFD symbols/slots for the (open) RU 5a; any information indicating one or more symbols/slots to be changed to/from one or more UL/DL only symbols/slots from/to one or more SBFD symbols/slots; and/or any information indicating an UL subband, DL subband and/or guard band.

The RU management module 4472 also handles transmission and reception of beamforming related signalling to and from the DU 5b. The signalling sent to the DU 5b may include, for example, any signalling to indicate beamforming related information such as, for example: any information about the beams the RU 5a may use (e.g., coarse or fine beam, neighbour beam relation, beam patterns which can be generated by the RU 5a and/or the like); any information indicating the configuration of one or more of antenna arrays such as the number of vertical and horizontal antenna elements and antenna characteristics for each antenna array (which may be different for SBFD operation compared to UL and/or DL operation); and/or any information indicating which set of antenna panels/arrays/elements can/cannot be used for SBFD operation for UL/DL. The signalling received from the DU 5b may include, for example: any beamforming related channel information and/or scheduling information used to calculate beamforming weights; and/or any signalling from the DU 5b to indicate beamforming information such as, for example beamforming weights (e.g., for each layer), beamforming attributes, and/or associated beam identifiers.

### RAN Node (DU)

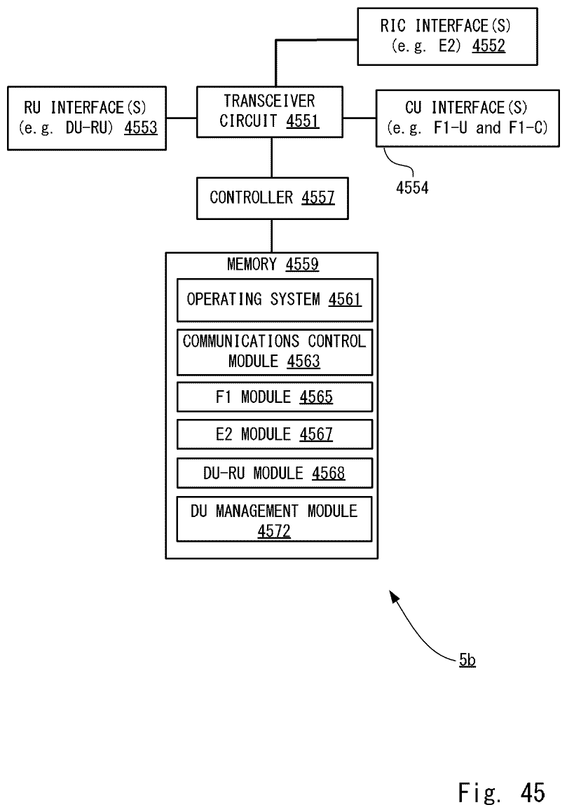

FIG. 45 is a schematic block diagram illustrating the main components of the DU 5b of the RAN 5 for the communication system 1 shown in FIG. 5. As shown, the DU 5b has a transceiver circuit 4551 for: transmitting signals to, and for receiving signals from, the communication devices (such as UEs 3) via the RU 5a and the associated DU-RU interface 4553; for transmitting signals to, and for receiving signals from, the CU 5c of the RAN node via a CU interface 4554 (e.g. comprising an F1 interface which may be split into an F1-U and an F1-C interface for user plane and control plane signalling respectively); and for transmitting signals to, and for receiving signals from, the RIC 13 (and in particular the near-RT RIC 13-2) via a RIC interface 4552 (e.g. comprising an E2 interface).

The DU 5b has a controller 4557 to control the operation of the DU 5b. The controller 4557 is associated with a memory 4559. Software may be pre-installed in the memory 4559 and/or may be downloaded via the communication system 1 or from a removable data storage device (RMD) for example. The controller 4557 is configured to control the overall operation of the DU 5b by, in this example, program instructions or software instructions stored within memory 4559.

As shown, these software instructions include, among other things, an operating system 4561, a communications control module 4563, an F1 module 4565, an E2 module 4567, and a DU-RU module 4568.

The communications control module 4563 is operable to control the communication between the DU 5b and one or more RUs 5a (and hence between the DU 5b and the UE 3), between the DU 5b and the CU 5c, and between the DU 5b and the RIC 13 (and in particular the near-RT RIC 13-2). The communications control module 4563 is configured for the overall control of the reception of signals corresponding to uplink communications from the UE 3 and for handling the transmission of downlink communications destined for the UE 3.

The F1 module 4565 is responsible for the appropriate processing of signals received from, or transmitted to, the CU 5c via one or more CU (e.g. F1) interfaces 4554. These signals may be separated into: user plane signals received from, or transmitted to, the CU-UP part of the CU 5c via the F1-U interface; and control plane signals received from, or transmitted to, the CU-CP part of the CU 5c via the F1-C interface.

The E2 module 4567 is responsible for the appropriate processing of signals received from, or transmitted to, the RIC 13 (and in particular the near-RT RIC 13-2) via one or more RIC (e.g. E2) interfaces 4552.

The DU-RU module 4568 is responsible for the appropriate processing of signals received from, or transmitted to, the RU 5a via one or more RU (e.g. DU-RU) interfaces 4553.

The DU management module 4572 is responsible for managing the overall operation of the DU 5b and the overall performance of the tasks required of the DU 5b. These tasks include, among other things, the generation and transmission of appropriate messages using appropriate signalling application protocols, depending on the functional split between the RU 5a, DU 5b and CU 5c, such as interpretation of received MAC signalling and the generation of MAC signalling for transmission.

The DU management module 4572 is responsible, for example, for handling any O-FH M-plane capability information exchange with the RU 5a, and transmission/reception over the O-FH CUS-plane, of user plane and control plane messages. The DU management module 4572 is also responsible, for example, for managing reception and processing of the signalling to the RU 5a to indicate its support of SBFD operation and/or its isolation capability. The DU management module 4572 is also responsible, for example, for the generation and transmission of SBFD related signalling to the RU 5a such as: information indicating a configuration of SBFD symbols/slots for the (open) RU 5a; information indicating one or more symbols/slots to be changed to/from one or more UL/DL only symbols/slots from/to one or more SBFD symbols/slots; and/or information indicating an UL subband, DL subband and/or guard band.

The DU management module 4572 also handles transmission and reception of beamforming related signalling to and from the RU 5a. The signalling received from the RU 5a may include, for example, any signalling to indicate beamforming related information such as, for example: any information about the beams the RU 5a may use (e.g., coarse or fine beam, neighbour beam relation, beam patterns which can be generated by the RU 5a and/or the like); any information indicating the configuration of one or more of antenna arrays such as the number of vertical and horizontal antenna elements and antenna characteristics for each antenna array (which may be different for SBFD operation compared to UL and/or DL operation); and/or any information indicating which set of antenna panels/arrays/elements can/cannot be used for SBFD operation for UL/DL. The signalling sent to the RU 5a may include, for example: any beamforming related channel information and/or scheduling information used to calculate beamforming weights; and/or any signalling from the DU 5b to indicate beamforming information such as, for example beamforming weights (e.g., for each layer), beamforming attributes, and/or associated beam identifiers.

The DU management module 4572 also handles transmission and reception of TDD configuration related signalling to and from the CU 5c. The signalling may include, for example, any signalling for exchanging TDD information between the DU 5b and CU 5c including any information indicating any SBFD specific configuration and/or any SBFD specific parameters. The signalling may include, for example, any information indicating (explicitly or implicitly) that SBFD operation is (or is not supported).

### RAN Node (CU)

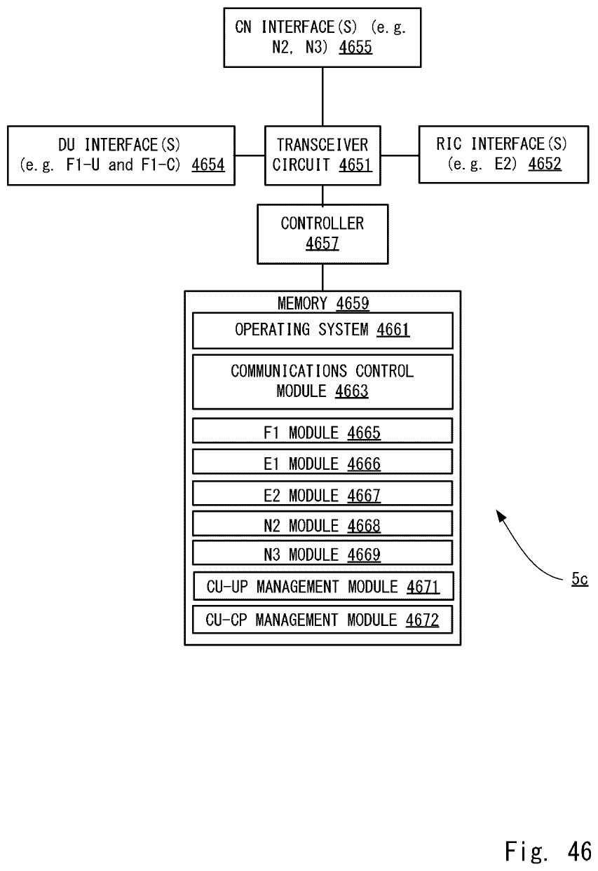

FIG. 46 is a schematic block diagram illustrating the main components of the CU 5c of the RAN 5 for the communication system 1 shown in FIG. 5. As shown, the CU 5c has a transceiver circuit 4651 for: transmitting signals to, and for receiving signals from, the DU 5b via one or more DU interfaces 4654 (e.g. comprising an F1 interface which may be split into an F1-U and an F1-C interface for user plane and control plane signalling respectively); for transmitting signals to, and for receiving signals from, the functions of the core network 7 via one or more core network interfaces 4655 (e.g. comprising the N2 and N3 interfaces or the like); and for transmitting signals to and for receiving signals from the RIC 13 (and in particular the near-RT RIC 13-2) via a RIC interface 4652 (e.g. comprising an E2 interface).

The CU 5c has a controller 4657 to control the operation of the CU 5c. The controller 4657 is associated with a memory 4659. Software may be pre-installed in the memory 4659 and/or may be downloaded via the communication system 1 or from a removable data storage device (RMD) for example. The controller 4657 is configured to control the overall operation of the CU 5b by, in this example, program instructions or software instructions stored within memory 4659.

As shown, these software instructions include, among other things, an operating system 4661, a communications control module 4663, an F1 module 4665, an E1 module 4666, an E2 module 4667, an N2 module 4668, an N3 module 4669, a CU-UP management module 4671, and a CU-CP management module 4672.

The communications control module 4663 is operable to control the communication between the CU 5c and one or more DUs 5b (and hence between the CU 5c and the UE 3), between the CU 5c and the core network 7, and between the CU 5c and the RIC 13 (and in particular the near-RT RIC 13-2). The communications control module 4663 is configured for the overall control of the reception of signals corresponding to uplink communications from the UE 3 and for handling the transmission of downlink communications destined for the UE 3.

The F1 module 4665 is responsible for the appropriate processing of signals received from, or transmitted to, the DU 5b via one or more DU (e.g. F1) interfaces 4654. These signals may be separated into: user plane signals received at, or transmitted by, the CU-UP part of the CU 5c via the F1-U interface; and control plane signals received at, or transmitted by, the CU-CP part of the CU 5c via the F1-C interface.

The E1 module 4666 is responsible for the appropriate processing of signals transmitted between the CU-UP part of the CU 5c and the CU-CP part of the CU 5c via the corresponding internal CU interface (e.g. E1).

The E2 module 4667 is responsible for the appropriate processing of signals received from, or transmitted to, the RIC 13 (and in particular the near-RT RIC 13-2) via one or more RIC (e.g. E2) interfaces 4652.

The N2 module 4668 is responsible for the appropriate processing of signals received from, or transmitted to, the AMF 10-1 via one or more corresponding core network (e.g. N2) interfaces 4655.

The N3 module 4669 is responsible for the appropriate processing of signals received from, or transmitted to, the one or more core network user plane functions 11 via one or more corresponding core network (e.g. N3) interfaces 4655.

The CU-UP management module 4671 is responsible for managing the overall operation of the CU-UP part of the CU 5c and the overall performance of the tasks required of the CU-UP.

The CU-CP management module 4672 is responsible for managing the overall operation of the CU-CP part of the CU 5c and the overall performance of the tasks required of the CU-CP. These tasks include, among other things, the generation and transmission of appropriate messages using appropriate signalling application protocols, depending on the functional split between the RU 5a, DU 5b and CU 5c, such as interpretation of received RRC signalling and the generation of RRC signalling for transmission.

The CU-CP management module 4672 also handles transmission and reception of TDD configuration related signalling to and from the DU 5b. The signalling may include, for example, any signalling for exchanging TDD information between the DU 5b and CU 5c including any information indicating any SBFD specific configuration and/or any SBFD specific parameters. The signalling may include, for example, any information indicating (explicitly or implicitly) that SBFD operation is (or is not supported).

### Modifications and Alternatives

A detailed example embodiment has been described above. As those skilled in the art will appreciate, a number of modifications and alternatives can be made to the above example embodiments whilst still benefiting from the description embodied therein.

It will be appreciated, for example, that whilst cellular communication generation (2G, 3G, 4G, 5G, 6G etc.) specific terminology may be used, in the interests of clarity, to refer to specific communication entities, the technical features described for a given entity are not limited to devices of that specific communication generation. The technical features may be implemented in any functionally equivalent communication entity regardless of any differences in the terminology used to refer to them.

In the above description, the UEs and the RAN node (DU, CU, and RU) are described for ease of understanding as having a number of discrete functional components or modules. Whilst these modules may be provided in this way for certain applications, for example where an existing system has been modified to implement the description, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied to the RAN node (DU, CU, or RU) or to the UE as a signal over a computer network, or on a recording medium. Further, the functionality performed by part, or all of this software may be performed using one or more dedicated hardware circuits. However, the use of software modules is preferred as it facilitates the updating of the RAN or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch exchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and example embodiments described in the present document. Needless to say, these technical ideas and example embodiments are not limited to the above-described UE and various modifications can be made thereto.

Various other modifications will be apparent to those skilled in the art and will not be described in further detail here.

For example, the whole or part of the exemplary embodiments disclosed above can be described as, but not limited to, the following supplementary notes.

### (Supplementary Note 1)

A method performed by a first unit of an access network, the method comprising:
transmitting, to a second unit of the access network, capability information indicating a capability of the first unit, the information indicating the capability indicating at least one of:
a capability of the first unit to communicate with a user equipment (UE) using a communication scheme in which at least one time resource is configured for uplink communication, at least one time resource is configured for downlink communication, and at least one time resource is configured both for downlink communication and for uplink communication; or
a capability of the first unit to isolate downlink communication from uplink communication in at least one time resource that is configured both for downlink communication and for uplink communication.

### (Supplementary Note 2)

A method according to supplementary note 1, wherein the capability information includes information indicating a respective isolation capability for each of a plurality of different isolation schemes.

### (Supplementary Note 3)

A method according to supplementary note 1, wherein the capability information includes information indicating a combined isolation capability for a plurality of different isolation schemes.

### (Supplementary Note 4)

A method according to supplementary note 3, wherein the capability information includes information identifying a configuration of the different isolation schemes used to determine the combined isolation capability.

### (Supplementary Note 5)

A method according to supplementary note 3 or 4, wherein the capability information includes information indicating a respective combined isolation capability for each a plurality of different configurations of the different isolation schemes.

### (Supplementary Note 6)

A method according to any of supplementary notes 2 to 5, wherein the different isolation schemes include at least one of: a first isolation scheme in which at least one guard band is used to isolate downlink communication from uplink communication; a second isolation scheme in which different beams are used to isolate downlink communication from uplink communication; a third isolation scheme in which different antenna configurations are used to isolate downlink communication from uplink communication; or a fourth isolation scheme in which at least one cancellation mechanism is used to isolate downlink communication from uplink communication.

### (Supplementary Note 7)

A method according to any preceding supplementary note, further comprising receiving a request from the second unit, wherein the capability information is provided in response to the request.

### (Supplementary Note 8)

A method performed by a second unit of an access network, the method comprising:
receiving, from a first unit of the access network, capability information indicating at least one of:
a capability of the first unit to communicate with a user equipment (UE) using a communication scheme in which at least one time resource is configured for uplink communication, at least one time resource is configured for downlink communication, and at least one time resource is configured both for downlink communication and for uplink communication; or a capability of the first unit to isolate downlink communication from uplink communication in at least one time resource that is configured both for downlink communication and for uplink communication.

### (Supplementary Note 9)

A method performed by a second unit of an access network, the method comprising:
transmitting, to a first unit of the access network, configuration information for a communication scheme in which at least one time resource, of a plurality of time resources, is configured as a first type for uplink communication, at least one time resource, of the plurality of time resources, is configured as a second type for downlink communication, and at least one time resource, of the plurality of time resources, is configured as a third type for both downlink communication and uplink communication.

### (Supplementary Note 10)

A method according to supplementary note 9, wherein the configuration information is for configuring the first unit to communicate with at least one user equipment (UE) using the plurality of time resources in accordance with the communication scheme.

### (Supplementary Note 11)

A method according to supplementary note 9 or 10, wherein the configuration information includes information indicating, for each time resource of the plurality of time resources whether that time resource is: the first type, the second type, or the third type.

### (Supplementary Note 12)

A method according to supplementary note 9 or 10, wherein the first unit has an existing configuration of the plurality of time resources in which at least one time resource is configured as the first type and at least one time resource is configured as the second type, and wherein the configuration information includes information indicating which of the plurality of time resources of the existing configuration are to be modified from the first type, or from the second type, to the third type.

### (Supplementary Note 13)

A method according to supplementary note 9 or 10, wherein the configuration information includes:
first information for respectively configuring each resource, of the plurality of time resources, to be the first type for uplink communication or the second type for downlink communication in a first frequency region; and
second information for respectively configuring each resource, of the plurality of time resources, to be the first type for uplink communication or the second type for downlink communication in a second frequency region.

### (Supplementary Note 14)

A method according to any of supplementary notes 9 to 13, further comprising transmitting, to the first unit, further information indicating:
at least one time resource of the first type, and/or at least one time resource of the second type, to be modified dynamically to become a time resource of the third type; and/or
at least one time resource of the third type to be modified dynamically to become a time resource of the first type or a time resource of the second type.

### (Supplementary Note 15)

A method according to supplementary note 14, wherein the transmitting of the further information is timed to be received by the first unit a minimum time before the first unit receives control information relating to transmission of data for at least one UE by the second unit.

### (Supplementary Note 16)

A method according to supplementary note 14, wherein the further information is transmitted with control information relating to transmission of data for at least one UE by the second unit.

### (Supplementary Note 17)

A method according to any of supplementary notes 9 to 16, further comprising transmitting, to the first unit, an indication of a frequency region for at least one of: an uplink subband; a downlink subband; and/or a guard band.

### (Supplementary Note 18)

A method according to any of supplementary notes 9 to 16, further comprising transmitting, to the first unit, an indication of a filter to be applied for time resources configured as the third type.

### (Supplementary Note 19)

A method according to supplementary note 9, wherein the configuration information includes at least one of: information indicating a configuration for the communication scheme for implementation at the first unit; information indicating an intended configuration for the communication scheme at the second unit; and/or information indicating a configuration for the communication scheme for a neighbouring unit of the access network or another access network.

### (Supplementary Note 20)

A method according to supplementary note 9 or 19, wherein the configuration information includes information, for configuring at least one time resource as the third type, that includes at least one of: an indication of frequency resources for at least one uplink subband; an indication of frequency resources for at least one downlink subband; an indication of frequency resources for at least one guard band; an indication of a time location for at least one uplink subband or downlink subband; and/or a time location for the at least one time resource of the third type.

### (Supplementary Note 21)

A method according to supplementary note 9, 19 or 20 wherein the configuration information is transmitted on condition that the first unit: supports reception of configuration information including information for configuring at least one time resource as the third type; or supports operation in accordance with a communication scheme in which at least one time resource is configured as the third type.

### (Supplementary Note 22)

A method according to supplementary note 9, 19 or 20, wherein the configuration information includes information for configuring at least one time resource as the third type on condition that the first unit: supports reception of configuration information including information for configuring at least one time resource as the third type; or supports operation in accordance with a communication scheme in which at least one time resource is configured as the third type.

### (Supplementary Note 23)

A method according to supplementary note 9 wherein the configuration information is second configuration information, and the transmitting includes transmitting first configuration information for configuring at least one time resource as the first type, and at least one time resource as the second type, without configuring a time resource as the third type.

### (Supplementary Note 24)

A method according to supplementary note 9 wherein the configuration information includes first configuration information for configuring at least one time resource as the first type, and at least one time resource as the second type, and second configuration information for configuring at least one time resource configured by the first configuration information as the first type or as the second type, as the third type.

### (Supplementary Note 25)

A method performed by a first unit of an access network, the method comprising:
receiving, from a second unit of the access network, configuration information for a communication scheme in which at least one time resource, of a plurality of time resources, is configured as a first type for uplink communication, at least one time resource, of the plurality of time resources, is configured as a second type for downlink communication, and at least one time resource, of the plurality of time resources, is configured as a third type for both downlink communication and uplink communication.

### (Supplementary Note 26)

A method according to supplementary note 25, wherein the configuration information is for configuring the first unit to communicate with at least one user equipment (UE) using the plurality of time resources in accordance with the communication scheme.

### (Supplementary Note 27)

A method according to supplementary note 25 or 26, further comprising determining a filter to be applied between an uplink subband and a downlink subband based on a guard band configured by the second unit.

### (Supplementary Note 28)

A method according to supplementary note 25, wherein the configuration information is second configuration information, and the receiving includes receiving first configuration information for configuring at least one time resource as the first type, and at least one time resource as the second type, without configuring a time resource as the third type, the method further comprising:
in a case where the first unit does not support reception of configuration information including information for configuring at least one time resource as the third type, or does not support operation in accordance with a communication scheme in which at least one time resource is configured as the third type: ignoring the second configuration information and using the first configuration information; and
in a case where the first unit supports reception of configuration information including information for configuring at least one time resource as the third type, or supports operation in accordance with a communication scheme in which at least one time resource is configured as the third type: using the second configuration information.

### (Supplementary Note 29)

A method according to supplementary note 25, wherein the configuration information includes first configuration information for configuring at least one time resource as the first type, and at least one time resource as the second type, and second configuration information for configuring at least one time resource configured by the first configuration information as the first type or as the second type, as the third type, the method further comprising:
in a case where the first unit does not support reception of configuration information including information for configuring at least one time resource as the third type, or does not support operation in accordance with a communication scheme in which at least one time resource is configured as the third type: ignoring the second configuration information and using the first configuration information; and
in a case where the first unit supports reception of configuration information including information for configuring at least one time resource as the third type, or supports operation in accordance with a communication scheme in which at least one time resource is configured as the third type: using the first configuration information and the second configuration information.

### (Supplementary Note 30)

A method according to supplementary note 28 or 29, further comprising using a configuration of time resources based on whether the first configuration information and or second configuration is used, and transmitting an indication to the second unit to indicate: that the configuration of time resources used at the first unit is a configuration that includes at least one time resource that is configured as the third type; or that the configuration of time resources used at the first unit is a configuration that does not include at least one time resource that is configured as the third type.

### (Supplementary Note 31)

A method according to any of supplementary notes 25 to 30, further comprising providing, to the second unit: an indication of whether the first unit does, or does not support reception of configuration information including information for configuring at least one time resource as the third type; or an indication of whether the first unit does, or does not support operation in accordance with a communication scheme in which at least one time resource is configured as the third type.

### (Supplementary Note 32)

A method according to any of supplementary notes 25 to 30 further comprising, in a case where the first unit does not support reception of configuration information including information for configuring at least one time resource as the third type, or does not support operation in accordance with a communication scheme in which at least one time resource is configured as the third type: sending an error message to the second unit in response to receipt of the configuration information.

### (Supplementary Note 33)

A method performed by a first unit of an access network, the method comprising:
transmitting, to a second unit of the access network, beam or antenna related information including at least one of:
first information indicating at least one first beam configuration for at least one time resource that is configured both for downlink communication and for uplink communication, and at least one second beam configuration for at least one time resource that is configured specifically for downlink communication or specifically for uplink communication;
second information indicating at least one first beam pattern for at least one time resource that is configured both for downlink communication and for uplink communication, and at least one second beam pattern for at least one time resource that is configured specifically for downlink communication or specifically for uplink communication;
third information indicating at least one first set of antenna components that can, or cannot, be used for uplink communication in at least one time resource that is configured both for downlink communication and for uplink communication, and at least one second set of antenna components that can, or cannot, be used for downlink communication in at least one time resource that is configured both for downlink communication and for uplink communication; and/or
fourth information indicating at least one first configuration for an antenna for uplink communication in at least one time resource that is configured both for downlink communication and for uplink communication, and at least one second configuration for an antenna for downlink communication in at least one time resource that is configured both for downlink communication and for uplink communication.

### (Supplementary Note 34)

A method performed by a second unit of an access network, the method comprising:
receiving, from a first unit of the access network, beam or antenna related information including at least one of:
first information indicating at least one first beam configuration for at least one time resource that is configured both for downlink communication and for uplink communication, and at least one second beam configuration for at least one time resource that is configured specifically for downlink communication or specifically for uplink communication;
second information indicating at least one first beam pattern for at least one time resource that is configured both for downlink communication and for uplink communication, and at least one second beam pattern for at least one time resource that is configured specifically for downlink communication or specifically for uplink communication;
third information indicating at least one first set of antenna components that can, or cannot, be used for uplink communication in at least one time resource that is configured both for downlink communication and for uplink communication, and at least one second set of antenna components that can, or cannot, be used for downlink communication in at least one time resource that is configured both for downlink communication and for uplink communication; and/or
fourth information indicating at least one first configuration for an antenna for uplink communication in at least one time resource that is configured both for downlink communication and for uplink communication, and at least one second configuration for an antenna for downlink communication in at least one time resource that is configured both for downlink communication and for uplink communication.

### (Supplementary Note 35)

A method according to supplementary note 34, further comprising using the beam or antenna related information when identifying a beam to be used for at least one time resource that is configured both for downlink communication and for uplink communication.

### (Supplementary Note 36)

A method according to supplementary note 34 or 35, further comprising using the beam or antenna related information when identifying at least one weight to be applied for beamforming for at least one time resource that is configured both for downlink communication and for uplink communication.

### (Supplementary Note 37)

A first unit for an access network, the first unit comprising:
means for transmitting, to a second unit of the access network, capability information indicating a capability of the first unit, the information indicating the capability indicating at least one of:
a capability of the first unit to communicate with a user equipment (UE) using a communication scheme in which at least one time resource is configured for uplink communication, at least one time resource is configured for downlink communication, and at least one time resource is configured both for downlink communication and for uplink communication; or
a capability of the first unit to isolate downlink communication from uplink communication in at least one time resource that is configured both for downlink communication and for uplink communication.

### (Supplementary Note 38)

A second unit for an access network, the second unit comprising:
means for receiving, from a first unit of the access network, capability information indicating at least one of:
a capability of the first unit to communicate with a user equipment (UE) using a communication scheme in which at least one time resource is configured for uplink communication, at least one time resource is configured for downlink communication, and at least one time resource is configured both for downlink communication and for uplink communication; or
a capability of the first unit to isolate downlink communication from uplink communication in at least one time resource that is configured both for downlink communication and for uplink communication.

### (Supplementary Note 39)

A second unit for an access network, the second unit comprising:
means for transmitting, to a first unit of the access network, configuration information for a communication scheme in which at least one time resource, of a plurality of time resources, is configured as a first type for uplink communication, at least one time resource, of the plurality of time resources, is configured as a second type for downlink communication, and at least one time resource, of the plurality of time resources, is configured as a third type for both downlink communication and uplink communication.

### (Supplementary Note 40)

A first unit for an access network, the first unit comprising:
means for receiving, from a second unit of the access network, configuration information for a communication scheme in which at least one time resource, of a plurality of time resources, is configured as a first type for uplink communication, at least one time resource, of the plurality of time resources, is configured as a second type for downlink communication, and at least one time resource, of the plurality of time resources, is configured as a third type for both downlink communication and uplink communication.

### (Supplementary Note 41)

A first unit for an access network, the first unit comprising:
means for transmitting, to a second unit of the access network, beam or antenna related information including at least one of:
first information indicating at least one first beam configuration for at least one time resource that is configured both for downlink communication and for uplink communication, and at least one second beam configuration for at least one time resource that is configured specifically for downlink communication or specifically for uplink communication;
second information indicating at least one first beam pattern for at least one time resource that is configured both for downlink communication and for uplink communication, and at least one second beam pattern for at least one time resource that is configured specifically for downlink communication or specifically for uplink communication;
third information indicating at least one first set of antenna components that can, or cannot, be used for uplink communication in at least one time resource that is configured both for downlink communication and for uplink communication, and at least one second set of antenna components that can, or cannot, be used for downlink communication in at least one time resource that is configured both for downlink communication and for uplink communication; and/or
fourth information indicating at least one first configuration for an antenna for uplink communication in at least one time resource that is configured both for downlink communication and for uplink communication, and at least one second configuration for an antenna for downlink communication in at least one time resource that is configured both for downlink communication and for uplink communication.

### (Supplementary Note 42)

A second unit for an access network, the second unit comprising:
means for receiving, from a first unit of the access network, beam or antenna related information including at least one of:
first information indicating at least one first beam configuration for at least one time resource that is configured both for downlink communication and for uplink communication, and at least one second beam configuration for at least one time resource that is configured specifically for downlink communication or specifically for uplink communication;
second information indicating at least one first beam pattern for at least one time resource that is configured both for downlink communication and for uplink communication, and at least one second beam pattern for at least one time resource that is configured specifically for downlink communication or specifically for uplink communication;
third information indicating at least one first set of antenna components that can, or cannot, be used for uplink communication in at least one time resource that is configured both for downlink communication and for uplink communication, and at least one second set of antenna components that can, or cannot, be used for downlink communication in at least one time resource that is configured both for downlink communication and for uplink communication; and/or
fourth information indicating at least one first configuration for an antenna for uplink communication in at least one time resource that is configured both for downlink communication and for uplink communication, and at least one second configuration for an antenna for downlink communication in at least one time resource that is configured both for downlink communication and for uplink communication.

This application is based upon and claims the benefit of priority from Great Britain Patent Application No. 2304384.7, filed on Mar. 24, 2023, the disclosure of which is incorporated herein in its entirety by reference.

### REFERENCE SIGNS LIST

1 COMMUNICATION SYSTEM
3 USER EQUIPMENT
5 RADIO ACCESS NETWORK
5a RADIO/REMOTE UNIT (RU)
5b DISTRIBUTED UNIT (DU)
7 CORE NETWORK
9 CELL
10 CONTROL PLANE FUNCTIONS
11 USER PLANE FUNCTIONS
20 EXTERNAL DATA NETWORK
30 SERVICE MANAGEMENT AND ORCHESTRATION FRAMEWORK
4331 TRANSCEIVER CIRCUIT
4333 ANTTENNA
4335 USER INTERFACE
4337 CONTROLLER
4339 MEMORY
4341 OPERATING SYSTEM
4343 COMMUNICATIONS CONTROL MODULE
4345 UE MANAGEMENT MODULE
4451 TRANSCEIVER CIRCUIT
4453 ANTTENNA
4454 DU INTERFACE
4457 CONTROLLER
4459 MEMORY
4461 OPERATING SYSTEM
4463 COMMUNICATIONS CONTROL MODULE
4468 DU-RU MODULE
4472 RU MANAGEMENT MODULE
4551 TRANSCEIVER CIRCUIT
4552 RIC INTERFACE
4553 RU INTERFACE
4554 CU INTERFACE
4557 CONTROLLER
4559 MEMORY
4561 OPERATING SYSTEM
4563 COMMUNICATIONS CONTROL MODULE
4565 F1 MODULE
4567 E2 MODULE
4568 DU-RU MODULE
4572 DU MANAGEMENT MODULE
4651 TRANSCEIVER CIRCUIT
4652 RIC INTERFACE
4654 DU INTERFACE
4655 CN INTERFACE
4657 CONTROLLER
4659 MEMORY
4661 OPERATING SYSTEM
4663 COMMUNICATIONS CONTROL MODULE
4665 F1 MODULE
4666 E1 MODULE
4667 E2 MODULE
4668 N2 MODULE
4669 N3 MODULE
4671 CU-UP MANAGEMENT MODULE
4672 CU-CP MANAGEMENT MODULE

What is claimed is:

1.-30. (canceled)

31. A method performed by a first unit of a distributed base station, the method comprising:
transmitting, to a second unit of the distributed base station, configuration information indicating which time resources are configured for subband full duplex (SBFD).

32. The method according to claim 31, wherein
the configuration information indicates which time resources are configured for uplink communication only or downlink communication only.

33. The method according to claim 31, wherein
the configuration information indicates which time resources are modified to be configured for SBFD, or uplink communication only or downlink communication only.

34. The method according to claim 31, wherein
the configuration information indicates configuration of respective time resources per frequency regions.

35. The method according to claim 34, wherein
each of the frequency regions indicates at least one of:
an uplink subband,
an downlink subband, or
a guard band.

36. The method according to claim 31, wherein
the configuration information indicates which time resources are dynamically modified to be configured for SBFD, or uplink communication only or downlink communication only, and
the configuration information is transmitted:
before receiving data transmitted using the time resources, or
in a message for scheduling a transmission of the data.

37. The method according to claim 31, wherein
the configuration information indicates at least one of:
a configuration configured by the first unit to the second unit,
a configuration for the first unit, intended by the first unit, or
a configuration for a neighbouring unit of the access network or another access network.

38. The method according to claim 31, wherein
the configuration information is transmitted in a case where the second unit supports a scheme of SBFD.

39. The method according to claim 31, further comprising:
receiving, from the second unit, information indicating the second unit does not support a scheme of SBFD.

40. The method according to claim 31, wherein
the configuration information is ignored by the second unit, in a case where the second unit does not support a scheme of SBFD.

41. The method according to claim 31, further comprising:
transmitting, to the second unit, capability information indicating at least one of:
a capability of the first unit to communicate with a mobile device using SBFD symbols; or
a capability of the first unit to isolate downlink communication from uplink communication in SBFD symbols in a frequency region or a spatial region.

42. The method according to claim 41, wherein
the capability information includes at least one parameter for a plurality of schemes to isolate the downlink communication from the uplink communication in the SBFD symbols.

43. The method according to claim 42, wherein
a first set of the at least one parameter is specific to one of the plurality of the schemes to isolate.

44. The method according to claim 42, wherein
each of at least one second set of the at least one parameter is common to the plurality of the schemes to isolate.

45. The method according to claim 41, wherein
the at least one parameter includes at least one of:
at least one value each of which indicates each supported guard band combination;
at least one value each of which indicates each supported beam pair;
at least one value each of which indicates each supported antenna array and/or panel configuration; or
at least one value each of which indicates each supported digital and/or analog cancellation mechanism.

46. The method according to claim 31, further comprising:
transmitting, to the second unit, beam or antenna related information including:
at least one first configuration for SBFD symbols; and
at least one second configuration for uplink only symbols or downlink only symbols.

47. The method according to claim 46, wherein
the at least one first configuration and the at least one second configuration respectively indicates at least one of:
a supported beam configuration,
a supported beamforming pattern, or
a supported set of antenna panels, antenna arrays and/or antenna elements.

48. A method performed by a second unit of a distributed base station, the method comprising:
receiving, from a first unit of the distributed base station, configuration information indicating which time resources are configured for subband full duplex (SBFD).

49. A first unit of a distributed base station, the first unit comprising:
at least one memory storing instructions; and
at least one processor configured to process the instructions to:
transmit, to a second unit of the distributed base station, configuration information indicating which time resources are configured for subband full duplex (SBFD).

50. A second unit of a distributed base station, the second unit comprising:
at least one memory storing instructions; and
at least one processor configured to process the instructions to:
receive, from a first unit of the distributed base station, configuration information indicating which time resources are configured for subband full duplex (SBFD).
